(19) United States
(12) Patent Application Publication
(10) Pub. No.: US 2007/0083286 A1
(43) Pub. Date: Apr. 12, 2007

(54) Medical instrument and equipment for managing of the same

(75) Inventor: Norio Kobayashi, Tokyo (JP)

Correspondence Address: SCULLY SCOTT MURPHY & PRESSER, PC, 400 GARDEN CITY PLAZA, SUITE 300, GARDEN CITY, NY, 11530, US

(73) Assignee: Olympus Corporation, Tokyo (JP)

(21) Appl. No.: 11/076,332

(22) Filed: Mar. 9, 2005

(30) Foreign Application Priority Data
Mar. 9, 2004 (JP) 2004-065912
Mar. 9, 2004 (JP) 2004-065913
Mar. 10, 2004 (JP) 2004-068141
Mar. 23, 2004 (JP) 2004-085559
Mar. 31, 2004 (JP) 2004-107092
Apr. 15, 2004 (JP) 2004-124868
Sep. 24, 2004 (JP) 2004-277082

(51) Int. Cl. G06F 7/00

(52) U.S. Cl. 700/214

(57) ABSTRACT

Medical instrument management equipment of the present invention comprises an order data entry element for entering the information on a medical instrument ordered by means of the type of a given medical practice from a given medical institution, a medical instrument extraction element for extracting the medical instruments require for the give medical practice based on the order data entered at the order data entry element, a “collected” medical instrument determination element for determining those designated as “collected” after being used by the medical institution out of the medical instruments extracted, and an identification information storing element for storing the identification information entered.

### CROSS-REFERENCE TO RELATED APPLICATIONS

This application is based upon and claims the benefit of priority from the prior Japanese Patent Application No. 2004-277082, filed Sep. 24, 2004, Japanese Patent Application No. 2004-124868, filed Apr. 15, 2004, Japanese Patent Application No. 2004-085559, filed Mar. 23, 2004, Japanese Patent Application No. 2004-107092, filed Mar. 31, 2004, Japanese Patent Application No. 2004-068141, filed Mar. 10, 2004, Japanese Patent Application No. 2004-065912, filed Mar. 9, 2004 and Japanese Patent Application No. 2004-065913, filed Mar. 9, 2004, the entire contents of which are incorporated herein by reference.

### BACKGROUND OF THE INVENTION

1. Field of the Invention

The present invention related to medical instruments and a technique for managing thereof.

2. Description of the Related Art

A disposable instrument also referred to as a single-use instrument is used only for a single patient in conducting a medical treatment on him/her once and not used for anyone in subsequence treatment. The examples of disposable instruments include an infusion solution bag, a catheter tube, a blood circuit, an injection syringe, a vacuum blood collecting tube, a surgical non-woven cloth, and surgical rubber globes. The disposable instruments are characterized in that unlike lease instruments, which are lent out to hospitals or other medical treatment facilities for reuse, they eliminate the need for repackaging after sterilization, resulting in easy treatment. Thus, as relatively economical medical instrument products have been commonly used, most of medical professions have often used this type of instruments.

However, in recent years, expensive sophisticated instruments have been increasingly put on the market, the ideal situation of disposable instruments being reconsidered. At present, most of the cost of disposable instruments is included in a surgical expense and according to a study, percentage of the cost of disposable instruments in the surgical expense is nearly 50% for laparoscopic cholecystectomy, whose expense is highest. The medical fee defined for this type of operation is usually 22,400 points, 224,000 yen, while the disposable instrument cost is about 110,000 yen, an average of those for a lot of surgical hospitals.

Note that patent document 1 discloses a system for recycling disposal instruments and patent document 2 discloses a technique for selecting only disposable ones out of a mix of lease and disposable instruments, packaging and then delivering them to hospitals. [patent document 1] Japanese Laid-Open Publication No. 2002-56080 [patent document 2] Japanese Laid-Open Publication No. 2002-166261.

### SUMMARY OF THE INVENTION

According to techniques disclosed in the patent documents 1 and 2, the procurement plans and costs of disposable and lease instruments may be partially improved. However, a combination of disposable and lease instruments is actually used in a medical field and it would be difficult to improve overall efficiency of hospital practices even though an improvement measure is planed out focusing on either type of instruments. Nevertheless, at least there is room for further improvement.

In this context, the present invention has been developed and its object is to supply a technique successfully contributing to reductions in management task and manpower on a hospital side, and medical expense on a patient side in connection with both the disposal and lease instruments.

Another object of the present invention is to provide a technique, which allows hospitals to totally manage both the disposable and lease instruments, facilitating cost management and finally providing hospitals with consultation service, whether explicitly or implicitly.

An aspect of the present invention is medical instrument management equipment. The equipment have an order data entry element, from which order data, with the type of a medical practice specified, on a medical instrument ordered by a given medical institution is entered, a medical instrument extraction element, at which the medical instrument required for the medical practice is extracted, a “collected” medical instrument identification element, which identifies the medical instrument to be collected after the e use at a medical institution, an identification information entry element on the identified medical instrument at the collected medical instrument identification element, and an identification information storage, which stores the entered identification information.

The “order data on a medical practice” indicates, for example, a case name, but any other kind of data may be used provided that it is capable of identifying the medical practice.

Another aspect of the present invention is a medical instrument. It has been assembled using plural kinds of subassemblies, each of which corresponds to its given medical function, and performs a secondary function of the given medical practice in cooperation of the plural kinds of subassemblies assembled into the equipment. To these subassemblies, subassembly IDs are assigned for managing their usage in an external database.

The “subassemblies” are basic assembly units corresponding to the individual functions of the medical instrument elements, wherein it is determined whether they are to be reused or disposed individually. Some subassemblies are to be disposed after being used once and the others may be reused several times. The medical instrument may be composed of a combination of these various kinds of subassemblies. For example, for a medical instrument such as a bipolar tweezers, its total functionality is achieved in cooperation among various types of functions including functions of grasping an affected site and transmitting user's operation. The subassemblies may be those which are corresponding to various medical functions of the medical instrument.

A subassembly ID may be assigned to the subassembly in the form of a sticker, engraved mark, or print as unique graphic information and text information containing numeric and literal characters for identifying it. Alternatively, the subassembly ID, which can be electromagnetically read out, for example, RFID (Radio Frequency Identification), may be assigned to the subassembly.

A further aspect of the present invention is medical instrument management equipment. The equipment stores an assembly table, which gives the correspondence between the medical instrument IDs assigned to the medical instruments and the subassembly IDs assigned to a plurality of various subassemblies, as basic assembly units, corresponding to the given medical functions of the medical instruments, and records the correspondence between the medical instrument IDs of the medical instruments to be managed and the subassembly IDs of the subassemblies composing the medical instruments in the assembly table. In the assembly table, one-many correspondence may be applied to the medical instrument IDs and their subassembly IDs.

The medical instrument IDs may be created by an external device or defined by the user at his/her discretion. Alternatively, the medical instrument management equipment itself may create the medical instrument IDs internally. The medical instrument IDs may be attached in the form of a sticker, engraved mark, or print, for example, on their packages. They may be assigned to the medical instrument when the instruments are assembled. The medical instrument IDs may be removed from the instruments when they are disassembled into their subassemblies or the subassemblies composing the medical instrument are incorporated in another instrument as its subassemblies. Thus, the subassembly IDs may be valid only when the subassemblies are reused or only when the subassemblies, basic assembly units, are treated as subassemblies of the original medical instrument.

### BRIEF DESCRIPTION OF THE DRAWINGS

FIG. 1 is a view illustrating a whole configuration of a medical instrument management system.

FIG. 2 is a view illustrating a whole flow of the medical instrument management system according to one aspect of the present invention.

FIG. 3 is a view illustrating a whole flow of the medical instrument management system according to another aspect of the present invention.

FIG. 4 is a functional block diagram showing a basic configuration of the medical instrument management system to be installed in both the sites of the supplier and user of the medical instrument management system.

FIG. 5 is a functional block diagram showing a basic configuration of the medical instrument management system installed at the medical institution.

FIG. 6 is a schematic view explaining a whole flow of the process from a step of ordering the medical instrument by a medical institution to a step of accounting it by a supplier.

FIG. 7 is a view showing the process and data flow required for concluding a contract between the medical management system at the medical institution site and the medical instrument management system.

FIG. 8 is a view showing the process and data flow required for confirming contract fulfillment between the medical management system at the medical institution site and the medical instrument management system.

FIG. 9 is a schematic diagram showing information contained in an instrument table.

FIG. 10 is a schematic diagram showing information contained in a contract table.

FIG. 11 is a schematic diagram explaining a distribution channel of medical instrument subassemblies in a medical instrument recycle system.

FIG. 12 is a functional block diagram showing a terminal for storing subassembly information attached to the individual subassemblies.

FIG. 13 is a functional bock diagram showing the medical instrument management equipment.

FIG. 14 is a view illustrating the data structure in subassembly data storage.

FIG. 15 is a flowchart showing a process of determining whether assemblies are to be reused or not based on their usage status.

FIG. 16 is a flowchart showing a process of determining whether assemblies are to be reused or not based on a usage point.

FIG. 17A is a view showing an appearance of a bipolar tweezers.

FIG. 17B is a view showing appearances of four subassemblies composing the bipolar tweezers.

FIG. 18 is a pattern format explaining the medical instrument recycle channel.

FIG. 19 is a functional bock diagram showing the medical instrument management equipment.

FIG. 20 is a view showing a data structure in usage data storage.

FIG. 21 is a view showing a data structure in historical usage data storage.

FIG. 22 is a view illustrating an ID registration screen to be used to register medical instrument IDs and subassembly IDs.

FIG. 23 is a view illustrating a usage information entry screen to be used to register the usage information on the medical instruments.

FIG. 24 is a flowchart giving a full detail of a confirmation step at S720 in FIG. 18.

FIG. 25 is a view explaining a first variant of the medical instrument recycle system.

FIG. 26 is a view explaining a step to be followed when any subassembly is determined to be replaced with a new one at a checking step, S913, in FIG. 25.

FIGS. 27A and 27B are schematic diagrams showing aspects, wherein a combination of the subassembly IDs of a plurality of subassemblies makes up a medical instrument ID. FIG. 27A is an external view showing the disassembled the bipolar tweezers. FIG. 27B is an external view showing the assembled bipolar tweezers.

FIG. 28 is a view showing the configuration of the medical instrument management equipment according to the embodiment 5.

FIG. 29 is a view showing an example of the data structure in a case database in FIG. 28.

FIG. 30 is a view showing an example of the data structure in a contract information database in FIG. 28.

FIG. 31 is a view showing an example of the data structure in management information storage in FIG. 28.

FIG. 32 is a view showing an example of the screen displayed in an indicator from an output.

FIG. 33 is a flowchart illustrating a process to be performed in the medical instrument management equipment in FIG. 28.

FIG. 34 is a schematic diagram explaining a medical instrument distribution channel in a medical instrument distribution system according to the embodiment 6.

FIG. 35 is a view of the configuration of the medical instrument management equipment according to the embodiment 6.

FIG. 36 is a view showing an example of the data structure in the case database in FIG. 35.

FIG. 37 is a view showing an example of the data structure in an instrument database in FIG. 35.

FIG. 38 is a view showing an example of the data structure in an instrument inventory database in FIG. 35.

FIG. 39 is a view showing an example of the data structure in a subassembly inventory database in FIG. 35.

FIG. 40 is a view showing an example of the data structure in the contract information database in FIG. 35.

FIG. 41 is a flowchart showing a procedure for managing the medical instruments according to the embodiment 6.

FIG. 42 is a pattern diagram explaining the medical instrument distribution channel in the medical instrument distribution system.

FIG. 43 is a view showing the configuration of the management equipment according to the embodiment 7 of the present invention.

FIG. 44 is a view showing the data structure of the medical instrument data stored in the instrument data storage in FIG. 43.

FIG. 45 is a view showing the data structure of instrument identification information stored in identification information storage.

FIG. 46 is a view showing the constitution of a tweezers to be distributed in the medical instrument distribution system.

FIG. 47 is a view showing the configuration of the management equipment according to the embodiment 7 of the present invention.

FIG. 48 is a flowchart showing a procedure for the management equipment to confirm the confirmation in FIG. 47.

FIG. 49 is a view showing the data structure of package identification information stored in the identification information storage according to the embodiment 8 of the present invention.

FIG. 50 is a view showing the configuration of the management equipment according to the embodiment 9 of the present invention.

FIG. 51 is a view showing the data structure of package identification information stored in the identification information storage in FIG. 50.

FIG. 52 is a view showing the configuration of the management equipment according to the embodiment 9 of the present invention.

FIG. 53 is a flowchart showing the procedure for the management equipment to confirm the configuration in FIG. 52.

### DETAILED DESCRIPTION OF THE INVENTION

Another object of the embodiment is to provide a technique, which totally manages both the disposable and lease instruments to facilitate cost management on the hospital side and eventually perform a hospital management consultation function, whether explicitly or implicitly.

Now, a whole perspective of the aspects of the present invention is described in detail referring to drawings accompanied.

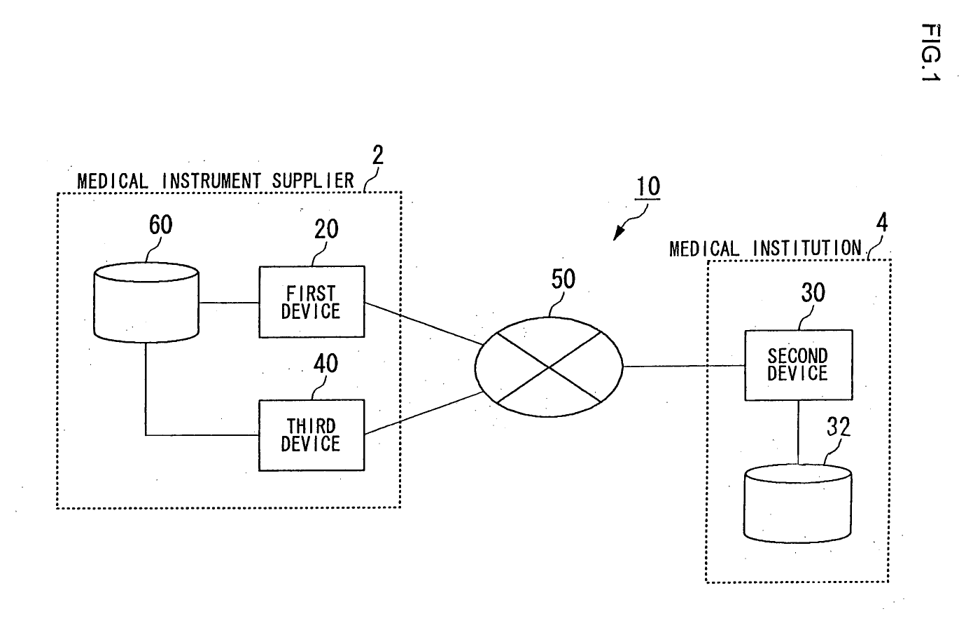

FIG. 1 shows a whole perspective of a medical instrument management system 10 according to one aspect. The medical instrument management system 10 has a first device for supporting delivery of medical instruments to a medical institution 4 such as a hospital, a second device 30 for managing the usage status of medical instrument on the site of the medical institution 4, and a third device 40 for managing the reuse process of the medical instruments used in the medical institution.

In the aspect, the first device 20, the second device 30, and the third device 40 are installed at the site of the medical instrument supplier 2, which collects the medical instruments from the medical institution and performs the task of managing the medical instruments, and the second device 30 is installed at the medical institution 4, where medical practices are conducted using the medical instruments.

Each of the first device 20, the second device 30, and the third device 40 is assembled as a microprocessor with a CPU mounted as a core and has ROM for containing a processing program, RAM for temporarily storing data, any memory for storing data, for example, hard disk, I/O ports, and communications ports.

The first device 20, the second device 30, and the third device 40 are connected to a network 50, for example, the Internet and a LAN, enabling data to be communicated among them.

The first device 20 and the third device 40 are connected to a group of databases 60 built at the site of the medical instrument supplier 2. The database group 60 includes, for example, an inventory database containing information on the medical instrument inventory of the medical instrument Supplier 2, an order-receiving database containing information on kit orders received, a contract database containing information on contracts, and a collection database containing information on medical instruments to be collected. The second device 30 is connected to a group of databases 32 built at the site of the medical institution 4. The database group 32 includes an inventory database containing information on the medical instrument inventory of the medical institution 4.

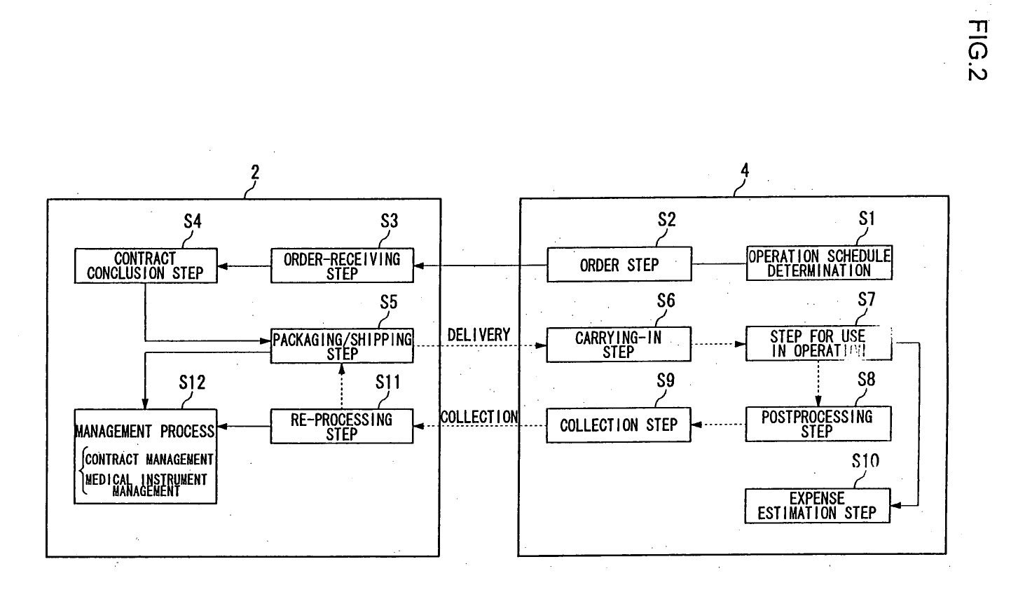

FIG. 2 shows a whole flow of a process from the step of ordering the medical instruments to the step of collecting them in the medical instrument management system 10 according to one aspect of the present invention. In FIG. 2, solid lines indicate the process flow and dotted lines indicate the transfer of goods.

First of all, the schedule of surgical operation is determined at the medical institution 4 (S1). The second device 30 receives detailed information on a standard medical instrument kit for each medical practice from the first device 20, creates an order screen image for selectively displaying a desired kit(s) from a kit list, and brings up the created order screen image on a monitor screen. Watching the order screen image, the user selects the kit appropriate for the scheduled surgical operation. When the kit is selected from the kit list displayed on the screen, the second device 30 sends the kit order information to the first device 20 (S2).

Based on the received ordering information, the first device 20 identifies information required for assembling a kit made of both purchased and lease medical instruments, which will be used in the medical institution 4, for each medical practice and confirms the inventory of the lease medical instruments (S3). Next, based on the order-receiving information, the first device 20 performs a process of concluding a lease contract of the medical instruments to be leased based on order-receiving information and records information on the lease contract in the database 60 (S4). Based on information on the lease contract, the kit is packaged and shipped to the medical institution 4 (S5).

The kit delivered to the medical institution 4 is stored there. The second device 30 records the delivered kit in the database 32 as a stock (S6). On schedule, the delivered kit is used in surgical operation. Before and/or after the surgical operation, information on the kit to be used in the operation is read in the second device 30 and the read information is sent to the first device 20 (S7) Out of the kit used in the operation, the purchased medical instruments are disposed and the lease medical instruments are washed and sterilized (S8). The lease medical instruments, after being washed and sterilized in the medical institution 4, are collected by the medical instrument supplier 2 (S9). The second device 30 calculates the cost of the medical instruments used in the operation and sums up expenses for the operation (S10).

Reusable instruments contained in the collected lease medical instruments are disassembled into subassemblies. After the secondary washing and sterilization steps, their appearances are visually checked and the numbers of usage times are confirmed. They are separated into two groups, reusable subassemblies and non-reusable subassemblies. The non-reusable subassemblies are repaired or replaced with new ones. The reusable subassemblies and the repaired or replaced subassemblies are used to assemble the reusable lease medical instruments (S11). The third device 40 records the progress for each step of the re-processing process, S11, in the database 60.

Thus, in the medical instrument management system 10, the medical instruments ordered by the medical institution 4 are delivered by the medical instrument supplier 2. The lease medical instruments out of the medical instruments delivered by the medical instrument supplier 2, after being used by the medical institution 4, are collected by the medical instrument supplier 2. The reusable medical instruments out of the collected lease medical instruments are reused after the reprocessing process 10. Moreover, in the medical instrument management system 10, the first device 20 performs a medical instrument management task including contract management such as accounting, grasping distribution/circulation status of the leased medical instruments, inventory control of the medical instruments, and confirmation of the number of usage times of them (S12). The third device 40 uses information on usage of individual medical instruments in the hospital to create information available for management reform of the medical institution 4 based on case data and necessary costs. These available information includes, for example, customer analysis based on usage of the medical instruments, sales activities, sales cost management, and asset management.

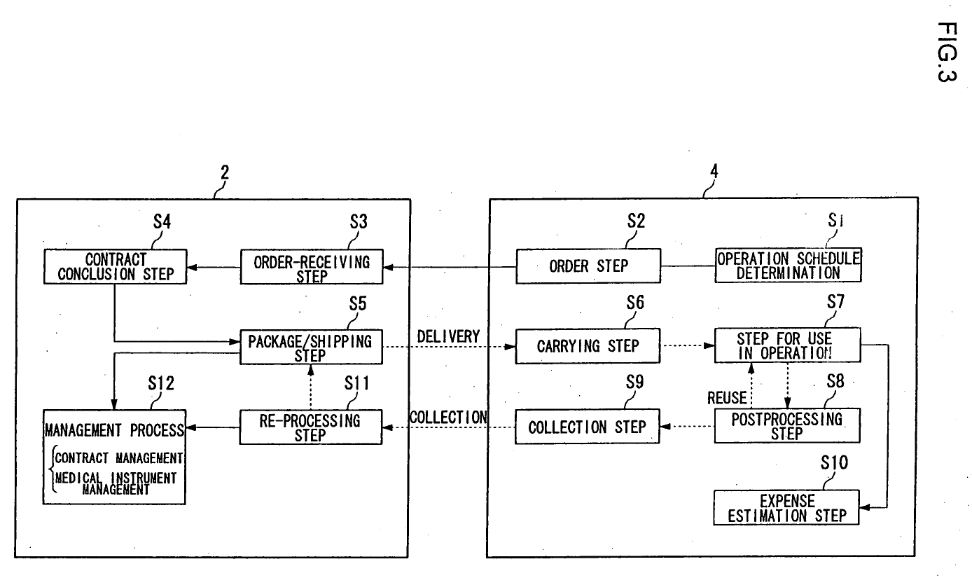

FIG. 3 shows a whole flow of the process from the step of ordering of medical instruments to the step of collecting of them in the medical instrument management system 10 according to another aspect. In FIG. 3, solid lines indicate the process flow and dotted lines indicate the transfer of goods. Since the aspect has a same basic structure as the aspect and its explanation is omitted. In this aspect, the lease medical instruments washed and sterilized at a step S8 are temporarily stored in the medical institution 4 and then reused for surgical operation. The lease medical instruments, which have reach a given limit number of usage times in the medical institution 4 and washed and sterilized, are collected by the medical instrument supplier 2 (S9). Thus, in the aspect, the lease medical instruments circulate through a cycle of use and washing/sterilization in the medical institution and are regularly maintained and collected by the medical instrument supplier 2. For that reason, time and labor required for medical instrument deliver and collection, which are incurred every time a surgical operation is performed, may be saved, reducing the distribution cost.

In the previous paragraphs, the whole configuration and flow of the process of the medical instrument management system 10 have been described.

The characteristics of the present invention described in one aspect and another aspect may be specified by means of following items.

(Item 1)

A medical instrument management system comprising;
a first device supporting the provision of medical instruments to the medical institution,
a second device managing the use of medical instruments on the medical institution side, and
a third device managing a process of reusing the medical instruments used in the medical institution,
wherein the first device identifies information required for assembling a kit composed of the purchased and lease medical instruments to be used for each medical practice in the medical institution,
the second device records the event of usage in connection with the used medical instruments immediately after the medical instruments contained in the kit are used in the actual medical practice, and
the third device records either the process of washing and sterilizing at least the lease medical instruments out of the used medical instruments or the process of maintaining them, said first device being characterized in that it receives data recorded in the second and third devices and base on them, manages circulation status of the medical instruments.
   (Item 2)

The medical instrument management system described in the item 1, wherein the second device further informs the first device of the schedule of the medical practice to be conducted in the medical institution and the first device identifies the medical instruments to be incorporated into the kit based on the schedule.

(Item 3)

The medical instrument management system described in the item 1, wherein the first device transfers information on a standard medical instrument kit for each medical practice to the second device and the second device displays the transferred information so that the user may select or modify it.

(Item 4)

The medical instrument management system described in the item 1, wherein the third device compares attribute values, which identify reuse status of each subassembly of the lease medical instrument put in the process, with given tolerances associated with them and determines the further reusability of each subassembly.

(Item 5)

The medical instrument management system described in the item 1, wherein the first device evaluates usage of the medical instruments by the medical institution based on information contained in the second device and executes an accounting step.

(Item 6)

A medical instrument management method, wherein to manage the medical instruments, it uses the first device supporting the provision of the medical instruments to the medical institution, the second device managing usage of the medical instruments in the medical institution, and the third device managing a reuse process of the medical instruments used in the medical institution, comprising;
a step for identifying information required to built a kit made of both the purchased and lease medical instruments to be used in the medical practice in the medical institution for each medical practice at the first device,
a step for recording the event of usage in connection with the used medical instruments immediately after the medical instruments contained in the kit are used in the actual medical practice at the second device,
a step for recoding the progress of the washing and sterilization step of the lease medical instruments out of the used medical instruments at the third device, and
a step for managing circulation status of the medical instruments based on the received information recorded in the second and third devices at the first device.
   (Item 7)

A medical instrument management method, comprising;
a registering step to register stock medical instruments in an inventory database,
an ordering step to accept an order of medical instruments for each medical practice from the medical institution and writes order information in a order-receiving database,
a shipping order step to assemble the order-receiver medical instruments into a kit for each medical practice, making reference to the inventory database,
a reuse management step to record the event that at least the lease medical instruments out of the medical instruments contained in the kit were used in the medical institution and collected by the supplier, and then the reuse process has been completed for them, and
a re-registering step to re-register the lease medical instruments, for which the event of the reuse process completion has been recorded, in the inventory database as reusable in a kit.
   (Item 8)

The medical instrument management method described in the item 7, wherein it further contains a usage confirmation step to record the event of usage in connection with the used medical instruments immediately after the medical instruments contained in the kit were used in the medical institution, and a uncollected instrument detection step to detect those lease medical instruments, which have been not yet collected on schedule, out of the medical instruments, for which the event of usage has been recorded.

(Item 9)

The medical instrument management method described in the item 7, wherein the reuse process involves steps of washing, drying, and re-sterilizing the lease medical instruments disassembled into subassemblies and then assembles these subassemblies into the lease medical instrument, further comprising;
a step for detecting the attribute value identifying usage status for each subassembly, and
   a step for comparing the detected attribute value with given tolerance to determine the reusability for each subassembly.
      (Item 10)

A medical instrument management system having the first device supporting the provision of the medical instruments to the medical institution and the second device managing the usage of the medical instruments in a given medical institution,
said second device containing an order entry means for entering order data for the given medical institution, and
said first device having; a medical instrument discrimination means for discriminating the medical instruments required for the given medical practice based on the order data entered from the second device;
   an order data management means for managing the medical instruments discriminated at the medical instrument discrimination means and the order data in connection with one another,
   a management information assignment means for assigning management information managed at the order data management means to the medical instruments corresponding to the given medical institution, for which they will be shipped,
   a delivery checking means for checking the medical instruments to be delivered to the medical instrument against the management information managed at the order data management device, and
   a carrying-out checking means for checking the medical instruments, which are to be carried out from the medical institution after the medical practice has been conducted in the given medical institution, against the management information managed at the order data management means.
      (Item 11)

A medical instrument management method, wherein it uses the first device supporting the provision of the medical instruments to the medical institution and the second device managing the usage of the medical instruments in the given medical institution, comprising;
a step for entering order data for the given medical institution from the second device,
a medical instrument discrimination step to discriminate the medical instruments required for the given medical practice based on the order data entered from the second device at the first device,
an order data management step to manage the medical instruments discriminated at the medical instrument discrimination step and the order data in connection with one another at the first device,
a management information assignment step to assign the management information managed at the order data management step to the medical instruments corresponding to the given medical institution, for which they will be shipped,
a delivery checking step to check the medical instruments delivered to the medical institution against the management information managed at the order data management device, and a carrying-out checking step to check the medical instruments, which are to be carried out from the medical institution after the medical practice has been conducted in the given medical institution, against the management information managed at the order data management means.

Regarding the item 1, a “kit” is a package of medical instruments to be used in given medical practices including endoscopic surgery, gastric resection, and lienectomy. For example, the kit for endoscopic surgery contains purchased medical instruments, which are purchase by the medical institution from the medical instrument supplier and disposed after being used in the medical institution, including reusable lease medical instruments such as an endoscope, tweezers, and trocar, and disposable instruments such as an electrode, clip, endopouch, and cherry disector.

According to the item 1, the management task is streamlined for both the purchased and lease medical instruments in the medical institution, reducing the management cost because circulation status of the medical instruments may be managed from building up the kit to be used in the medical practice in the medical institution to the confirmation of use of the medical instruments contained in the kit and the process of washing them.

Note that the first and third devices independently configured in the item 1 may be implemented as one integrated device by combining the processes performed at them.

The medical instrument supplier may comprehensively manage the purchased and lease medical instruments, facilitating hospital cost management and eventually providing a hospital management consultation service.

According to the item 2, the medical instruments composing a kit may be appropriately identified depending on the medical practice scheduled by the hospital, reducing manpower for acquiring both the purchased and lease medical instruments on the medical institution.

According to the item 3, the user may flexibly select and modify the medical instruments contained in the kit depending on the needs of each of the medical practices scheduled by the medical institution.

According to the item 4, it may be determined whether each of subassemblies composing the lease medical instrument is reusable or not, enabling stricter quality management.

According to the item 5, the accounting process may be streamlined depending on usage status of the medical instruments in the medical institution.

According to the item 8, the management task is streamlined for both the purchased and lease medical instruments in the medical institution, reducing the management cost because circulation status of the medical instruments may be managed from building up the kit to be used in the medical practice in the medical institution to the confirmation of use of the medical instruments contained in the kit and the process of washing them.

According to the item 7, the management task may be totally performed including the inventory management of the medical instruments, the orders of the medical instruments by the medical institution, the shipping of the order-receiving medical instruments, the reuse process of the lease medical instruments, and management of reusable lease medical, instruments, achieving appropriate medical instrument management as well as a reduction in management cost.

According to the item 8, the lease medical instruments, which have not yet been collected after being used in the hospital, may be correctly detected, enabling further appropriate management of the lease medical instruments.

According to the item 9, it may be determined whether each of subassemblies composing the lease medical instrument is reusable or not, enabling stricter quality management.

According to the items 10 and 11, the process may be totally managed from the orders of the medical instruments by the medical institution, the delivery of the ordered medical instruments, to the collection of the medical instruments used in the medical institution. This saves the time and labor required for managing the medical instruments on the medical institution side and facilitates the recycle management of the medical instruments, successfully reducing the cost of the medical instruments.

In the following paragraphs, various kinds of systems representative of the present invention are described.

<Lease Contract Concluding and Fulfillment Confirmation System>

### Embodiment 1

According to techniques disclosed in the patent documents 1 and 2, the acquiring process and the cost of disposable and reusable medical instruments may be partially improved. However, actually, a mixture of disposable and reusable medical instruments are used in the medical field and even tough an improvement plan is proposed focusing on one of two types of medical instruments, a whole efficiency of hospital practices may not easily improved or at least a room for improvement may be left.

In this context, the embodiment 1 has been developed and its object is to provide a technique, which allows the hospital to facilitate the management of both the disposal and reusable medical instruments by the hospital and reduce manpower for acquisition of them and their cost.

According to the embodiment 1, the lease, purchasing, and pre-processing contracts at the stages from the ordering of the medical instruments to the delivery of them may be concluded together between the medical institution and the medical instrument supplier and a contract fulfillment confirmation process is executed at the stages from the delivery of the medical instruments to the collection of them. These processes are executed and the contract is managed for each medical instrument lot, ensuring the convenience and reliability of contract conclusion.

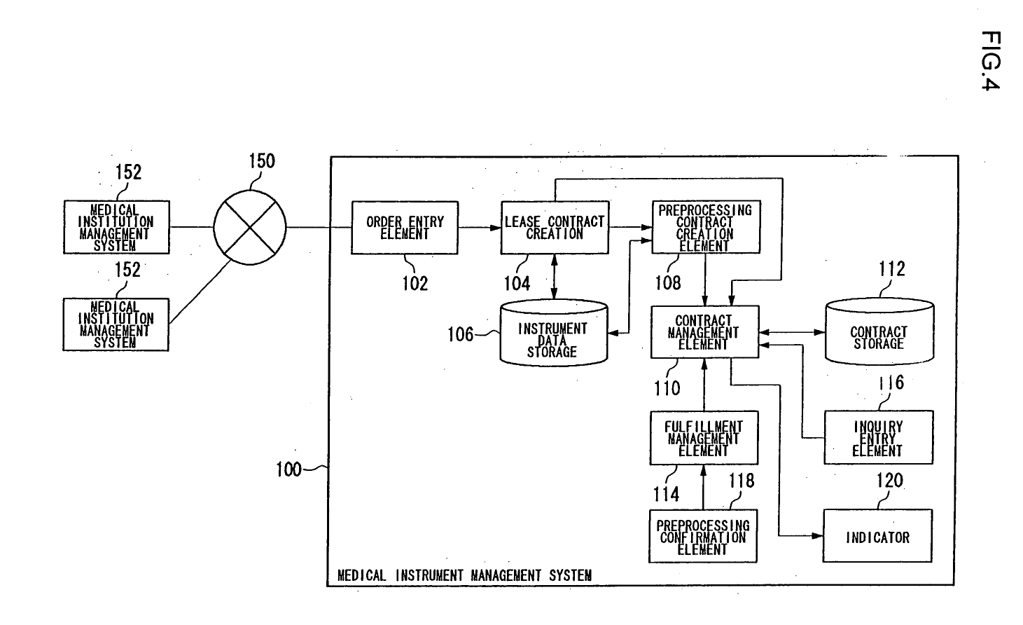

FIG. 4 is a functional block diagram showing the basic configuration of the medical instrument management system to be installed at the sites of the supplier and customer of the medical instruments. Medical institution management systems 152 to be individually installed a plurality of medical institutions are connected to a medical instrument management system 10 through a network 150. Herein, the medical institution management systems 152 are used for managing the orders of the medical instruments, order information, and contracts and order data describing the ordered medical instruments are sent to the medical instrument management system through the network 150. Note that the medical instrument management system 100 and the medical institution management systems 152 correspond to the first device 29 and the second device 30, respectively as shown in FIG. 1.

The medical instrument management system 100 has an order entry element 102, a lease contract creation element 104, an instrument data storage 106, an preprocessing contract creation element 108, a contract management element 110, a contract storage 112, a fulfillment management element 114, a inquiry entry element 115, a preprocess confirmation element 118, and an indicator 120.

The order entry element 102 accepts order data. The order data may be entered directly from the medical instrument management system 100, however, herein, it receives the order data from the medical institution management systems 152 through the network 150. The order data may specify the ordered medical instruments or the type of a medical practice to be performed or a case name. According to the embodiment 1, the case name is specified in the order data.

The lease contract creation element 104 extracts the order of the lease medical instruments to be leased and the purchased medical instruments to be purchased based on a given instrument table. The instrument table has been previously stored in the instrument data storage 106. The instrument table corresponds such information as the names, classes, contract types, and identification numbers of the lease and purchased medical instrument to the medical practice name or the case name. The lease contract creation element 104 extracts necessary lease and purchased medical instruments from the instrument table based on the medical practice name or the case name specified in order data.

The lease contract creation element 104 creates the lease contract data on the lease contract of the extracted lease medical instruments with the purchasing contract data on the purchasing contract of the extracted purchased medical instruments. The lease contract data is composed of information such as the contracted medical instruments, identification information, and the contract date, which are corresponded each other. As soon as the lease contract data is created and stored, it is assumed that both the parties have agreed the contract and the contract has been concluded. Similarly, the purchasing contract data is composed of information such as the contracted medical instruments, identification information, and the contract date, which are corresponded each other. As soon as the lease contract data is created and stored, it is assumed that both the parties have agreed the contract and the contract has been concluded.

The preprocessing contract creation element 108 further creates the preprocessing contract data as a contract of the contracted leased medical instruments. The preprocessing contract is a contract of preprocessing process to be performed on the lease medical instruments including inspections before being leased. The preprocessing process contains, for example, steps of collecting, washing, sterilizing, checking, repairing, assembling, and individual packaging of the lease medical instruments already leased. The preprocessing contract data is composed of information such as the contracted medical instruments, identification information, and the contract date, which are corresponded each other. As soon as the lease contract data is created and stored, it is assumed that both the parties have agreed the contract and the contract has been concluded. The preprocessing confirmation element 118 accepts the entry on date when the preprocessing process is performed and the contract is fulfilled in preprocessing the lease medical instruments before being leased. The fulfillment management element 114 writes the received fulfillment date in the preprocessing contract data and assumes that the preprocessing contract has been fulfilled at that time. According to the embodiment 1, the fulfillment date of the preprocessing contract is entered when the preprocessing including steps of collecting, checking, and repairing the preprocessing-contracted medical instruments after being used in the medical institution.

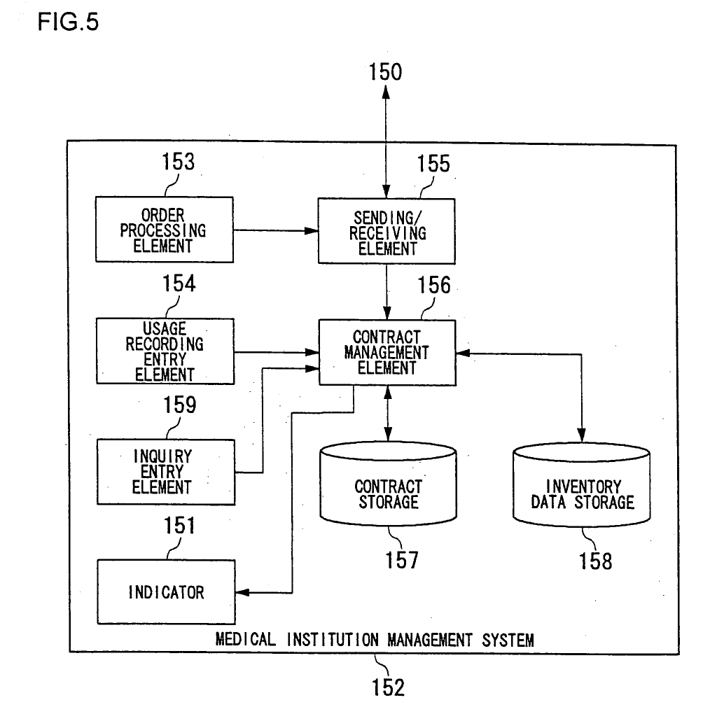

The contract management element 110 records the order data, lease contract data, purchasing contract data, and preprocessing contract data in connection with each other in the contract storage 112. The inquiry entry element 116 accepts the entry for inquiring at least any of the order data, lease contract data, purchasing data, and preprocessing contract data recorded in the contract storage 112. The inquiry entry element 116 extracts at least any of the order data, lease contract data, purchasing data, and preprocessing contract data, for which an inquiry has been accepted, recorded in the contract storage 112 and displays it on the indicator 120. This allows the administrator to extract and access his/her desired contract data. The contract management element 110 can add the given cost up to the medical institution's account when the contract has been fulfilled FIG. 5 is a functional block diagram showing the basic configuration of the medical instrument management system. The medical institution management system 152 has an indicator 151, an order processing element 153, a usage record entry element 154, data send/receive element 155, a contract management element 156, contract storage 157, an inventory data storage 158, and an inquiry entry element 159. The medical institution management system 152 is installed at each medical institution for performing inventory management, order management, and contract management. The order processing element 152 creates the order data based on information entered by the manager responsible for the medical instruments in the medical institution and sends it to the medical instrument management system 100 through the data send/receive element 155.

The data send/receive element 155 receives the contract data sent from the medical instrument management system 100 in response to the entry of the order data and sends it with the order data obtained from the order processing element 153 to the contract management element 156. The contract data includes the lease contract data, preprocessing contract data, and purchasing contract data. The contract management element 156 records the order data and the contract data in the contract storage 157 and updates the numbers of medical instrument stocks based on the order data. The numbers of medical instrument stocks are stored in the inventory data storage 158. A date, when the contracted medical instruments are used in the medical institution and the lease contract is fulfilled, is entered in the usage record entry element 154 by the manager of the medical institution. The contract fulfillment date is written into the contract data stored in the contract storage 157 and sent to the medical instrument management system 100 through the data send/receive element 155. The order entry element 102 of the medical instrument management system 100 sends data on the contract fulfillment data to the contract management element 110, which in turn, writes the fulfillment date data in the lease contract data. This ensures the liability of lease contract fulfillment and the convenience of medical instrument management.

From the inquiry entry element 159, information required for inquiring the contract data stored in the contract storage 157 or the inventory data stored in the inventory data storage 158 is entered by the manager. The contract data or the inventory data are extracted by the contract management element 151 in response to the inquiry and displays it on the indicator 151.

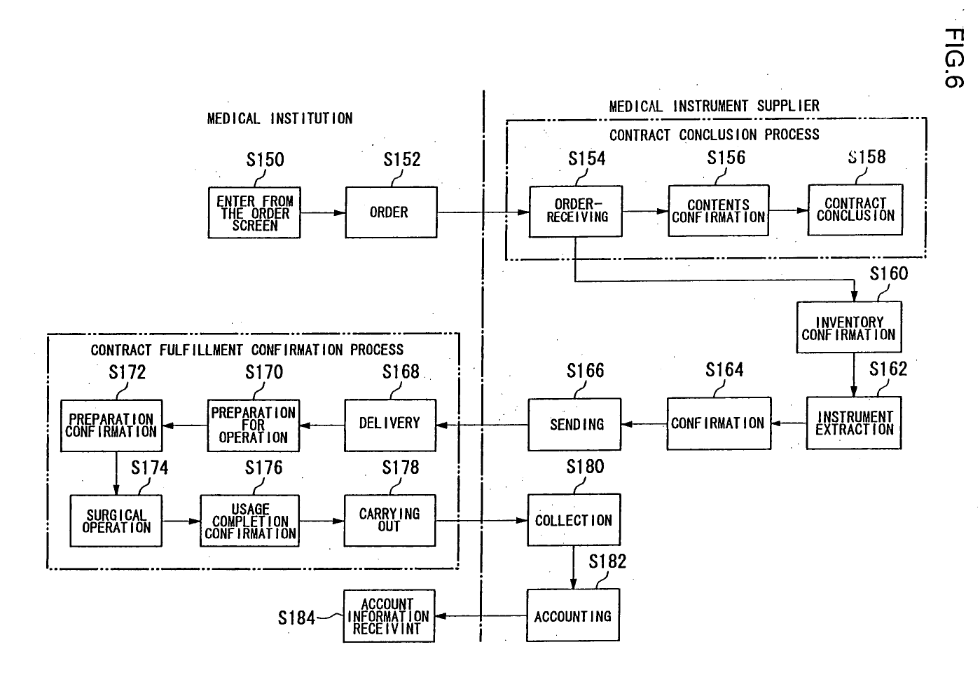

FIG. 6 is a schematic diagram showing a whole flow of the process from the step of ordering the medical instruments to the accounting step between the medical institution and the medical instrument supplier. First of all, the manager responsible for the medical instruments enters order information from the order screen in the medical institution (S150), the entered order data is sent to the medical instrument management system 100 (S152), and the sent order data is received by the order entry element 102 of the medical instrument management system 100 (S154).

After the contents of the order data received at the step S154 are confirmed (S156), based on the order data, the lease contract, preprocessing contract, and purchasing contract are concluded, respectively (S158). The process from the step, S154 to he step, S158 is a main contract conclusion process.

After based on the order data received at the step, S154, the inventory of the ordered medical instrument is checked (S160), the contracted medical instruments are extracted from the stock (S162), the number and the configuration of the medical instruments are finally checked (S164), and these medical instruments are sent to the medical institution (S166).

The medical instruments shipped from the medical instrument supplier are delivered to the medical institution (S168), the preparation of the scheduled surgical operation is set out (S170), the completeness of the preparation is confirmed (S172), and then the surgical operation is conducted (S174). After the surgical operation has been finished, the date when at lease the lease-contracted lease medical instruments out of the medical instruments used in the surgical operation is entered as the contract fulfillment date (S176), and the used lease medical instruments are carried out to the medical instrument supplier (S178) The process from the step, S168 to the step, S178 is a main contract fulfillment confirmation process.

The used lease medical instruments carried out from the medical institution are collected (S180) and the account data with a leasing fee charged according to the numbers and types of the used medical instruments is sent to the medical institution (S182), which in turn, receives it (S184).

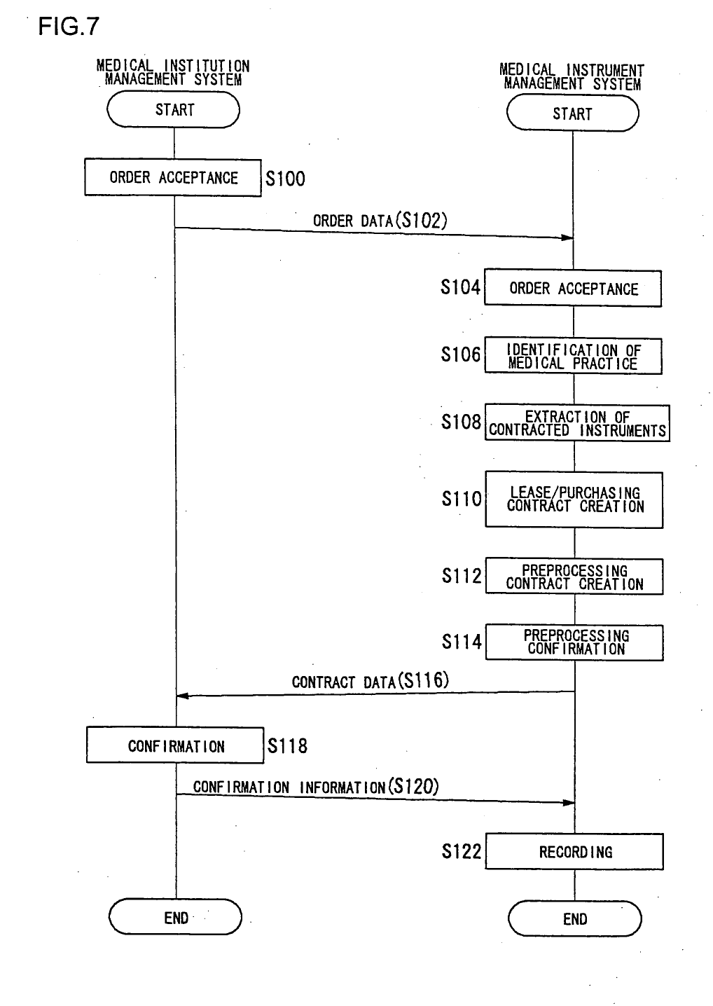

FIG. 7 shows flows of the contract conclusion process and the data related to it between the medical institution management system and the medical instrument management system. The medical institution management system 152 accepts the order of the medical instruments from the manager of the medical institution (S100), and sends the order data to the medical instrument management system 100 (S102), which in turn, received it (S104). The medical instrument management system 100 identifies a medical practice or a case based on the order data (S106), extracts the lease-contracted and purchasing-contracted medical instruments (S108), and creates the lease contract data and purchasing data (S110). Moreover, the preprocessing contract for the lease-contracted lease medical instruments is further created (S112), the contract fulfillment date after it is confirmed that the contract has been fulfilled is recorded (S114), and the lease contract data, the purchasing contract data, and preprocessing contract data are sent to the medical institution management system 152 (S116).

The medical institution management system [symbol] , when receiving the lease contract data, the purchasing contract data, and the preprocessing contract data, sends the contract information to the manager of the medical institution for confirmation (S119), and after the confirmation, a notification of the completion of confirmation to the medical instrument management system 100 (S120). The medical instrument management system 100 records the contract data in the contract storage 112 (S122) as soon as the contract information is confirmed.

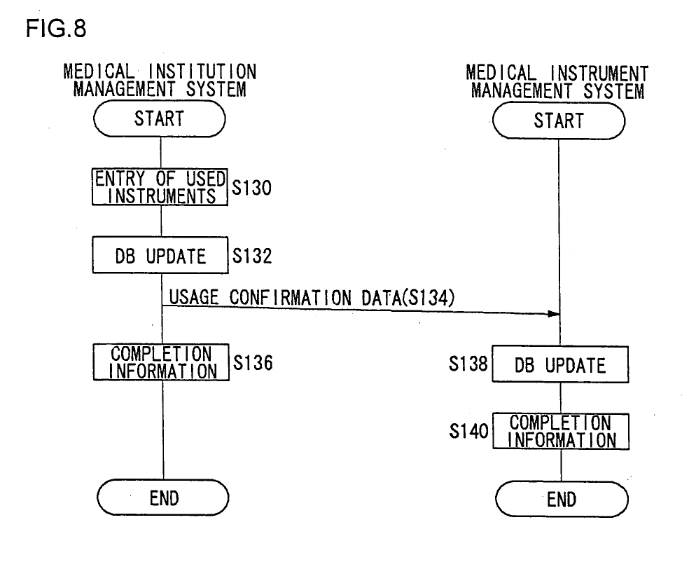

FIG. 8 shows flows of the contract fulfillment confirmation step and the data related to it between the medical institution management system and the medical instrument management system. To the medical institution management system, the lease contract fulfillment date for the lease medical instruments used in the surgical operation is entered by the manager of the medical institution as an evidence of usage (S130). The medical institution management system 152 updates the medical instrument database built in the medical institution based on the contract fulfillment date entered (S132), sends the information on the contract fulfillment date to the medical instrument management system 100 (S134), and informs the manager of the completion of the lease contract of the lease medical instruments.

The medical instrument management system 100, when receiving the lease contract fulfillment date, updates the database by writing the fulfillment date in the lease contract data (S138) and informs the indicator 120 of the completion the lease contract (S140).

Note that the contract fulfillment date entered at the step, S130 may be performed in sync with, for example, any of the step for delivering the medical instruments (S168), the step for preparation or operation (S170), the step for confirming the usage of them (S176), and the step for collecting the used medical instruments (S180). In the case where the contract fulfillment date is entered from the medical institution, the manager may enter it directly from a mobile terminal.

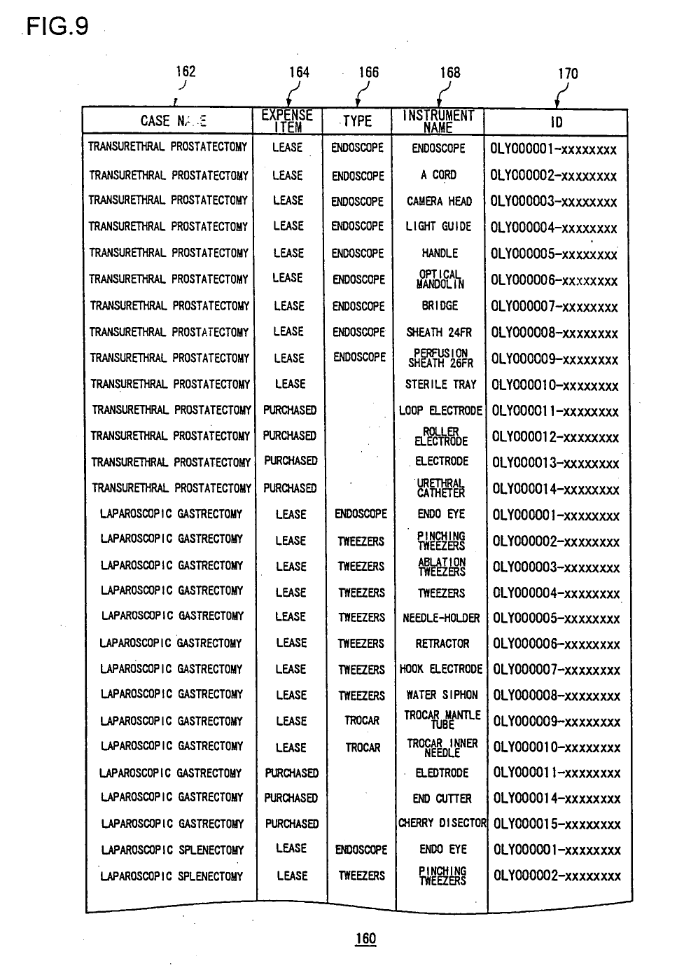

FIG. 9 is a schematic diagram showing the contents of the instrument table. The instrument table 160 is stored in the instrument data storage 106. The instrument table 160 contains a case name column 162, an expense item column 164, a model class column 166, an instrument name column 168, and an instrument ID column 170. The case name column 162 contains the case name or medical practice such as “transurethral prostatectomy”, “laparoscopic gastrectomy”, and “splenectomy”. The expense item column 164 contains the contract class such as “lease contract” and “purchasing contract”. The model class column 166 contains the medical instrument class such as an “endoscope”, tweezers”, and “trocar”. The instrument name column 168 contains medical instrument name such as an “endoscope”, “A cord”, “camera head”, and “light guide”. The instrument ID column contains the instrument identification information for identifying the medical instrument, for example, “OLY000001-xxxxxxxx” and “OLY000002-xxxxxxxx”. The instrument identification information is made of a combination of a portion “OLY000001” uniquely assigned to each type of medical instruments and a portion “xxxxxxxx” uniquely assigned to each lot of medical instruments.

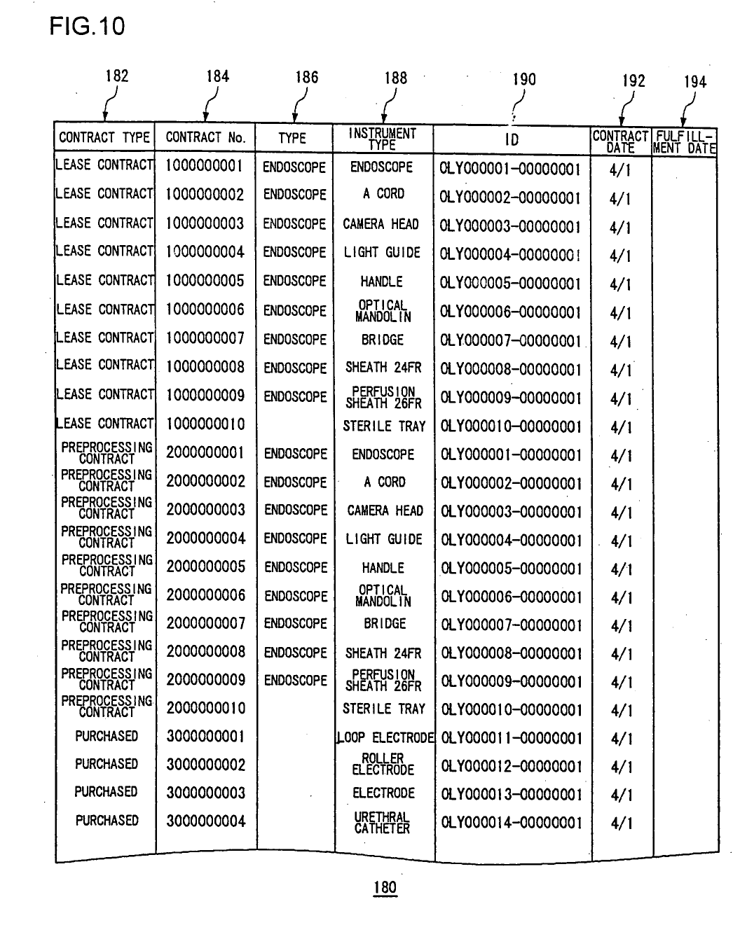

FIG. 10 is a schematic diagram showing the contents of the contract table. The contract table 180 is stored in the contract storage 112. The contract table contains a contract type column 182, a contract number column 184, a model class column 186, an instrument name column 188, and an instrument ID column 190. The contract type column 182 contains the contract type such as “lease contract”, “reprocessing contract”, and “purchasing contract”. The contract number column 184 contains the contract number such as “1000000001”, “2000000001”, and “3000000001”. The contract number is uniquely assigned to each contract and its most significant digit reflects the contract type. For example, “1” indicates the lease contract, “2” indicates the preprocessing contract, and “3” indicates the purchasing contract, respectively. The model class column 186 contains the classes of the medical instruments such as an “endoscope”, “tweezers”, and “trocar”. The instrument name column 188 contains the medical instrument name such as an “endoscope”, “A cord”, “camera head”, and “light guide”.

The instrument ID column 190 contains instrument identification information for identifying the medical instruments, for example “OLY000001-00000001” and “OLY000002-00000001”. The instrument identification information is made of a combination of a portion “OLY000001” uniquely assembled to each type of medical instruments and a portion “00000001” uniquely assigned to each lot of medical instruments. The contract date column 192 contains the date of contract conclusion. The fulfillment date column 194 contains the date when the contract has been fulfilled, namely the date when the lease-contracted medical instrument has been used or the date when the preprocessing-contracted medical instrument has been preprocessed. In FIG. 10, since no contracted medical instrument has been used and no preprocessing-contracted medical instrument has been preprocessed, the fulfillment date 194 continues to contain no fulfillment date.

Thus, the lease contract data, the preprocessing contract data, and the purchasing contract data are tabulated and stored in the contract storage 112. These contract data may be extracted from the contract table 180 using the instrument identification information as a key.

### Embodiment 2

Lease instrument preprocessing according to the embodiment 2 differs from that according to the embodiment 1 in that it involves only the steps of collecting, inspecting, repairing, assembling, individually packaging or assembling into a kit of the lent lease medical instruments excluding the steps of washing, disinfecting, and sterilizing them. Namely, the steps of washing, disinfecting, and sterilizing the lease medical instruments are performed on the medical institution side and the steps of collecting, inspecting, repairing, assembling, and individually packaging them are performed on the medical instrument supplier side. In this case, the used lease medical instruments, after being washed, disinfected, and sterilized, are reused in the medical institution and they, after being used several times, are collected by the medical instrument supplier. For this reason, the lease contract and the preprocessing contract are concluded on the assumption the medical instruments are collected after being used several times. Thus, the medical instrument management system 100 according to the embodiment 2 may easily conclude the contract regardless of the assumed number of usage times and reduce the burden of the job of maintaining and managing the medical instruments on the medical institution.

Note that according to the embodiment 1 or 2, the lease contract, purchasing contract, and preprocessing contract are concluded for each lot of medical instruments and the contract data are created. In an example of a variant, the lease contract creation element 104 and the preprocessing contract creation element 108 may create the lease contract, purchasing contract, and preprocessing contract may be created as a comprehensive contract using the contraction expiration date or the number of delivery times or collected times as a unit regardless of the number of articles. In this case, the fee for each contract may be flexibly set and the number of managed medical instruments and the unit of contracted medical instruments may be also flexibly set.

Moreover, in the embodiments 1 and 2, the medical practice name or the case name is specified in the order data. In an example of the variant, the medical instrument name may be specified in the order data. In the embodiments 1 and 2, a laparoscopic surgery is used as a medical practice name or the case name but it is not intended to limit to the laparoscopic surgery.

The characteristics described in the embodiments 1 and 2 may be specified by the following items.

(Item 12)

A medical instrument management system, comprising;
an order entry element for accepting the order data on the medical instrument ordered by the given medical institution,
a lease contract creation element for extracting the order of the lease-contracted lease medical instruments based on the order data entered and creating the lease contract data on the lease contract of the lease contract medical instruments extracted,
a preprocessing contract creation element for creating the preprocessing contract data on the preprocessing contract involving a checking step to be performed before the lease-contracted lease medical instruments are used, and
a contract management element for recording the order data, lease contract data, and preprocessing contract data in connection with each other.
   (Item 13)

A medical instrument management system, comprising;
an order entry element for accepting the order data on the medical instrument entered by the given medical institution,
a lease contract creation element for extracting the order of the lease-contracted lease medical instruments based on the order data entered and creating the lease contract data on the lease contract of the lease contract medical instruments extracted,
a preprocessing contract creation element for creating the preprocessing contract data on the preprocessing contract involving a checking step to be performed before the lease-contracted lease medical instruments are used,
a preprocessing confirmation element for entering preprocessing execution data indicating that the lease-instrument preprocessing has been executed in lease-instrument preprocessing of the lease medical instruments,
a fulfillment management element for recording fulfillment status of the preprocessing contraction as preprocessing management data based on the preprocessing execution data, and
a contract management element for recording the preprocessing management data, order data, and lease contract data in connection with each other.
   (Item 14)

A medical instrument management system, comprising;
an order entry element for accepting the order data on the medical instrument entered by the given medical institution in the form of the type of a medical practice,
a medical instrument extraction element for extracting the medical instruments required for the specified medical practice based on the entered order data,
a lease contract creation element for further extracting the order of the lease-contracted lease medical instruments from the extracted medical instruments and creating the lease contract data on the lease contract of the lease contract medical instruments extracted,
a preprocessing contract creation element for creating the preprocessing contract data on the preprocessing contract involving a checking step to be performed before the lease-contracted lease medical instruments are used, and
a contract management element for recording the preprocessing management data, order data, and lease contract data in connection with each other.
   (Item 15)

The medical instrument management system described in any of items 12 to 14, wherein the lease contract creation element creates the lease contract data with purchasing contract data on the purchasing contract of non-lease medical instruments and the contract management element further records each contract data in connection with the purchasing contract data.

(Item 16)

The medical instrument management system described in any of items 12 to 15, wherein the lease contract creation element creates the contract in the form of a comprehensive contract using the contract expiration period or the number of deliveries or collections as a unit regardless of the number of contracted articles.

(Item 17)

A medical instrument management method, comprising;
a step for acquiring order data on medical instruments ordered by a given medical institution via a network,
a step for extracting lease-contracted lease medical instruments based on the order data by referring to a given table, a step for creating lease contract data on the lease contract of the extracted lease medical instruments,
a step for creating preprocessing contract data on lease-instrument preprocessing contract of a lease-instrument preprocessing involving a checking step to be performed before the lease medical instruments described in the lease contract date,
a step for recording the order data, lease contract data, and preprocessing contract data in connection with each other, and a step for displaying at least any of the order data, lease contract data, and preprocessing contract data on a screen in response to an inquiry about a contract, if any.

Herein, some medical instruments are defined to be used only once and the others are defined to be used several times by means of a checking step and the like. According to the item 12, the ordering party may order the medical instruments defined to be used only once and the medical instruments defined to be used several times without identification them. Moreover, in the case where the lease contract of the medical instruments defined to be used several times is concluded, the same numbers of contracts as those of contracted medical instructions must be concluded. According to this aspect, since the medical instruments defined to be used several times may be easily extracted based on the order data, a step for concluding the lease contract of these medical instruments may be streamlined. Moreover, since checking of the lease medical instruments and management of the number of usage times of the medical instruments, contract information, and the like are managed by the supplier, the medical institution is released from these management tasks, achieving a reduction in management cost.

According to the item 13, a contract of carrying out for preprocessing the lease-contracted medical instruments before being lent may be concluded at the same time. The lease contract and the preprocessing contract need to be individually concluded from a legal point of view. On the other hand, according to this aspect, since they may be easily concluded at the same time, the ordering party may ensure the appropriate fulfillment of the preprocessing contract by strictly managing information indicating that preprocessing has been completed.

According to the item 14, the party ordering the medical instruments may order the medical instruments using an appropriate type and number of units simply by identifying the type of a medical practice or the case name only. For that reason, the step for ordering the medical instruments may be streamlined and any missing order may be avoided for each medical practice or each case, improving the safety of medical practices.

According to the item 17, since the medical instruments defined to be used several times may be easily extracted based on the order data, the ordering party may order a plurality of medical instruments without paying attention to the identification of the number of usage times.

<Subassembly Management System>

### Embodiment 3

The invention disclosed in the patent document 1 uses an assumption that metal functional subassemblies are reusable after being sterilized from the result of the experiment. It should be determined whether the metal functional subassemblies separated from the disposable instruments may be actually reused by microscopic examination and the like. However, the re-examination of the metal functional subassemblies separated from the disposable instruments requires additional cost and time. Namely, such a method relies only on the examination when usability is determined with missing view of effective management of a determination step.

The embodiment 3 has been developed in this context and its object is to provide a technique for efficiently managing the medical instruments using their subassemblies as basic units.

As described before, the medical instruments may be largely divided into two groups, purchased medical instruments and lease medical instruments. Note that even single-use purchased medical instruments may contain reusable subassemblies. On the contrary, the usable lease medical instruments are not always reusable infinitely. For example, in the case of the tweezers, an exhaust factor depends on the individual subassemblies. The subassembly called an end effecter for pinching a site to be operated is thought to be severely exhausted. On the contrary, a handle operated by a surgeon is thought to be less exhausted. In the embodiment 3, the medical instruments are managed according to their characteristics on a basis of the subassemblies of the medical instruments.

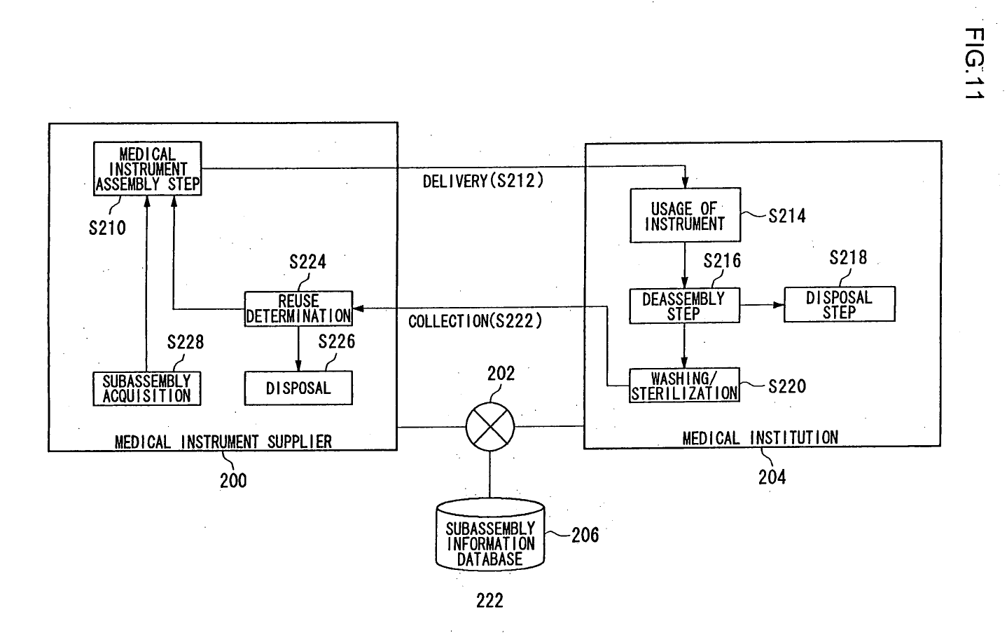

FIG. 11 is a schematic diagram explaining a distribution channel of the subassemblies of the medical instruments (hereinafter, simply referred to as “subassemblies”) in the medical instrument recycle system. In the subassembly recycle system 222, the medical instrument supplier 200, the medical institution 204, and the subassembly information database 206 are connected each other through the Internet 202. In the figure, the subassembly recycle system 222 is composed of one medical instrument supplier 200 and one medical institution 204 for easy recognition. Usually, the whole subassembly recycle system 222 is composed of a plurality of medical instrument suppliers 200 and the Internet 202.

The medical instrument supplier 200 is a supplier of medical instruments, for example, a medical instrument manufacturer. The medical institution 204 is a user of the medical instruments and as a usual example, a hospital is given. The subassembly information database 206 is a database for managing subassembly information for each subassembly. The subassembly information database may be built in the medical instrument supplier 200. The certified third party may be able to access the subassembly information database 206 through the Internet 202.

First of all, the medical instrument supplier 200 assembles the medical instruments to be delivered to the medical institution 204 (S210). The medical instrument supplier 200 delivers the assembled medical instruments to the medical institution 204 (S212). Usually, the medical instruments are delivered based on an order issued by the medical institution 204. In the medical institution 204, the delivered medical instruments are used (S214). The medical instruments, namely the subassemblies composing the medical instruments are contaminated while being used. The medical instruments are disassembled after being used (S216). Among the disassembled subassemblies, non-reusable ones (hereinafter, simply referred to as “disposable subassembly”) are disposed (S218). Usually, a medical waste disposer collects these disposable subassemblies. The reusable subassemblies are washed and then sterilized (S220). The medical instrument supplier 200 collects these washed and sterilized subassemblies (S222).

It is determined whether the collected reusable subassemblies are to be reused or disposed depending on their usage (S224). The step at S224 is described in detail later. The reusable subassemblies determined to be disposed are disposed (S226). Usually, the medical waste disposer collects these reusable subassemblies. The reusable subassemblies determined to be reusable are reused in the medical instruments at the step S210. In assembling the medical instruments at the step S210, new subassemblies are acquired if appropriate (S228). The subassemblies made internally by the medical instrument supplier 200 may be acquired. Alternatively, the medical instrument supplier 200 may acquire new ones from an external manufacturer.

The process from the acquisition of the subassemblies to the disposal of them has been described in the previous paragraphs. Along with the execution of each process in the distribution channel, subassembly status data are entered in the subassembly information database 206 if appropriate. Detail information may be found later. At the step S224, based on the subassembly information stored in the subassembly information database 206, it is determined whether the reusable subassemblies are to be reused or not. These steps may be executed by either the medical instrument supplier 200 or the medical institution 204. Alternatively, the medical instrument supplier 200 may take back the medical instruments used at the step S214 and execute the steps after S214. Note that a billing step is also executed along with the order or delivery of the medical instruments but the detail information on them are omitted for easy recognition from FIG. 11.

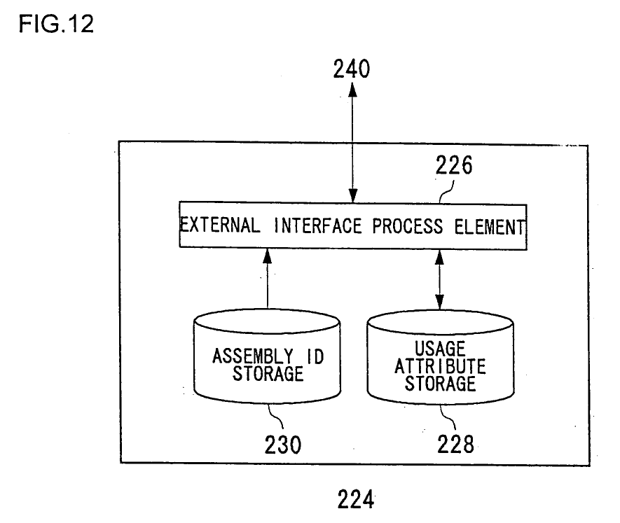

FIG. 12 is a functional block diagram showing a subassembly information terminal 224 containing subassembly information to be assigned to the subassemblies. The subassembly information terminal 224 contains an external interface process element 226, usage attribute storage 228, and subassembly ID storage 230. To the subassemblies composing the medical instruments, the subassembly information terminal 224 is assigned for managing identification information identifying the subassembly (hereinafter, simply referred to as “subassembly ID”) and information on usage status of the subassembly (hereinafter, simply referred to as “usage attribute”). The subassembly ID is a unique ID assigned to each subassembly regardless of the type of the subassembly. At present, non-contact type of tags called RFID (Radio Frequency Identification) is being commonly used. The subassembly information terminal 224 is implemented on such a small read/write recording medium.

The subassembly ID storage 230 stores subassembly IDs. The subassembly ID storage 230 may store the subassembly IDs, as well as other various types of information such as the types of subassemblies. The usage attribute storage 228 stores the usage attribute values of the subassemblies. The usage attribute value is a measure for usage status of the subassemblies. For example, the usage attribute value may be the number of usage times of the subassembly. Alternatively, it may be a usage point identified based on usage status or the exhaust factor. The usage point is calculated depending on status of the subassembly being used. For example, the subassembly used in a long-hour surgical operation has many usage points according to the length of time required for a surgical operation in which it is used. Alternatively, based on the type of a surgical operation, a possible exhaust factor is set for the subassembly in advance and the usage points may be set based on the status of the surgical operation.

The external interface process element 226 is responsible for the interface process with the medical instrument management equipment 240. The medical instrument management equipment 240 reads out subassembly IDs and the usage attribute values through the external interface process element 226. It also updates the usage attribute values in the usage attribute value storage 228 through the external interface process element 226. The external interface process element 226 may display the usage attribute values by means of visual information such as numeric values and colors. When the usage attribute values exceeds the threshold defined in advance, the external interface process element 226 may inform the user of it by means of indication with a color different from the normal one.

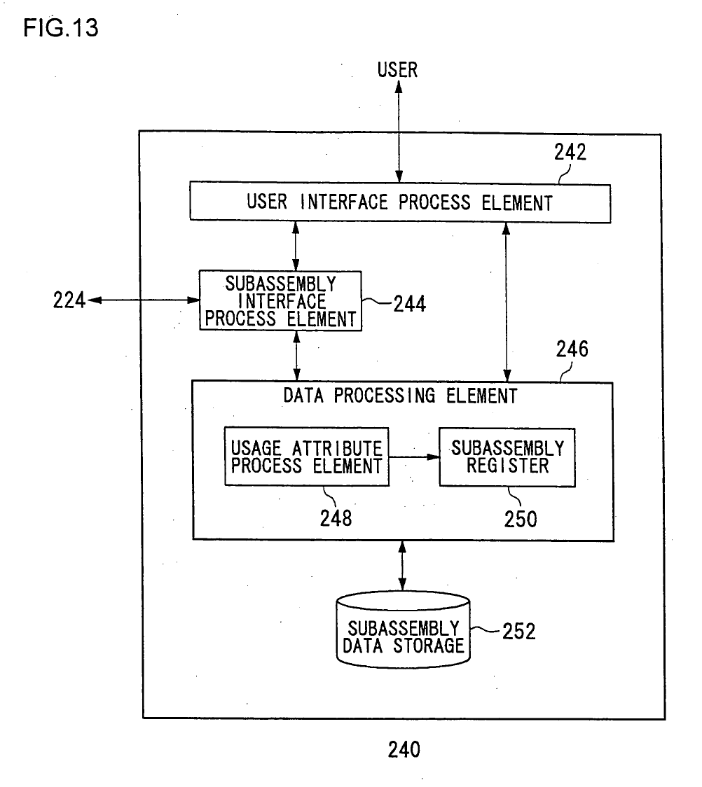

FIG. 13 is a functional block diagram showing the medical instrument management equipment 240. Each block shown in the figure may be implemented using elements and mechanical devices including a CPU by hardware while using a computer program by software. Herein, a functional block, which operates in cooperation between hardware and software, is illustrated. For that reason, the person skilled in the art may fully recognize that these functional blocks may be implemented in various forms by combining hardware and software. Most of the functionality of medical instruction management equipment 240 may be implemented mainly by means of the personal computer and software developed for it in the medical instrument supplier 200. Note that the medical instrument management equipment 240 is corresponding to the fist device 20 in FIG. 1.

The medical instrument management equipment 240 contains the user interface process element 242, the subassembly interface process element 244, the data processing element 246 and the assembly data storage 252. The main function of the subassembly data storage 252 may be implemented by the subassembly information database 206. The data structure of the subassembly data storage 252 is described in detail later. The user interface process 242 is responsible for the process of user interface. The user interface process element 2.42 displays various kinds of information on subassemblies on the user screen. The subassembly interface process element 244 is responsible for the process of interfacing with the subassembly information terminal 224. The subassembly interface process element 244 acquires the subassembly IDs and the usage attribute values from the subassembly information terminal 224 assigned to the subassemblies. Moreover, the subassembly interface process element 244 writes the usage attribute values in the subassembly information terminal 224.

The data processing element 246 processes and stores data acquired by the subassembly interface process element 244 and the user interface process element 242 in the subassembly data storage 252. Moreover, the data processing element 246 converts data to be stored in the subassembly data storage 252 to the format for the subassembly interface process element 244 and the user interface process element 242 to send data to the external device.

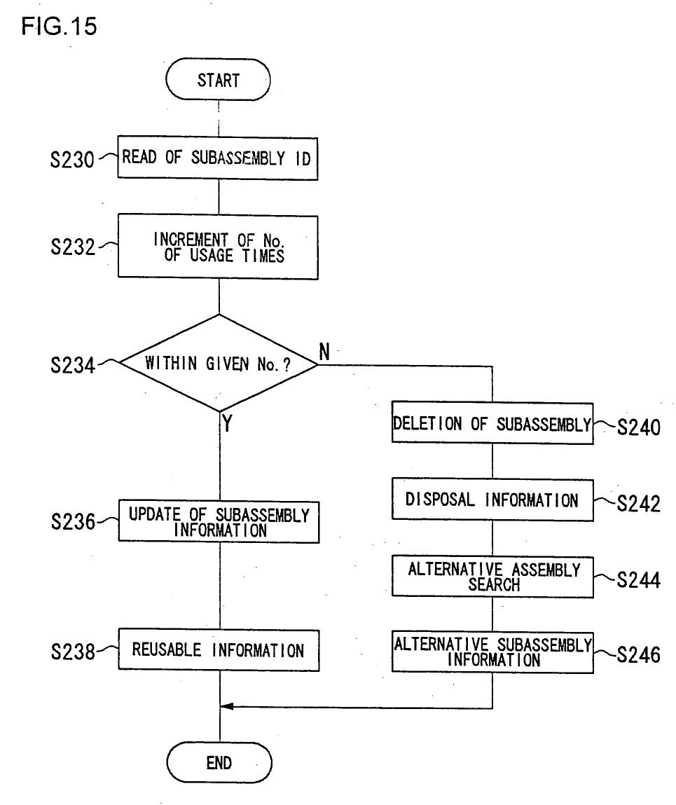

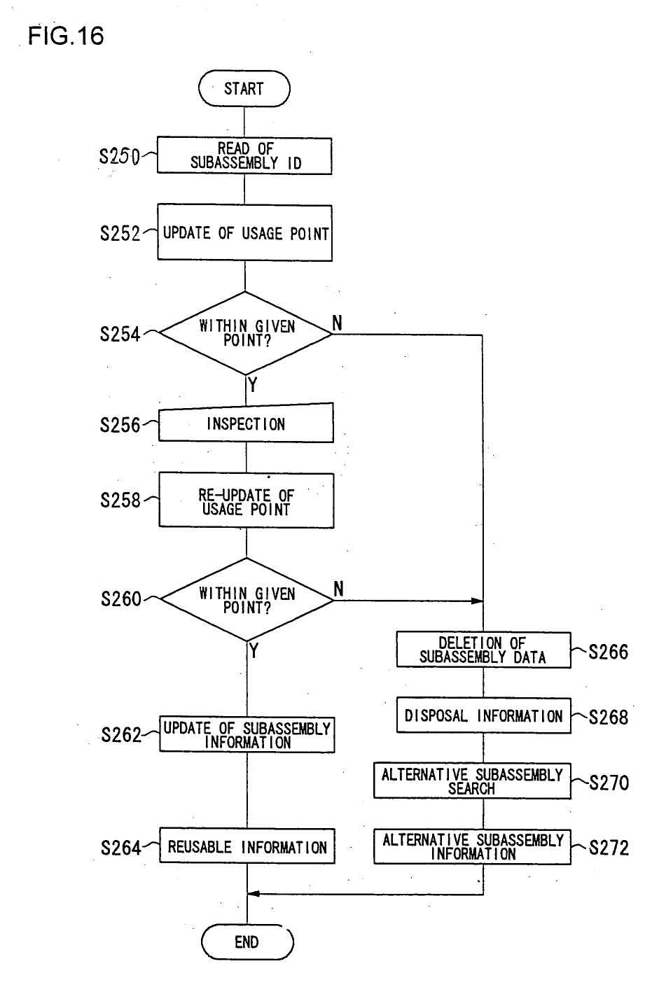

The data processing element 246 further contains the usage attribute value process element 248 and the subassembly register 250. The usage attribute value process element 248 is responsible for the process of the usage attribute values of subassemblies. The usage attribute value process element 248 updates the usage attribute values read by the subassembly interface process element 244. The subassembly interface process element 244 writes the usage attribute values in the subassembly information terminal 224. If the usage attribute value is the number of usage times of the subassembly, the usage attribute value process element 248 increments the usage attribute value as the number of usage times. The usage attribute value process element 248 determines whether the subassembly is to be reused or not based on the usage attribute value acquired by the subassembly interface process element 244. The process at the usage attribute value process element 248 is described in detail in connection with flowcharts shown in FIG. 15 and FIG. 16. When new subassemblies are acquired at the step S228 in FIG. 11, the subassembly register 250 registers information on the subassemblies in the subassembly data storage 252 in accordance with the instruction given by the user interface process element 242.

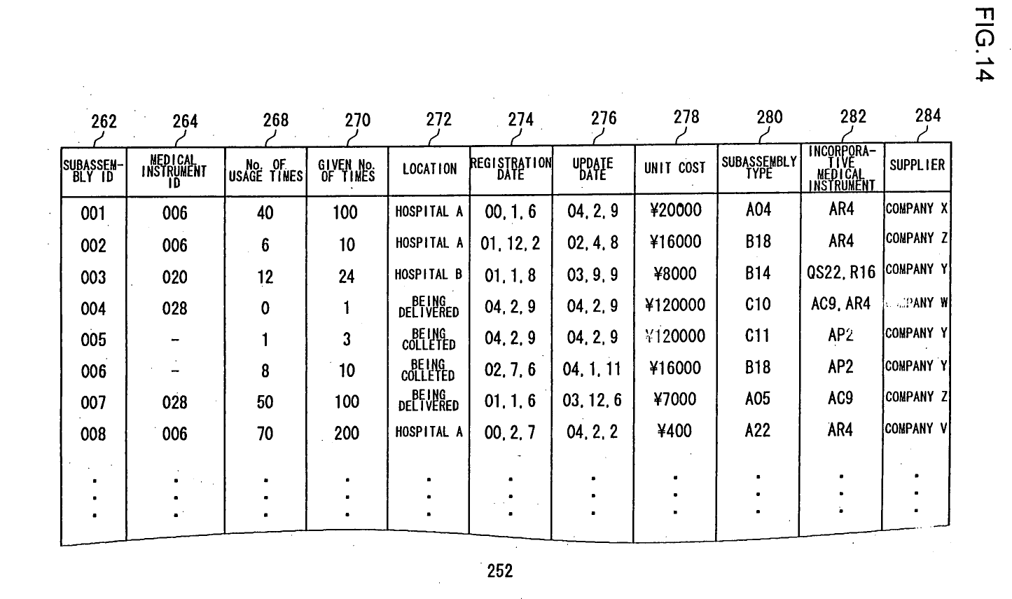

FIG. 14 is a view showing the data structure of the subassembly data storage 252. The subassembly ID column 262 contains the subassembly IDs. The medical instrument ID column 264 contains the medical instrument IDs identifying the medical instruments. Herein, the medical instrument IDs are not the types of the medical instrument but the IDs uniquely identifying the individual subassemblies. The medical instrument ID column 264 contains the correspondence between the subassemblies and the medical instrument in which the subassemblies have been incorporated. For example, the subassemblies with subassembly IDs “001”, “002”, and “003” assigned compose the medical instrument with the medical instrument ID “006” assigned. On the other hand, the subassemblies with IDs “005” and “006” assigned are not incorporated. Namely, they are separate subassemblies.

The number of usage times column 268 contains the current number of usage times of each subassembly. When the subassemblies are collected at the step S224 shown in FIG. 11, the subassembly interface process element 244 reads the number of usage times as the usage attribute value from the subassembly information terminal 224 assigned to the subassemblies. The usage attribute value process element 248 increments and writes the number of usage times in the number of usage times column 268. The subassembly interface process element 244 writes the incremented number of usage times in subassembly information terminal 224. For example, the subassembly with the subassembly ID “001” has been used forty times. On the other hand, the subassembly with the subassembly ID “004” has not been used and clearly it is a newly acquired subassembly.

A given number of times column 270 contains the number of usage times for each subassembly (hereinafter, simply referred to as “given number of times”). When the number of usage times of the subassembly exceeds the given number of times, the usage attribute value process 248 determines the subassembly to be not reusable. A subassembly location column 272 contains the location where the subassembly is located. For example, the subassembly with the subassembly ID “001” has been delivered to “Hospital A”. When the delivery has been completed at the step S212 shown in FIG. 11, the medical instrument supplier 200 updates the information in the subassembly location column 272. This allows for tracing the subassembly distribution through the subassembly information database 206.

A registration date column 274 contains the date (day and time) when the subassembly information is registered in the subassembly data storage 252. An update date column 276 contains the current update date (day and time) when the subassembly information is updated. A unit cost column 278 contains the unit cost of the subassembly. The unit cost column 278 may contain the unit price of the purchased subassembly or the unit fee of the lease subassembly, where the subassembly will be reused. A subassembly type column 280 contains the type of the subassembly. The subassemblies with the subassembly IDs “002” and “006” have the same type data “B12”, namely they are the same type of subassemblies.

An incorporable medical instrument column 282 contains the type of the subassembly which is incorporable. Some general-purpose subassemblies may be incorporated in a plurality of medical instruments. For example, the subassembly with the subassembly ID “003” is incorporable in two types of medical instruments, “QS22” and “R16”. Referring to the incorporable medical instrument column 282 at the step S210 shown in FIG. 11, it is effectively avoided that any wrong subassembly is incorporated in the assembled medical instrument. Furthermore, the subassembly data storage 252 may contain information on compatibility between the subassemblies. A supplier column 284 contains the supplier, from which the subassemblies are acquired at the step S118 shown in FIG. 11.

The number of usage times column 268 and the given number of usage times column 270 contain the number of usage time as the usage attribute value in this example. It may contain the usage point according to the exhaust factor as the usage attribute value. For example, based on the number of usage times of the subassembly, the usage point may be set. In this case, the subassembly data storage 252 contains information of time consumed in the surgical operation.

Based on the possible exhaust factor according to the type of the surgical operation, a database containing the usage point for each subassembly may be established in advance. The subassembly data storage 252 contains information on the surgical operation, where the subassemblies were used. In this case, the usage attribute value process element 248 identifies the usage point by referring to the database according to the surgical operation.

FIG. 15 is a flowchart showing a process for determining whether the reusable subassemblies are to be reused or not based on the number of usage times. This flowchart indicates the step S224 shown in FIG. 11 in detail. The subassembly interface process element 244 reads the subassembly IDs from the subassembly information terminal 224 assigned to the collected subassembly (S230). The usage attribute value process element 248 increments the number of usage times of the collected subassembly (S232). The subassembly interface process 244 writes the incremented number of usage times in the subassembly information terminal 224. The usage attribute value process element 248 accesses the subassembly data storage 252 and determines whether the incremented number of usage times falls within the given number of usage times or not (S234). If it falls within the given number of usage times (Y at S234), the usage attribute value process element 248 updates the number of usage times of the subassembly corresponding to the subassembly ID read out at the step S230 (S236). The user interface process 242 informs the user of the subassembly being reusable (S238) and the process ends. At the step S238, the subassembly interface process element 244 may write it in the subassembly information terminal 244 that the subassembly is reusable. The subassembly information terminal 224 visualizes information indicating the subassembly is reusable.

If it fails to fall within the given number of usage times (N at S234), the subassembly register 250 deletes the subassembly information on the subassembly corresponding to the subassembly ID read from the subassembly data storage 252 (S240). The user interface process element 242 informs the user of the subassembly being to be disposed (S242). At the step S242, the subassembly interface process element 244 may write it in the subassembly information terminal 224 that the subassembly is not reusable. The subassembly information terminal 224 visualizes information indicating that the subassembly is not reusable. The subassembly register 250 searches the subassembly to be replaced with the subassembly determined to be disposed in the data storage 252 (S244). The subassembly register 250 selectively searches the subassembly of the same type as that of the subassembly to be disposed and not incorporated in the specific medical instrument. The user interface process 242 informs the user of the searched alternative subassembly information (S246) and the process ends. If no alternative subassembly is found, the user interface process 242 may inform the user that a new assembly should be acquired.

FIG. 16 is a flowchart showing the process for determining whether the subassembly is reusable at each of usage points based on the exhaust factor of the subassembly. The flowchart shows the step S224 shown in FIG. 11 in detail. The subassembly interface process element 244 reads the subassembly ID from the subassembly information terminal assigned to the collected subassembly (S250). The usage attribute value process element 248 updates the usage point of the collected subassembly (S252). The subassembly interface process element 244 writes the updated usage point in the subassembly information terminal 224.

The subassembly interface process element 244 writes the updated usage point in the subassembly information terminal 224. The usage attribute value process element 248 accesses the subassembly data storage 252 and determines whether the updated usage point falls within the given usage point (hereinafter, simply referred to as a “given point”) (S254). The given point is the number of usage points defined as the limit of subassembly usage. If it falls within the given point (Y at S254), the user executes the inspection of the subassembly (S256). Herein, the examination is geometric inspection under the stereomicrocope or dimension inspection using an electric micrometer caliper as disclosed in the patent document 1.

Based on the result of the inspection, the user updates the usage point again through the user interface process element 242 (S258). Namely, if the exhaust factor of the subassembly is higher than expected, the usage point is added, while being lower than expected, it is subtracted. The subassembly interface process 244 writes the re-updated usage point in the subassembly information terminal 224. The usage attribute value process element 248 accesses the subassembly data storage-252 and determines whether the re-updated usage point falls within the given point or not (S260).

The usage attribute value process element 248 updates the usage point of the subassembly corresponding to the subassembly ID read out at the step S250 and stores it the subassembly data storage 252 (S262). The user interface process element 242 informs the user of the subassembly being reusable (S264) and the process ends. At the step S264, the subassembly interface process element 244 may write it in the subassembly information terminal 224 that the subassembly is reusable. The subassembly information terminal 224 visualizes information indicating that the subassembly is reusable.

At the step S254 or S260, if it is determined that the usage point of the subassembly fails to fall within the given point (N at S254, N at S260), the process branches to the step S266. The process from the step S266 to the step S272 corresponds to the process from S240 to the step S246 shown in FIG. 15.

According to the flowchart shown in FIG. 16, the need for the inspection at the step S256 is eliminated by means of the step S254 in collecting the subassembly. Only when the usage point is closer to the given point, the inspection may be executed at the step S256. By maintaining the subassembly, the usage point may be subtracted. In the case where it is determined whether the subassembly is to be reused or not based on the number of usage times, the number of inspection times may be decremented in the same manner even though the inspection at the step S256 is executed.

The characteristics described in the embodiment 3 may be specified by means of the following items.

(Item 18)

Medical instrument management equipment, comprising;
a subassembly information storage for storing the identification information on the purchased or lease subassemblies in connection with the usage attribute values indicating usage status of them,
a usage attribute value detector for detecting the usage attribute values of the subassemblies from the subassembly information storage based on the identification information, and
an indicator for displaying the result of the detection step on the screen.
   (Item 19)

Medical instrument management equipment, comprising;
a subassembly information storage for storing type information on the purchased or lease medical instruments to be assembled using the subassemblies and the identification information of them in connection with one another,
a medical instrument information acquisition element for detecting the type information on the medical instrument to be assembled using the subassemblies from the subassembly information storage based on the identification information, and
an indicator for displaying the result of the detection step on the screen.
   (Item 20)

Medical instrument management equipment, comprising;
an identification information acquisition element for acquiring the subassembly identification information assigned to the subassemblies of the medical instrument, which has been assembled from one or more subassemblies and may be disassembled,
a usage attribute value acquisition element for reading the usage attribute values out from the recording medium, which stores the usage attribute values indicating the usage of the subassemblies,
a usage limit value acquisition element for reading the usage limit values from the recording medium, which stores the usage limit values, the limit values for the usage attribute values,
a usage attribute storage for storing the subassembly identification information and the usage attribute values in connection with one another,
a usage limit value storage for storing the subassembly identification information and the usage limit values in connection with one another, and
a reusability determination element for determining whether the target subassembly is usable or not based on the subassembly identification information read out by comparing the usage attribute value and the usage limit value.
   (Item 21)

The medical instrument management equipment described in the item 20, further comprising;
an identification information storage for storing the subassembly identification information on the medical instrument, which has been assembled from one or more subassemblies and may be disassembled, in the recording medium fixedly attached to the subassembly, wherein the identification information acquisition element being characterized in that it acquires the subassembly identification information from the subassembly identification information storage.
   (Item 22)

The medical instrument management equipment described in the item 20 or 21, wherein the identification information acquisition element acquires the subassembly identification information on the medical instrument lease-contracted with the medical institute, which has been assembled from one or more subassemblies and may be disassembled,

further comprising;

subassembly information storage for storing the subassembly identification information and the medical instrument information containing the type and/or usage of the medical instrument in connection with one another.
   (Item 23)

The medical instrument management equipment described in the item 20 or 21, wherein the identification information acquisition element acquires the subassembly identification information of the medical instrument lease-contract with the medical institution, which has been assembled from one or more subassemblies and may be disassembled,

further comprising;

a subassembly identification information storage for storing the subassembly identification information and the medical instrument information containing the type and/or usage of the medical instrument in connection with one another.
   (Item 24)

A medical instrument management method, comprising;
a step for acquiring the subassembly identification information of the medical instrument, which has been assembled from one or more subassemblies and may be disassembled,
a step for reading the usage attribute value out from the recording medium, which stores the usage attribute value indicating usage status of the subassembly,
a step for reading the usage limit value out from the recording medium, which stores the usage limit value indicating the limit value for the usage attribute value,
a step for recording the subassembly identification information and the usage attribute value in the recording medium in connection with one another,
a step for recording the subassembly identification information and the usage limit value in the recording medium in connection with one another,
a step for comparing the usage attribute value and the usage limit value based on the subassembly identification information read out on the target subassembly,
a step for determining whether the subassembly is reusable or not based on the result of the comparison step, and
a step for displaying the result of the determination step on the image display device.

### Embodiment 4

The hospital, after using, washes the reusable instrument used in the surgical operation. If the reusable medical instrument is composed of a combination of a plurality of subassemblies, the medical instrument is disassembled into the subassemblies and then washed. Some of subassemblies are reusable as those for another medical instrument but the others are not. Some subassemblies, even though being reusable, have different given numbers of reusable times (hereinafter, simply referred to as “given number of times”). The medical instrument supplier collects the medical instrument disassembled into its subassemblies from the hospital. The medical instrument supplier needs to strictly manage so that all the subassemblies of the medical instrument delivered may be surely collected. To determine whether the collected subassemblies are further reusable or not, usage status and usage history of them must be fully recognized.

The embodiment 4 has been developed in this context and its object is to provide a technique for strictly managing the subassemblies, which are components for the medical instrument.

The medical institution, for example, a hospital may purchase the medical instrument or may rent it from the medical instrument supplier. The object of the embodiment 4 is to ensure that the medical instrument lease business to improve cost-effectiveness and ensure reliability in operating the medical instrument delivered to the user. Usually, the medical institution may reduce its economical burden by renting a lease medical instrument rather than by purchasing it. Some medical instruments contain the subassemblies, which are reusable several times. The effective reuse of these subassemblies may bring merits to patients, as well as contributing to a reduction in unnecessary waste because of it being in a recycle system. On the other hand, to ensure high reliability of the medical instrument, it is not preferable that the subassemblies are reused so many times. To establish the recycle system of the medical instrument, a technique for efficiently managing the medical instrument and its subassemblies, namely components is indispensable.

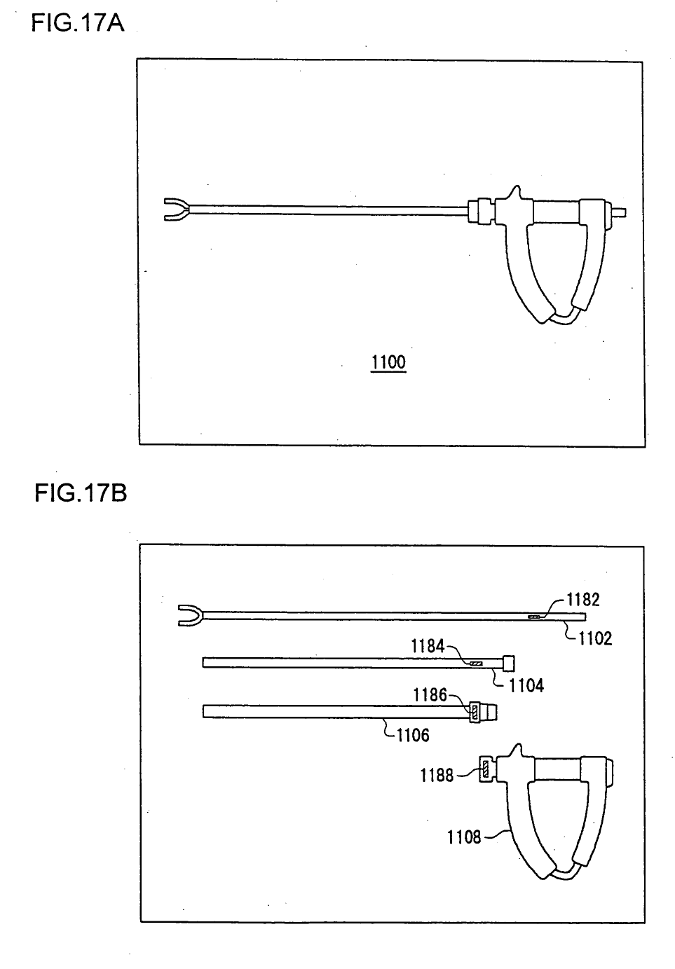

FIG. 17 is a view showing a bipolar tweezes and its subassemblies as an example of a reusable medical instrument. The bipolar tweezers is a medical instrument used in exsection or coagulating the affected site.

FIG. 17A is a view showing the appearance of the tweezers. FIG. 17B is a view showing the appearances of four subassemblies composing the tweezers.

The bipolar tweezers 1100 is a reusable medical instrument composed of a combination of four subassemblies, a tweezers unit 1102, an inner sheath 1104, an outer sheath 1106, and a handle 1108. In the figure, the tweezers unit 1102 has a jaw at its tip for holding the affected site. Alternatively, various forms of tweezers units may be used in the manner to meet the intended purpose of the bipolar tweezers 1102. The tweezers unit 1102 has the inner sheath 1104 and outer sheath 1106 covered to protect it. The handle 1108 is attached to the tweezers unit 1102 into the bipolar tweezers 1100. When the user operates the handle 1108, the jaw at the tweezers unit 1102 opens and closes.

The tweezers unit 1102, the inner sheath 1104, the outer sheath 1106, and the handle 1108 are all reusable subassemblies. The tweezers unit 1102 used as part of the bipolar tweezers 1100, after being disassembled from the bipolar tweezers 1100, may be further incorporated as a subassembly in another medical instrument. Although the tweezers unit 1102, which comes in contact with the affected site, is easy to wear, high reliability is needed. It is not preferable that it is reused so many times that exceed the given number of times, otherwise the reliability of the medical instrument may be deteriorated. On the other hand, the handle 1108, after being disassembled from the bipolar tweezers 1100, may be further incorporated in another medical instrument as a subassembly. Since the handle 1108 does not come in direct contact with the affected site, the given number of times may be set to any higher value allowing it to be used more times than the tweezers unit 1102.

To these subassemblies, IDs called subassembly IDs are assigned to uniquely identify them. In the embodiment 4, small geometric information indicating the subassembly IDs are attached to the subassemblies. Identifiers 1182, 1184, 1186, and 1188 are attached to the tweezers unit 1102, the inner sheath 1104, the outer sheath 1106, and handle 1108, respectively at the points as shown in the figure. The subassembly IDs are read by an identifier reader to obtain the subassembly IDs for the individual subassemblies. Next, giving as an example of the bipolar tweezers 1100, the recycle system for reusable medical instruments is generally descried.

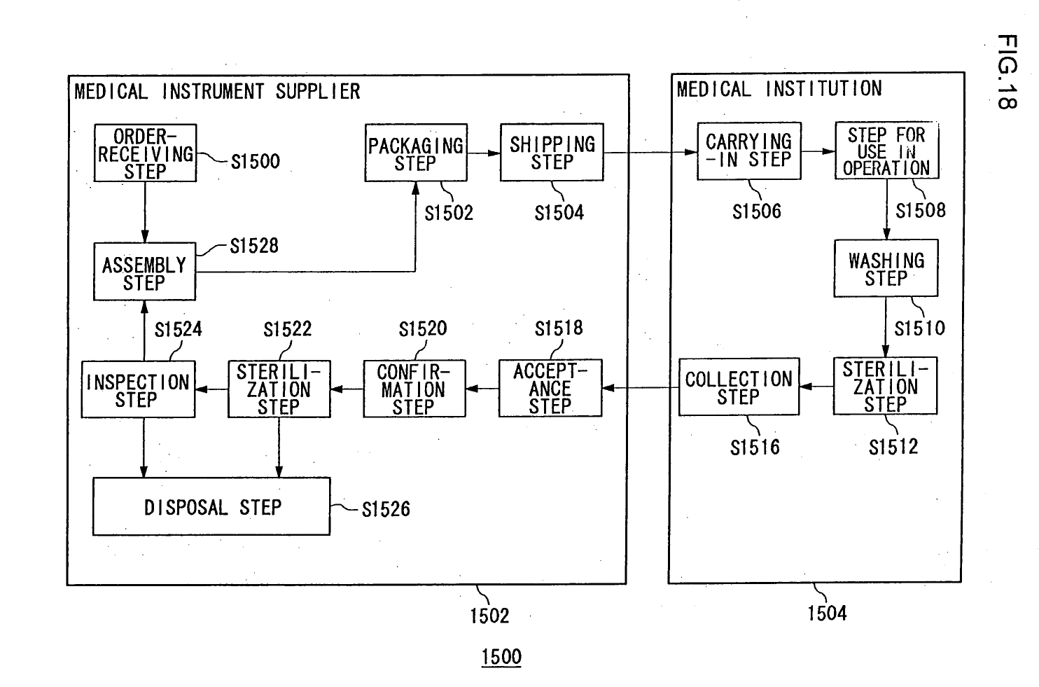

FIG. 18 is a schematic diagram explaining a recycle channel of the medical instruments.

The medical instrument recycle system 1500 contains a medical instrument supplier 1502 and a medical institution 1504. Herein, a channel is shown only for transporting the medical instruments between the medical instrument supplier 1502 and the medical institution 1504, however, actually a communications network for ordering and order-receiving the medical instruments between the medical instrument supplier 1502 and the medical institution 1504 exists as another channel. The communications network may be a leased line or may be any of those, which uses a communications line such as the Internet. In the figure, the medical instrument recycle system 1500 contains one medical instrument supplier 1502 and one medical institution 1504 only. Usually, a plurality of medical instrument suppliers 1502 and medical institutions 1504 compose the integrated medical instrument recycle system 1500.

The medical instrument supplier 1502 is a supplier who provides the medical instruments, for example, a medical instrument sales firm, a medical instrument lease firm, and medical instrument manufacturer. The medical institution 1504 is a user of the medical instruments, for example, a hospital.

The medical instruction supplier 1502 accepts the order of the medical instruments from the medical institution 1504 through a network (not indicated). The subassemblies composing the bipolar tweezers 1100, the tweezers unit 1102, the inner sheath 1104, the outer sheath 1106, and the handle 1108 are supplied by the medical instrument supplier 1502 or the external manufacturer (S1500). Some assemblies determined to be reusable at the inspection step (S1524) described later out of the collected subassemblies from the medical institution 1504 are also reused in another medical instrument.

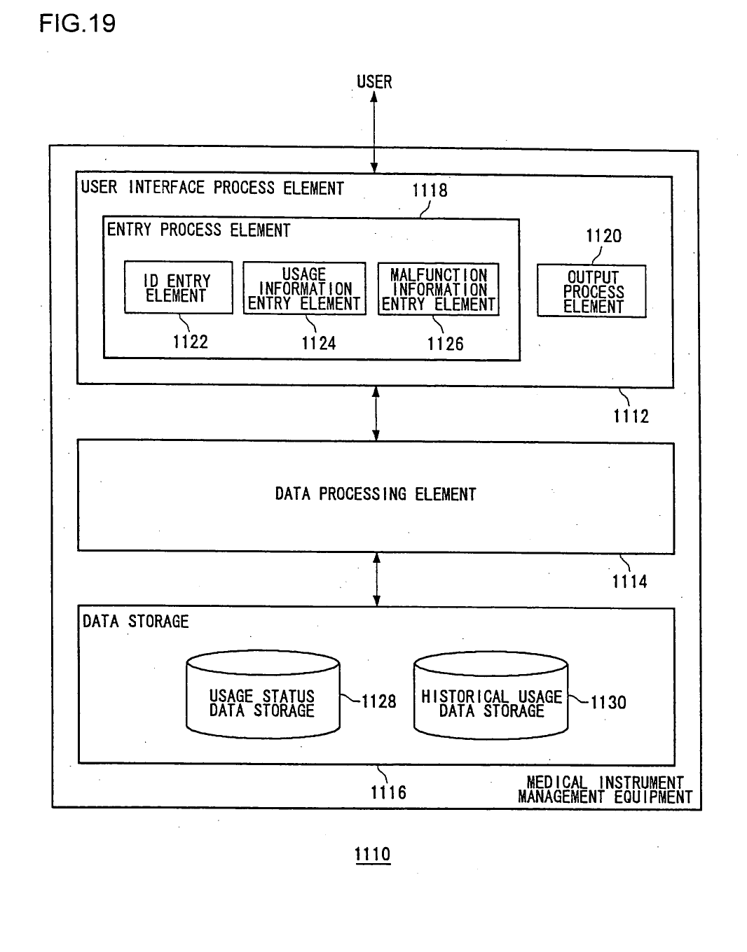

The acquired subassemblies this way are assembled into the ordered bipolar tweezers 1100 (S1528). Once the bipolar tweezers 1100 has been assembled, the medical instrument ID is assigned to the tweezers 1100 to uniquely identify it. The medical instrument supplier 1502 packages the assembled bipolar tweezers (S1502). At that time, the medical instrument ID is assigned to a container containing the bipolar tweezers 1100 as an identifier. The user reads the identifier using the identifier reader to obtain the medical instrument ID of the bipolar tweezers 1100. The user enters various types of information on the bipolar tweezers 1100 in the medical instrument management equipment 1110 by making the reader read the medical instrument ID. The medial instrument supplier 1502 ships the packaged bipolar tweezers to the medical institution 1504 (S1504). At that time, information indicating that sipping of the bipolar tweezers has been completed is entered in the medical instruction management equipment 1110 with the medical instrument ID. Described in detail referring to FIG. 19, the medical instrument management equipment 1110 is equipment for managing the medical instruments and their subassemblies.

The bipolar tweezers 1100 shipped from the medical instrument supplier 1502 is delivered to the medical institution 1504 (S1506). The medical institution 1504 uses the delivered bipolar tweezers 1100 in conducting the surgical operation (S1508). During the surgical operation, the tweezers unit 1102, the inner sheath 1104, the outer sheath 1106, and the handle 1108 composing the bipolar tweezers 1100 are contaminated. The bipolar medical instrument, after being used, is disassembled into these subassemblies. Out of the subassemblies, non-reusable ones may be disposed at the medical institution 1504 or the medical instrument supplier 1502 may collect all the subassemblies including non-usable subassemblies.

The subassemblies contaminated at the step S1508 are washed (S1510) and sterilized (S1512). These washed and sterilized subassemblies are collected (S1516) and accepted by the medical instrument supplier 1502 (S1518).

The medical instrument supplier 1502 confirms that the collected subassemblies have been incorporated in the bipolar tweezers 1100 shipped by the medical instrument supplier 1502 (S1520). At this confirmation step, the user makes the reader read the subassembly IDs from the identifiers attached to the colleted subassemblies. It confirms that the tweezers 1102, the inner sheath 1104, the outer sheath 1106, and the handle 1108 of the shipped bipolar tweezers 1100 have been all collected. A flag “collected” is set for the collected subassembly IDs. At that time, the subassembly IDs attached at the assembling step (S1528) may be overridden. Namely, the medical instrument IDs are valid until the subassemblies are assembled into the medical instrument at the assembling step (S1528) and it is confirmed that the subassemblies composing the medical instrument have been collected at the confirmation step (S1520).

The medical instrument supplier 1502 re-sterilizes the collected subassemblies (S1522). Non-reusable ones out of the sterilizes subassemblies (S1526) are disposed, while reusable ones are checked to see if they are to be reused or not based on usage status of the subassemblies (S1524). The subassemblies determined to be disposed at the inspection step are disposed (S1526). Usually, the medical waste disposer or the industrial waster disposer collects these medical instruments. The subassemblies determined to be reusable are reused in another medical instrument.

FIG. 19 is a functional block diagram showing the medical instrument management system 1110.

The medical instrument management equipment 1110 centrally manages information on the medical instruments and the subassemblies composing them in the medical instrument recycle system 1500.

Each block shown herein may be implemented by hardware by means of the elements and mechanical devices including the CPU and by software by means of a computer program and the like. For that reason, the person skilled in the art may fully recognize that these functional blocks may be implemented in various forms by combining hardware and software. The medical instrument management equipment 1110 is the equipment configured as a server/client system, for example, some of the functionality of the user interface of the medical instrument management equipment 1110 may be implemented by means of client terminals installed for the individual steps.

The medical instrument management equipment 1110 contains the user interface process element 1112, the data processing element 1114, and data storage 1116.

The medical instrument management equipment 1110 is responsible for the user interface process. The user interface process element 1112 displays various kinds of information on the user's screen in response to the user's entry. At that time, the user interface screen will appear at the client terminal used by the user, allowing he/she to enter information. The data processing element 1114 processes various kinds of data in the data storage 116 according to the user's entry accepted by the user interface process element 1112. The data storage 1116 stores various kinds of data required for managing the medical instruments and their subassemblies.

The user interface process element 1112 contains the input processing element 1118 and the output processing element 1120.

The input processing element 1118 accepts the entry from the user. The output processing element 1120 displays various kinds of information on the user screen.

The input processing element 1118 contains the ID input element 1122, the usage information input element 1124, and the malfunction information input element 1126.

The ID input element 1122 accepts the medical instrument ID and the subassembly ID sent by the user. These IDs read by the identifier reader are accepted by the ID input element 1122. The data processing element 1114 record these IDs in the data storage 1116. The usage information input element 1124 accepts usage information sent by the user. The malfunction information input element 1126 accepts malfunction information entered by the user. The information also is recorded in the data storage 1116 by the data processing element 1114.

The data storage 116 contains the usage data storage 1128 and the historical usage data storage 1130.

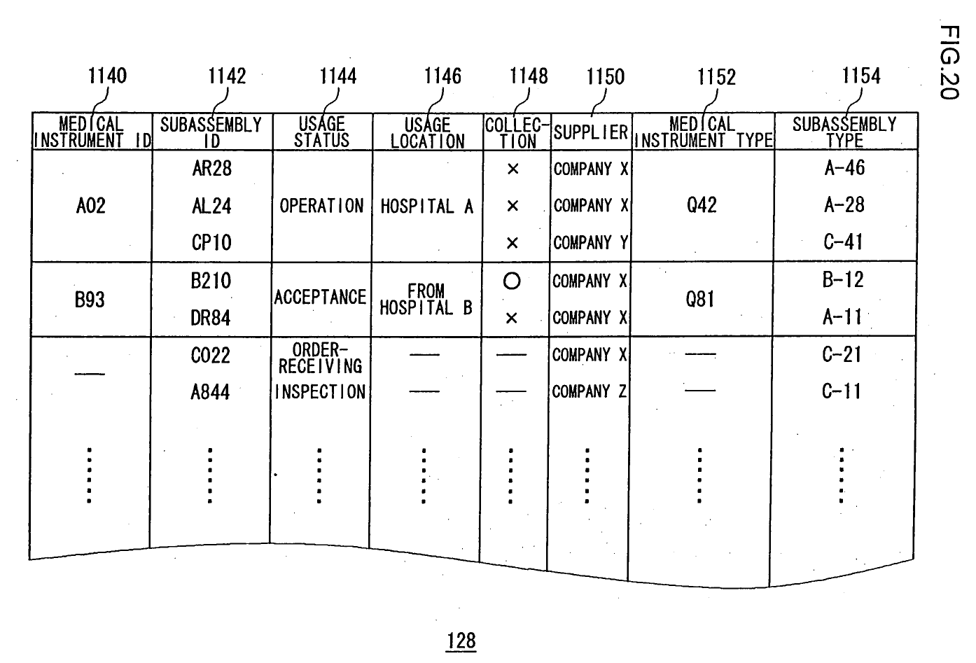

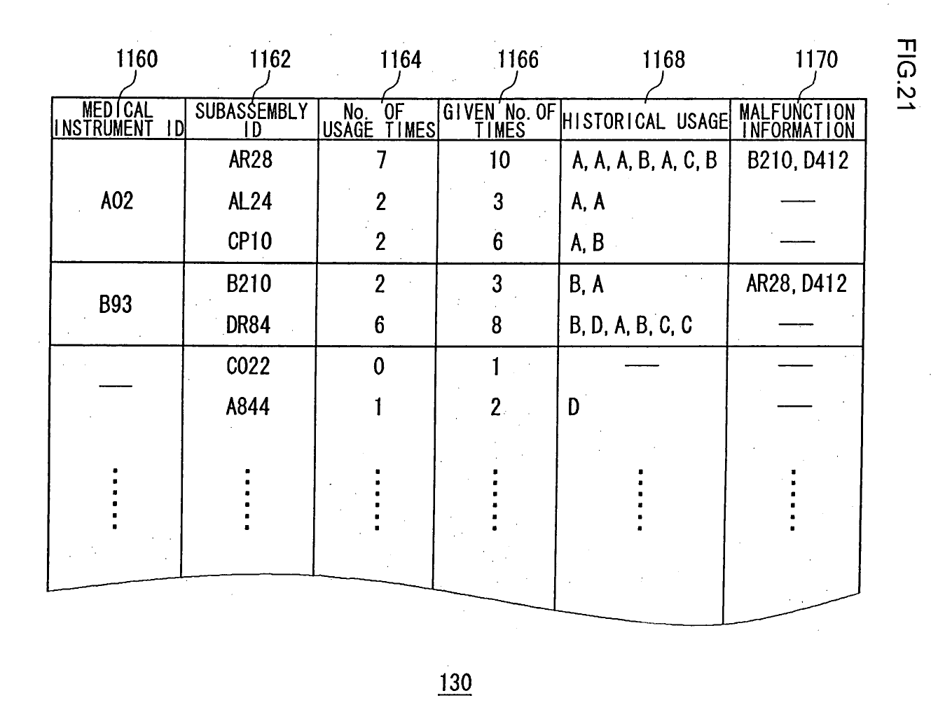

The usage data storage 1128 stores data required mainly for managing current usage status of the medical instruments and their subassemblies. The data structures of the usage data storage 1128 and the historical usage data storage 1130 are described in detail referring to FIGS. 20 and 21 shown below.

FIG. 20 is a view showing the data structure of the usage data storage 1128.

The medical instrument ID column 1140 contains the medical instrument IDs. The subassembly ID column 1142 contains the subassembly IDs. In the figure, the medical instrument with the medical instrument ID “A02” is composed of three subassemblies with the subassembly IDs “AR28”, “AL24”, and “CP10”. The subassemblies with the subassembly IDs “C022” and “A844” have not been incorporated in any medical instrument. The user enters the medical instrument ID of the medical instrument assembled at the assembling step (S1528) instruments. These IDs acquired by the ID input element 1122 are recorded in the medical instrument ID column 1140 and the subassembly ID column 1142 of the usage data storage 1128 in connection with each other by the data processing element 1114. By referring to the medical instrument ID column 1140 and the subassembly ID column 1142, it may be recognized in the whole medical instrument recycle system 1500; what subassemblies have been incorporated in what medical instrument and what subassemblies have not been incorporated in what medical instrument.

The usage status column 1144 contains the usage status of the medical instruments and subassemblies. The usage location column 1146 contains the current usage locations of the medical instruments and the subassemblies. In the figure, the medical instrument with the medical instrument ID “A02” is at the “used in operation” step (S1508). Namely, three subassemblies with subassembly IDs “AR28”, “AL24”, and “CP10”, respectively, composing the medical instrument are also at the “used in operation” step. The medical instrument is being used in the surgical operation conducted at “hospital A”, the medical institution 1504.

The user who operates the medical instruments at the steps shown in FIG. 18 enters the medical instrument ID and the subassembly ID, as well as the usage information on the medical instrument and the subassembly. At the ID input element 1122, the medical instrument ID and the subassembly ID are read to identify the medical instrument and the subassembly. The usage information acquired at the usage information input element 1124 is recorded in the usage status column 1144 and the usage location column 1146 of the usage status data storage 1128 at the data processing element 1114. In addition to the information contained in the usage status column 1144 and the usage location column 1146, various kinds of information may be further recorded as the usage information. For example, for the medical instrument with the medical instrument ID “A02”, such information may be recorded as the operation date, the surgeon, and the operation type.

The collection determination column 1148 contains the information whether the subassemblies contained in the medical instrument delivered to the medical institution 1504 have been collected by the medical instrument supplier 1502. At the confirmation step (S1502), the user, who is responsible for the step, enters the subassembly IDs of the collected subassemblies. The data processing element 1114 records the collected subassemblies out of the subassemblies composing the medical instrument delivered to the medical institution 1504 in the collection determination column 1148 of the usage status data storage 1128. By referring to data in the collection determination column 1148, uncollected subassemblies, if any, out of the subassemblies composing the medical instrument delivered to the medical institution 1504 may be easily detected. The supplier column 1150 contains the suppliers of the subassemblies. Usually, the supplier, herein, is the name of a manufacture of the subassembly and the supplier information is entered at the order step (S1500). The medical instrument type column 1152 contains the type of the medical instrument. The medical instruments are classified according to their intended purposes. The subassembly type column 1154 contains the type classified according to its intended purpose.

FIG. 21 is a view showing the data structure of the historical usage data storage 1130.

The medical instrument ID column 1160 contains the medical instrument ID. The subassembly ID column contains the subassembly ID. The medical instrument ID column 1160 and the subassembly ID column 1162 correspond to the medical instrument ID column 1140 and the subassembly ID column 1142 of the usage status data storage 1128, respectively. The number of usage times column 1164 contains the current number of usage times of each subassembly. The number of usage times, herein, is the number of times, which will be added at the inspection step (S1524) after the subassembly has been incorporate in the medical instrument. For example, the subassembly with the subassembly ID “AR28” contained in the medical instrument with the medical instrument ID “A02” is the subassembly already used seven times. On the contrary, the subassembly with the subassembly ID “AL24” contained in the same medical instrument has been used two times only. Moreover, the number of usage times of the subassembly with the subassembly ID “C022” is 0. As shown in the usage status column 1144 of FIG. 20, the subassembly is unused because it being at the order step (S1500).

The given number of times column 1166 contains the given number of times for each subassembly. As shown in the figure, the subassembly with the subassembly ID “AR28” has the given number of times of 10 assigned. The information in the number of usage times column 1164 indicates that it has been used seven times and may be further used three times. On the contrary, the subassembly with the subassembly ID “C022” has the given number of times of 1 assigned. Namely, the subassembly is a non-reusable type of subassembly and may not be reused.

The historical usage column 1168 contains the historical usage for each subassembly. In the figure, the subassembly with the subassembly ID “AR28” has been already used seven times at Hospital B, Hospital C, Hospital A . . . , Hospital A in that order starting at the rightmost one. When the user enters the usage information at each of steps shown in FIG. 18, the data processing element 1114 updates the historical usage contained in the historical usage column 1168 for each of subassemblies contained in the medical instrument. In addition to the information shown in the figure, various kinds of information may be written in the historical usage column, for example, the number of washing times, operator name, and usage date (day and time).

The malfunction information column 1170 contains the malfunction information for each subassembly. At each of steps shown in FIG. 18, the user enters malfunction or anomaly in the medical instrument, when detected, in the medical instrument management equipment 1110. The data processing element 1114 records the malfunction information for each of subassemblies contained in the medical instrument in the malfunction information column 1170. In the figure, it is indicated that a malfunction occurred in the subassembly with the subassembly ID “AR28” when it was incorporated in the medical instrument together with the subassemblies with the subassembly IDs “B210” and “D412”. The user may enter the malfunction itself as well as a concrete description of it as the malfunction information. In addition to the information contained in the malfunction information column 1170 in the figure, detail information on the malfunction may be recorded in the historical usage data storage 1130.

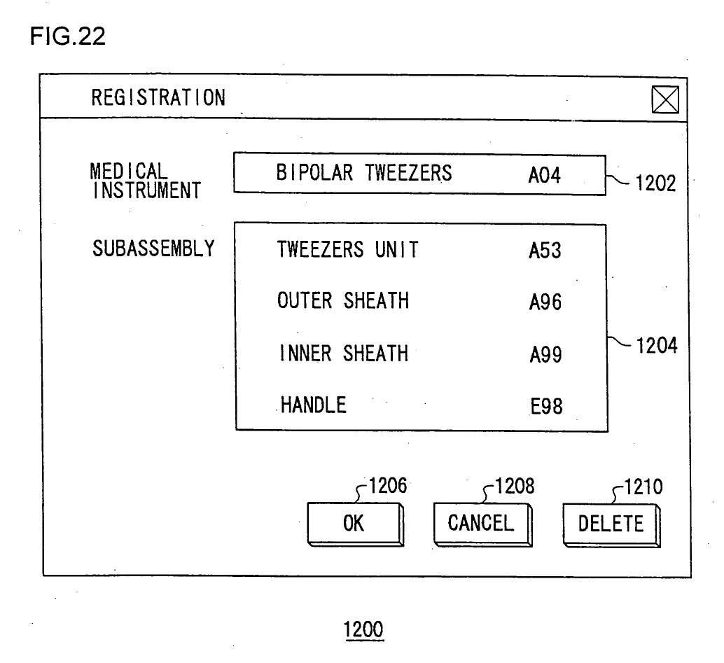

FIG. 22 is a view showing the ID registration screen for registering the medical instrument ID and the subassembly ID.

The user registers the medical instrument ID of the medical instrument and the subassembly IDs of the subassemblies contained in the medical instrument in the medical instrument management equipment 1110 at the assembly step (S1528). In the embodiment 4, when the user requests the medical instrument ID to the medical instrument management equipment 1110 at the assemble step, the data processing element 1114 selects an appropriate ID from unreserved IDs. The identifier corresponding to the medical instrument ID created this way is printed by an external device in the form of a sticker. The user attaches the sticker indicating the identifier on the packaging container for the medical instrument. When the user makes the identifier reader read the identifier, the output processing element 1120 displays the read medical instrument ID on the medical instrument indicator 1202. The information identifying the type of the medical instrument is associated with the identifier and the name of the medical instrument is also displayed on the medical instrument indicator 1202. As known from the figure, the name of the medical instrument is a “bipolar tweezers” and its medical instrument ID is “A04”.

The user makes the identifier reader read the subassembly ID from each of subassemblies contained in the medical instrument in the given order. The output processing element 1120 displays the read subassembly IDs in the subassembly indicator 1204. In the figure, four subassemblies a “tweezers unit”, “outer sheath”, “inner sheath”, and “handle” have been read out as the subassemblies composing the medical instrument. When the user clicks the OK button, the data processing element 1114 records the medical instrument ID and the subassembly IDs in the usage status data storage 1128 and the historical usage data storage 1130 in connection with one another. When the CANCEL button 1208 is clicked, the ID registration screen 1200 closes with no ID recorded. When the DELETE button is clicked with any of the medical instruments and the subassemblies selected in the medical instrument indicator 1202 or the subassembly indicator 1204, the appropriate medical instrument or subassembly is deleted from the medical instrument indicator 1202 or the subassembly indicator 1204.

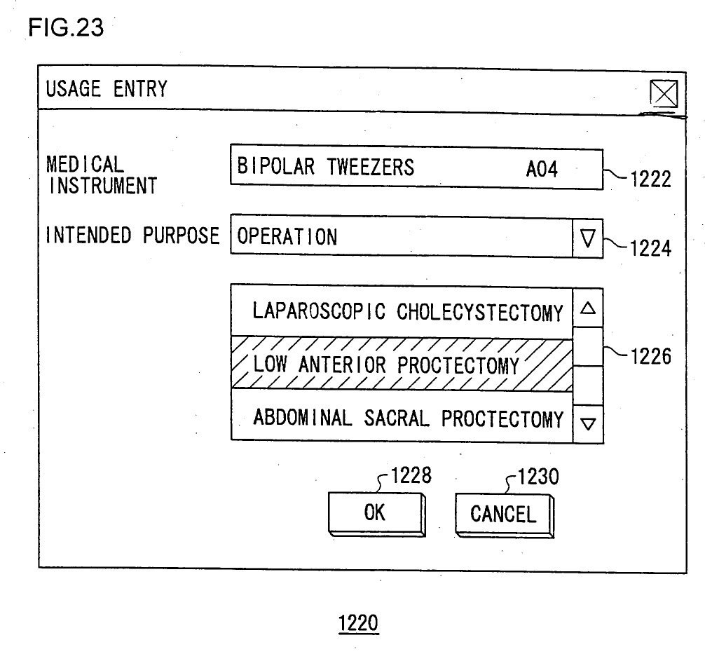

FIG. 23 is a view showing the usage information entry screen for registering the usage information of the medical instrument.

At the step shown in FIG. 18, the user enters the usage information on the medical instrument in the medical instrument management equipment 1110. In the figure, the entry screen is shown at the “used in operation” step (S1508). When the user makes the identifier reader read the medical instrument ID, the output processing element 1120 displays the read medical instrument ID in the medical instrument indicator 1222. The user selects the intended purpose of the medical instrument from the selections in a pull down menu in the intended purpose indicator 1224. In the figure, “operation” has been selected, indicating that it was entered at the operation step (S1508).

When the user selects the operation in the intended purpose 1224, the operation information indicator 1226 brings up with a list of operations. The user selects the appropriate operation from the operation information indicator 1226. In the figure, “low anterior rectum resection” has been selected. When the OK button 1228 is clicked, the data processing element 1114 records the usage information in the usage status data storage 1128 including the entered medical instrument ID and the intended purpose selected in the intended purpose indicator 1224 in the usage status data storage 1128. In sync with this operation, the historical usage of the subassembly contained in the medical instrument shown in the medical instrument indicator 1222 is also updated. When the CANCEL button 1230 is clicked, the usage information entry screen closes with no data recorded. By means of the data entry screens with uniform entry formats, the medical instrument equipment 1110 correctly manages the usage status of the medical instruments and subassemblies. As at the order step (S1500) or inspection step (S1524), if the subassembly is not contained in any medical instrument, the user enters usage information for each of subassemblies.

If any other malfunction or anomaly is detected, its information may be entered in the medical instrument management equipment 1110 as the malfunction information in the free text format. The data processing element 1114 records the read medical instrument ID and the entered malfunction information in the historical usage data storage 1130. The malfunction information is managed for each of subassemblies. At the inspection step (S1524), when the subassembly ID of the medical instrument to be inspected is entered to request the multifunction information, the data processing element 1114 retrieves the historical usage data storage 1130 based on the subassembly ID to check any malfunction occurring in the medical instrument, in which the subassembly has been incorporated. The user determines whether the subassembly may be reused or not based on the malfunction information. Namely, even for the subassembly with the number of usage times being within the given number of times, which is reusable usually, the reusability may be determined based on the previous malfunction information. The subassemblies are preferably reused at a higher reliability.

It may be considered that the malfunction occurred in the medical instrument due to a wrong combination of subassemblies. At the assembly step (S1528), when the user enters the subassembly IDs of a plurality of subassemblies to be assembled, the data processing element 1114 can check for any malfunction occurring in connection with the combination of these assemblies. In this case, the user can assemble the subassemblies into the medical instrument so that no combination of subassemblies, which caused the malfunction, may be reused. Accordingly, the subassemblies may be preferably assembled at a higher reliability.

As at the order step (S1500) or the inspection step (S1524), when the subassembly is not contained in any medical instrument, if the user detects an anomaly in the subassembly, he/she may make the identifier reader read the subassembly ID and enters the malfunction information for each of subassemblies.

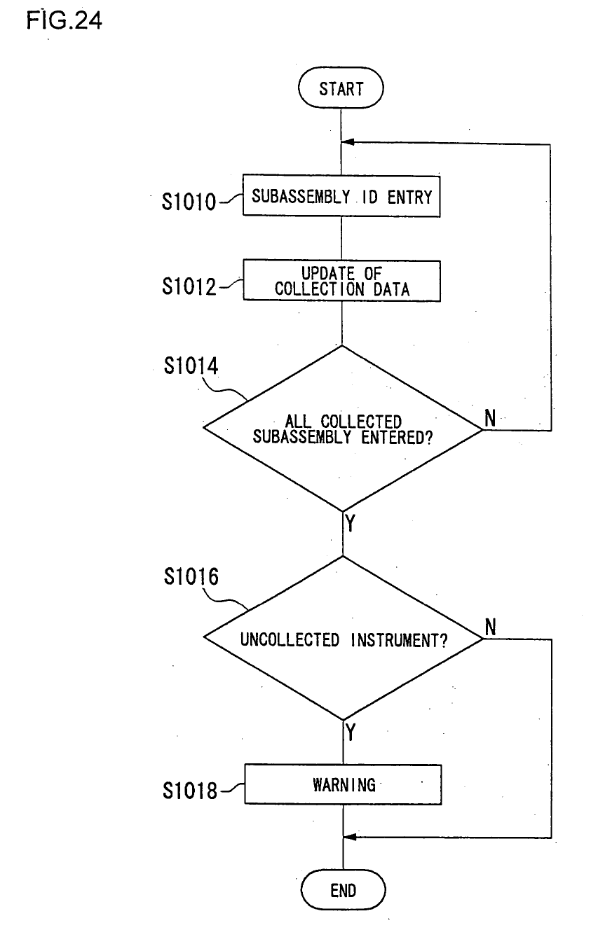

FIG. 24 is a flowchart showing the confirmation step (S1520) in FIG. 18 in detail. At the confirmation step S1520), the user makes the identifier reader read the subassembly IDs of the collected subassemblies (S1010). When the ID input processing element 1122 acquires the subassembly IDs, the data processing element 1114 updates the collection determination column 1148 of the usage status data storage 1128 (S1012). If the subassembly IDs for all the collected subassemblies have not been read (N at S1014), the process returns to S1010. If all the subassembly IDs have been read (Y at S1014), the data processing element 1114 check for any uncollected subassemblies out of the subassemblies contained in the medical instrument delivered at the shipping step (S1504) to the medical institution 1504. If only some of subassemblies have been collected for any medical instrument (Y at S1016), the output processing element 1120 issues the warning indicating it on the screen (S1018). If no uncollected subassembly is detected (N at S1016), the step S1018 is skipped and the confirmation step ends (S1520).

According to the embodiment 4 described above, the medical instruments and plural kinds of their subassemblies are managed by means of ID. The medical instrument management equipment 1110 may centrally manage: what subassemblies have been incorporated in what medical instrument and what subassemblies have not been incorporated in what medical instrument. Moreover, at the step shown in FIG. 18, the usage information on the medical instrument and their subassemblies are collected in the medical instrument management equipment 1110. For this reason, the usage status of the medical instruments and their subassemblies may be managed in the medical instrument management equipment 1110. The medical instrument management equipment 1110 also manages the historical usage and malfunction information for each of subassemblies. For this reason, preferably, the subassemblies with a malfunction may be reused and any combination of subassemblies with possible malfunction may be effectively avoided.

According to the medical instrument management equipment 1110, since the medical cost may be saved while the reliability of the medical instrument is ensured, the medical instrument leas system is effectively streamlined and excessive medical waste may be reduced.

The functionality of medical instrument ID entry element and the subassembly ID entry element described in claims is fulfilled mainly by the ID entry element 1122 in the embodiment 4.

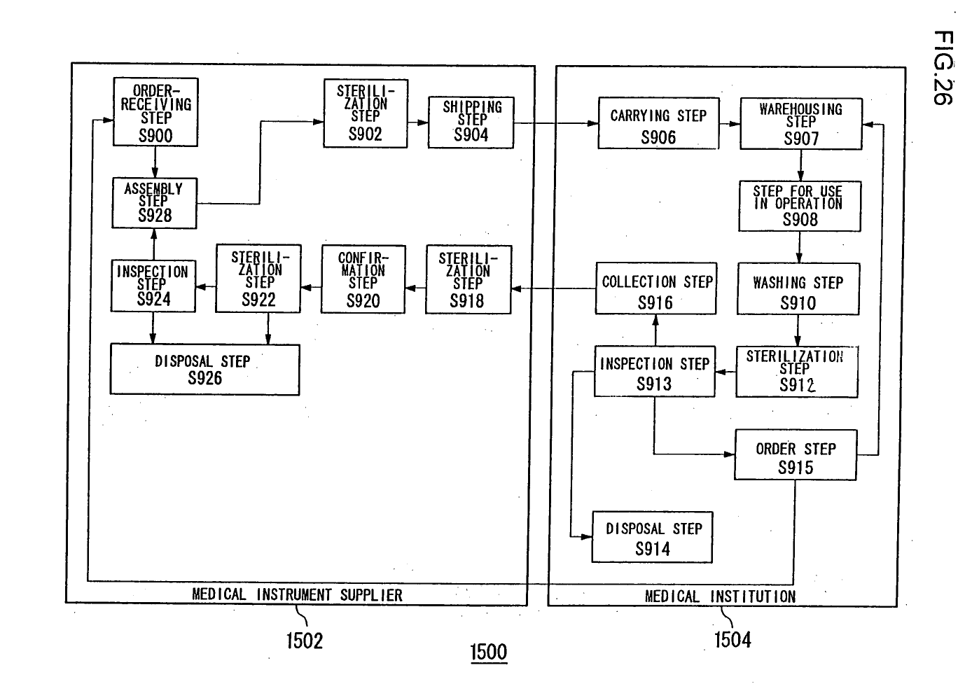

FIG. 26 is a view explaining a first variant of the medical instrument recycle system.

In this example, the medical instrument recycle system 1500 contains the medical instrument supplier 1502 and the medical institution 1504.

The medical instrument supplier 1502 accepts the order of a medical instruments from the medical institution 1504 through a network (not indicated). The subassemblies composing the medical instrument are supplied by the medical instrument supplier 1502 or the external manufacturer (S900). Alternatively, the subassemblies determined to be reusable at the inspection step (S924) out of the subassemblies collected from the medical institution 1504 may be available.

By assembling the subassemblies acquired this way, the ordered medical instrument is obtained (S928). The medical instrument, after being sterilized (S902), is shipped to the medical institution (S904) in association between the medical instrument and their subassemblies.

The medical instrument shipped from the medical instrument supplier 1502 is delivered to the medical institution 1504 (S906) and carried in the warehouse of the medical institution 1504 (S907). When the medical instrument carried in the warehouse is used in the surgical operation, the number of usage times for each of the subassemblies of the medical instrument is incremented (S908). After being used, the subassemblies of the medical instrument are washed independently (S910) and sterilized (S912). After being sterilized, the subassemblies are visually checked for any anomaly (S913). The subassemblies determined to be not reusable are disposed (S914). On the other hand, the subassemblies determined to be reusable at the step S013 are collected (S916) are delivered to the medical instrument supplier and sterilized (S918). The collected subassemblies are checked to see if they are those, which have been contained in any medical instrument supplied by the medical instrument supplier (S920). If so, they are further sterilized (S922). The non-reusable ones out of the sterilized subassemblies are disposed (S926) and for the reusable ones, it is determined whether they may be reused based on their usage status (S924). The subassemblies determined to be disposed at the inspection step are disposed (S926).

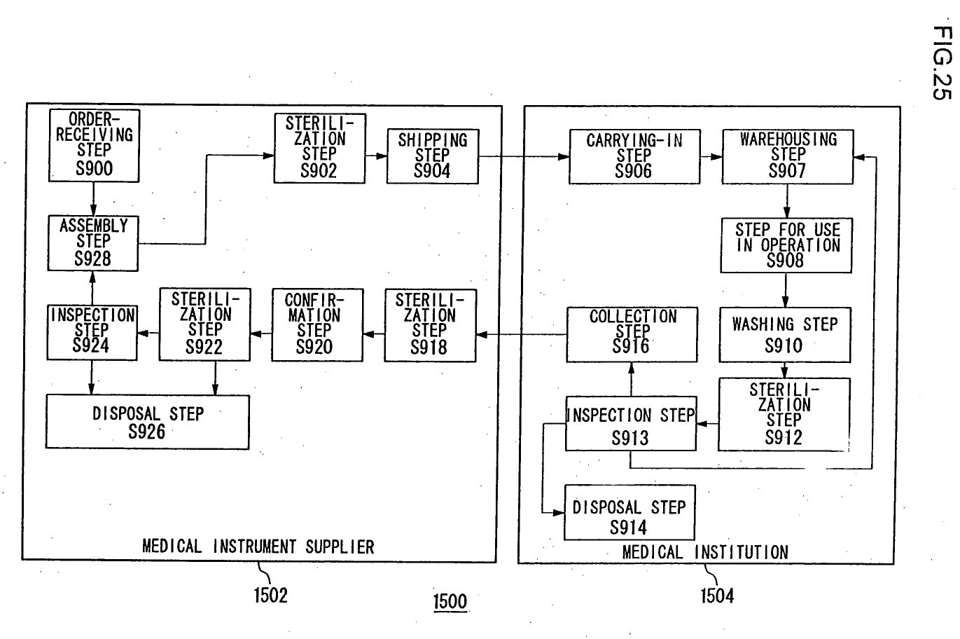

FIG. 26 is a view explaining the process to be followed when the subassemblies to be replaced are detected at the inspection step S913 in FIG. 25.

At the step S913, the subassemblies determined to be not reused may be disposed (S914) but they may be ordered to the medical instrument supplier 1502 by replacing them with new ones. When the medical instrument ID of the medical instrument containing the subassemblies to be replaced is entered in the medical instrument management equipment 1110, a list of subassemblies IDs of the subassemblies composing the medical instrument are displayed on the user screen. The user selects the subassembly IDs of the subassemblies to be replaced from the list. After selection, the order screen (not indicated) appears in the medical instrument management equipment (S915). At that time, the order information entered from the order screen is sent to the medical instrument supplier 1502. The subassemblies to be replaced are carried in the warehouse again as sock (S907). Based on the order information displayed at the step S915, the medical instrument supplier 1502 receives the order of the same type of subassemblies (S900). The order-received subassemblies are replaced with those carried back in the warehouse.

A combination of reusable and non-reusable subassemblies may be mixed in the medical instrument. For example, if the subassembly with the given number of times is 5 and the disposable subassemblies, which are non-reusable, are contained in the medical instrument, the disposable subassemblies may be supplied as a kit of five subassemblies. Thus, by making a plurality of subassemblies into a kit based on the number of usage times, the burden may be reduced on the medical instrument recycle system 1500 at the step of order processing.

The medical instrument identifier may be organized by combining the subassembly IDs. The medical instrument ID also may be organized by combining the subassembly IDs of the subassemblies contained in the medical instrument. For example, the medical instrument ID of the medical instrument composed of three subassemblies with IDs “AR18”, “AL24”, and “CP10” may be “AR28-AL24-CP10”.

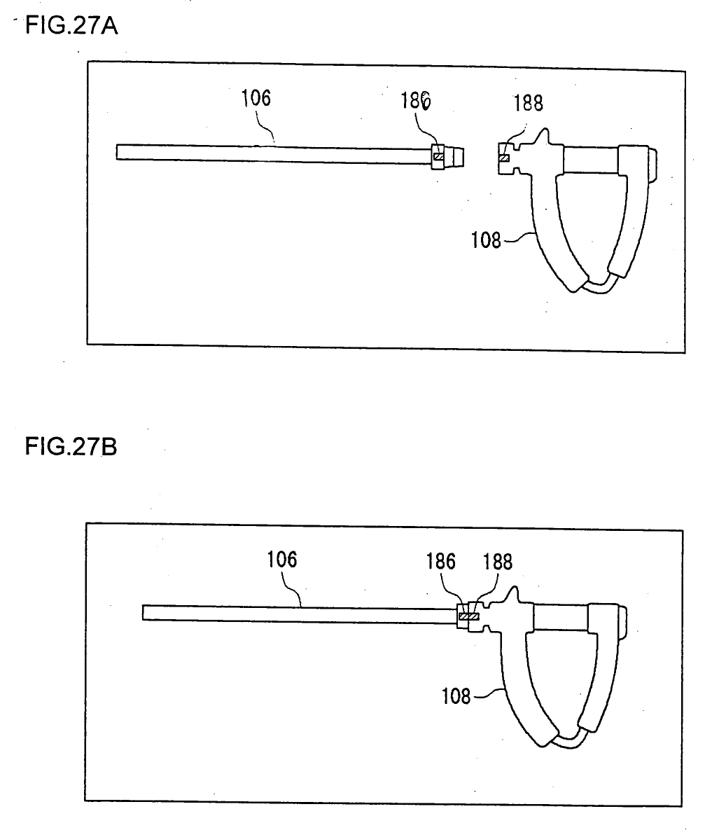

FIG. 27 is a schematic diagram showing an aspect, wherein a combination of a plurality of subassembly IDs of the subassemblies organizes a medical instrument ID. FIG. 27A is a view showing the appearance of the disassembled bipolar tweezers. FIG. 27B is a view showing the appearance of the assembled bipolar tweezers.

When the identifier 1186 of the outer sheath 1106 is “AR28” and the identifier 1188 of the handle 108 is “AL24”, a new identifier is organized by combining these IDs when these subassemblies are assembled. The new identifier ID is “AR28AL24”. Thus, by attaching the identifiers to the subassemblies composing the medical instrument at possible locations, a new identifier indicating the medical instrument ID may be easily organized.

The given number of times for the subassembly may be modified according to the usage status. For example, for the subassemblies determined to be not reusable before they reach the given number of times assigned to them, the given number of times may be controlled to be decremented. Thus, by modifying the given number of times based on the usage status, the medical instruments may be flexibly managed according to the context of the medical field.

The characteristics of the present invention described in the embodiment 4 may be specified by the following items.

(Item 25)

A medical instrument, wherein each of the medical instruments are assembled from plural kinds of subassemblies corresponding to the given medical functions and after being assembled and performs the function supporting the medical practice in cooperation among these subassemblies, said subassemblies have subassembly IDs assigned for controlling in the external database.

(Item 26)

The medical instrument described in the item 25, wherein to make a given reader read the subassembly IDs from the subassemblies, the subassembly IDs are attached to the subassemblies in the form of geometric information.

(Item 27)

Medical instrument management equipment, comprising;
an assembly table storage for storing the assembly table, where the medical instrument IDs assigned to the medical instruments are corresponded to the subassembly IDs assigned to plural kinds of subassemblies associated with given medical functions as basic units of the medical instrument,
a medical instrument ID entry element for accepting the entered medical instrument IDs,
a subassembly ID entry element for accepting the entered subassembly IDs, and
an assembly table recording element for recording the entered medical instrument ID of the medical instrument to be managed and the entered subassembly IDs of the subassemblies composing the medical instrument in the assembly table in connection with one another.
   (Item 28)

The medical instrument management equipment described in the item 27, further comprising;
an instrument usage data storage for storing an instrument usage data table, where the medical instrument IDs of the medical instruments are corresponded to the information on their usage (hereinafter, simply referred to as “usage information”), and
an intended purpose entry element for accepting the information on the usage of the medical instrument entered by the user,
an instrument usage data recording element for recording the medical instrument IDs of the medical instruments to me managed accepted by the medical instrument ID entry element and the information on the usage accepted by the intended purpose entry element in the instrument usage data table in connection with one another.
   (Item 29)

The medical instrument management equipment described in the item 28, comprising;
a subassembly usage data storage for storing the subassembly IDs of the subassemblies and the information of the usage of the subassemblies in the subassembly usage data table in connection with one another,
a subassembly ID identifying element for detecting the subassembly ID of the subassembly contained the medical instrument to be managed by referring to the assemble table based on the medical instrument ID of the medical instrument, and
a subassembly usage data recording element for recording the subassembly ID detected and the information on the usage of the medical instrument to be managed in the subassembly usage data table in connection with one another.
   (Item 30)

The medical instrument management equipment described in any of the items 27 to 29, further comprising;
a supplied instrument table storage for storing the supplied instrument table where the medical instrument ID of the supplied medical instrument are corresponded to the subassembly IDs of the subassemblies contained in the medical instrument, and
a collection detection element for detecting the collected subassemblies and/or uncollected subassemblies among the subassemblies contained in the medical instrument supplied by referring to the supplied instrument table.
   (Item 31)

The medical instrument management equipment described in any of the items 27 to 30, comprising;
a malfunction table storage for storing the malfunction data table where the information on malfunction occurring in using the medical instrument (hereinafter, simply referred to as “malfunction information”) are corresponded to the subassembly IDs of the subassemblies contained in the medical instrument,
a malfunction entry element for accepting the information on the malfunction occurring in the medical instrument entered by the user,
a malfunction table recording element for recording the malfunction data table where the subassembly IDs detected the subassembly ID detection element of the subassemblies contained in the medical instrument, for which the malfunction information has been accepted, are corresponded to the information on the multifunction on the medical instrument, and
a malfunction detection element for determining whether the subassembly to be inspected has been ever incorporated in the medical instrument with a malfunction by referring to the malfunction data table.
   (Item 32)

The medical instrument management equipment described in any of the items from 27 to 31, wherein the malfunction table recording element records the a combination of subassemblies contained in the medical instrument, for which the entered multifunction information has been accepted and the information on the malfunction occurring in the medical instrument in the malfunction data table in connection with one another, the malfunction detection element determining whether a combination of plural kinds of subassemblies to be inspected has been ever incorporated in the medical instrument with the malfunction by referring to the malfunction data table.

(Item 33)

A medical instrument management method, comprising;
a step for detecting the medical instrument ID assigned to the medical instrument,
a step for detecting the entered subassembly IDs assigned to the subassemblies corresponding to the given medical functions as the basic units of the medical instrument, and
a step for recording the entered medical instrument ID of the medical instrument to be managed and the entered subassembly IDs of plural kinds of subassemblies contained in the medical instrument in the given location of memory in connection with one another as the assemble table to manage the usage status of the medical instrument and their subassemblies.
   (Item 34)

A medical instrument management program, wherein the computer can fulfill a function for detecting the entered medical instrument ID assigned to the medical instrument,
a function for detecting the entered subassembly IDs assigned to the subassemblies corresponding to the medical functions as basic units of the medical instrument, and
a function for recording the entered medical instrument ID of the medical instrument t be managed and the entered subassembly IDs of plural kinds of subassemblies contained in the medical instrument in the given location of memory in connection with one another as the assemble table to manage the usage status of the medical instrument and their subassemblies.

Regarding the item 25, the “subassembly” corresponds to each of medical functions of the components of the medical instrument and the basic units for which reusability is determined. The subassemblies are not limited to single-piece subassemblies and may subassemblies made of plural kinds of parts. Some subassemblies are to be disposed once being used and the others may be used several times. The medical instrument may be assembled from a combination of two types of subassemblies. For example, for the medical instrument such as a bipolar tweezers, various functions including a function for pinching the affected site and a function for transmitting the user's operation achieves the whole functionality of the medical instrument. The subassemblies may correspond to various medical functions.

The subassembly IDs may be attached to the medical instrument for example, unique geometric information, and numeric and literal characters in the form of a sticker, engraved mark, or print. Alternatively, the subassembly IDs may be attached to the subassemblies so that they may be electro-magnetically read such as RFID (Radio Frequency Identification).

Regarding the item 27, the medical instrument ID may be created an external device or defined by the user at his/her discretion. Alternatively, the medical instrument management equipment itself may create the medical instrument IDs internally. The medical instrument ID may be attached in the form of, for example, a sticker, engraved mark, or print on the package. The medical instruction IDs may be assigned to the medical instruments when being assembled. Alternatively, the medical instrument IDs may be released when the medical instrument is disassembled into their subassemblies or when some of the subassemblies composing the medical instruction are incorporated in another medical instrument. Thus, the subassembly ID may remain effective as long as the subassembly with the ID assigned continue to be reused and the medical instrument ID may remain effective as long as the subassemblies are treated as parts of the medical instrument.

Regarding the item 28, the usage information may identify the step, where the medical instrument is, such as washing, operation, sterilization. At these steps, the user treating the medical instrument may update the instrument usage data table by entering the information in the instrument, if appropriate. Moreover, the usage information may contain various information on the medical instrument, such as the name of the user treating the medical instrument, the usage date (day and time), operation type, and sterilization technique. The entered usage information may be recorded as the subassembly usage table by corresponding to the subassembly IDs of the subassemblies contained din the medical instrument.

The equipment may determine whether the subassemblies contained in the medical instrument delivered by the medical instrument supplier to the medical field have been collected or not. To do so, the equipment may record the medical instrument ID of the delivered medical instrument and the subassembly IDs of the subassemblies contained in the medical instrument as the supplied instrument table in connection with one another. Besides, it may determine whether the subassemblies contained din the medical instrument have been collected by collating the subassembly IDs of the collected subassemblies to the supplied instrument table.

Regarding the item 30, the malfunction information may the information on any anomaly detected in the medical instrument when used by the use. In the step, the user treating the medical instrument may update the malfunction table by entering the malfunction information in the equipment, if appropriate. The malfunction table may contain a combination of subassemblies contained in the medical instrument, for which the malfunction information has been entered. This records a combination of subassemblies, which may cause a malfunction.

<Estimating system>

### Embodiment 5

In the medical field, fixed type of medical instruments are used such as a light source and monitor devices as well as disposable and reusable instruments. For reusable instruments, new product are not provided every medical practice and the same instruments are used several times after being washed, sterilized, and checked for any anomaly. For light source and monitor devices, for example, they may be used under the lease contract agreed with the supplier for a given period. For that reason, cost for each medical practice is difficult to be estimated.

The embodiment 5 has been developed in this context and its object to provide a technique for estimating the cost for each medical practice.

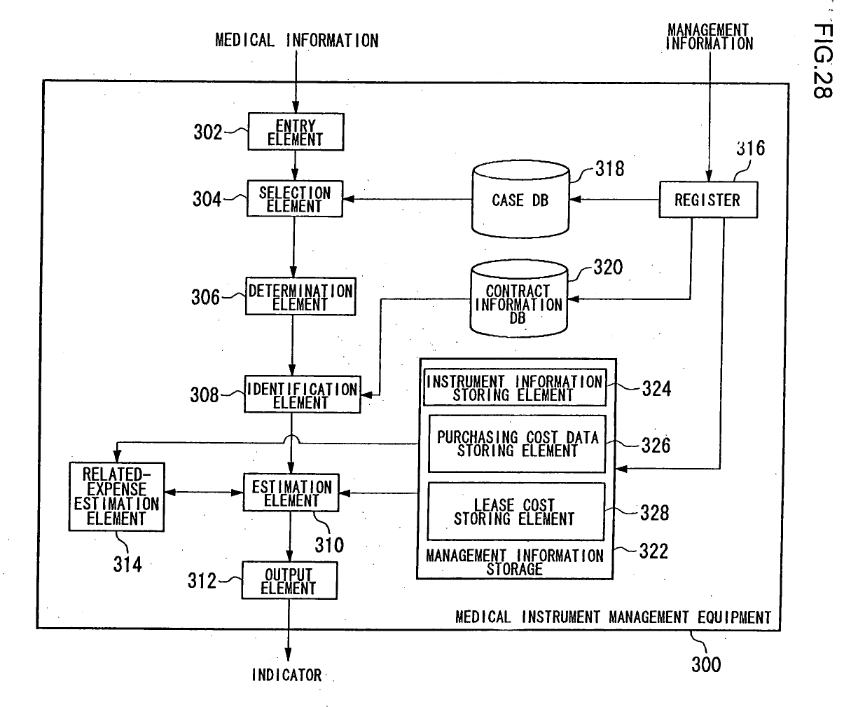

FIG. 28 is a view showing the medical instrument management equipment 300 of the present invention. The components of the medical instrument management equipment 300 may be implemented centering on the CPU of any computer, memory, a program for implementing the components loaded in memory (shown in the figure), a memory unit such as hard disk storing the program, and an interface for connecting to a network, taking a computer system as an example. The person skilled in the art will fully recognize that there are various variants for its implementing method and devices. The figures described below show functional blocks but not the components of hardware configuration. Note that the medical instrument management equipment 240 is the first device 20 in FIG. 1.

The entry element 302 accepts entered information (hereinafter, simply referred to as “medical information”) on the medical instrument required in conducting a given medical practice through an input device, for example, a keyboard or mouse. The entry element 302 may accept the name of the medical instrument individually or the name of a medical practice, for example, “transurethral prostate resection” or “laparoscopic gastric resection”. The selection element 304, when the case name is entered as the medical information, selects the medical instrument(s) to be used by referring to the case database 318.

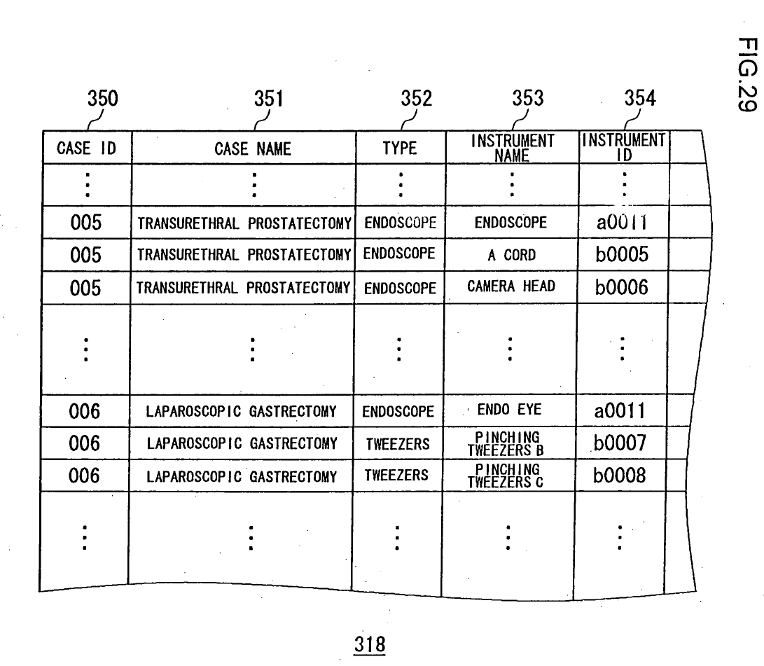

FIG. 29 is a view showing an example of the data structure of the case database 318. The case ID column 350 contains information identifying cases. The case name column 351 contains the case name. The class column 352 contains information on the class of the medical instrument. The instrument name column 353 contains the name of a medical instrument. The instrument ID column 354 contains the instrument ID identifying the medical instrument. For example, to “transurethral prostate resection” by identified the case ID “005”, an “endoscope” “End Eye”, “grasping tweezers A”, and “ablation tweezers” are corresponded. Thus, the case database 318 contains information, which corresponds each case to the medical instruments to be used. Note that in the figure, only the cases using an endoscope are shown but the present invention is not intended to limit to these cases. The case database 318 can contains information on various cases.

Returning back to FIG. 28, the selection element 304 selects the medical instrument(s) corresponding to a given case by referring to the case database 318 using the case name entered from the entry element 302 as a retrieval key. Then, the selection 304 outputs the medical instrument ID of the selected medical instrument at the determination element 306. Thus, by corresponding the medical instrument(s) to be used for each case to the case name, the medical instrument(S) to be used for the case specified by the user, namely the medical instrument(s) to be used in the medical practice may be automatically selected.

The determination element 306 determines whether the fees for the medical instruments selected at the selection element 304 is used in estimating the cost of a medical practice for each case (hereinafter, simply referred to as “case expense”). Hereinafter, the medical instrument, for which fee is included in estimating the case expense, are simply referred to as “estimated medical instrument” and the medical instrument, for which fee is excluded, is simply referred to as “non-estimated medical instrument”. In the embodiment 5, the lease medical instruments or the purchased medical instruments are included in estimating the case expense while other medical instruments are excluded. Namely, the determination element 306 determines the lease and purchased medical instruments as “estimated medical instrument” and other medical instruments as “non-estimated medical instrument”. The non-estimated medical instruments may include hospital fixtures such as a surgical table and instrument table and consumables such as gauze and medications. The medical instruments to be treated non-estimated medical instrument may be determined in accordance with administrative policies of the hospital.

Various methods for implementing the determination step at the determination element 306 may be assumed. For example, the determination element 306 may contain the list of estimated medical instruments, determines the medical instrument ID entered at the election element 304 found in the list to be estimated medical instrument, and the medical instrument of which ID is not found in the list as non-estimated medical instrument.

As described later in detail, a contract information database 320 contains the contract information for each medical instrument. An identification element 308 determines whether for the medical instrument determined to be an estimated medical instrument, a contract has been concluded or not by referring to the contract information database 32.0 and identifies estimated medical instruments and non-estimated medical instruments. In the embodiment 5, the lease contract has been concluded for each medical instrument, and the identification element 308 identifies the medical instruments to be leased contacted as lease-medical instruments and the others as purchased medical instruments.

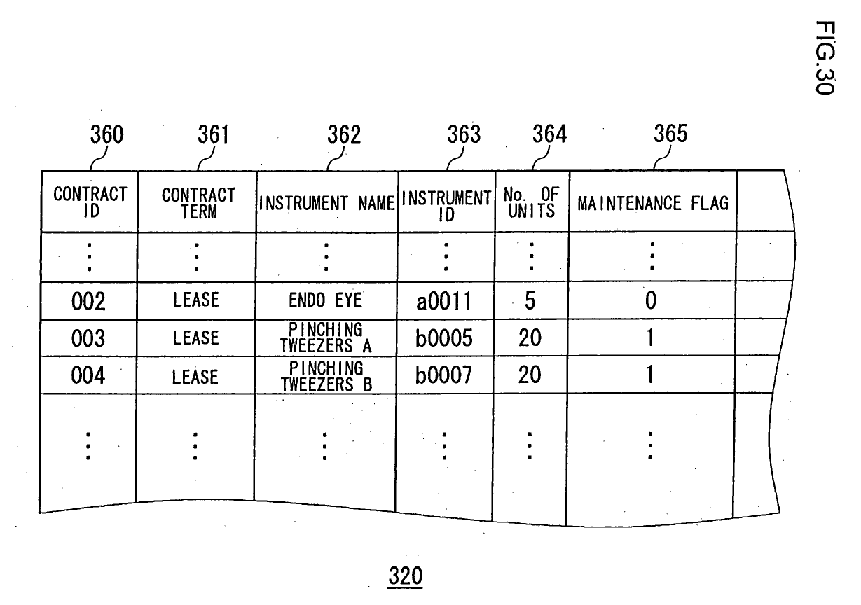

FIG. 30 is a view showing an example of the data structure of the contract information database 320. A contract ID column 360 contains the contract IDs identifying the contracts. A contract term column 361 contains information indicating the contract term such as “lease”, “purchases”, and the like. An instrument name column 362 contains the names of contracted medical instruments. An instrument ID column 363 contains the medical instrument IDs of contracted medical instruments. A count column 364 contains the number of contracted medical instruments. A maintenance flag column 365 contains information on whether a medical instrument maintenance service is needed or not on the user side, namely the hospital side. In the figure, “1” indicates the hospital's need for maintenance and “0” indicates no need. As described later in detail, by referring to the maintenance flag, it may be determined whether the maintenance task related to the use of medical instruments is required or not and also whether the related cost incurs or not.

In other examples, the contract information database 320 may contain information indicating whether waste disposal is required or not. Namely, the contract information database 320 contains not only the contract information but also information required for determining whether cost for the task related to the use of the contracted medical instruments incurs or not. In the embodiment 5, the contract has been concluded for each medical instrument and the information on the concluded each contract is contained in the database as a record. For example, the contract ID “003” indicates that the lease contract of 20 “pinching tweezers” has been concluded. The maintenance flag “1” indicates the hospital's need for maintenance.

Retuning back to FIG. 28, the estimation element 310 estimates the unit cost of a contracted medical instrument determined to be estimated medical instrument and the unit cost of a non-contracted one using different pricing systems and adds these unit costs to calculate the case expense. The estimation element 310 estimates the unit cost as the case expense and does not calculate the precise cost. Of course, precise case expense may be calculated provided that all the medical instruments used in a given medical practice are included in a group of estimated medical instruments.

The estimation element 310 identifies the unit cost for the purchased medical instrument by referring to a purchasing cost data storage 326, while the unit cost for the lease medical instrument by referring to a lease cost data storage 328. It sums up these unit costs for these medical instruments to estimate the case expense. It also gives an instruction to a related expense estimation element 314 requiring that it use the estimated medical instruments to estimate another related expense.

The related expense estimation element 314 estimates the costs for the related tasks such as washing, sterilization, maintenance service, and disposal, all of which are required after they have been used, as a related expense. The related expense estimation element 314 outputs the estimated related expense to the estimation element 310. The estimation element 310 outputs the related expense output estimated at the related expense estimation element 314 and the case expense to the output element 312. The output element 312 displays the case expense and related expense information in the indicator, prints or writes out them.

A management information storage 322 contains a instrument information storing element 324, a purchasing cost data storing element 326, and a lease cost data storing element 328. The instrument information storing element 324 contains information to be used in estimating the costs for the medical instruments related to tasks, for example, the name of medical instrument, need for maintenance, and disposal method. The purchasing cost data storing element 326 contains unit costs required for using the purchased medical instruments. The purchasing cost data storing element 326 may contain a value calculated by dividing the purchasing cost of a medical instrument by the number of usage times scheduled until its disposal as a unit cost and may contain the fee/usage of the medical instrument purchased by the hospital. The lease cost data storing element 328 contains the unit costs required for using the lease medical instruments. The lease cost data storing element 328 contains the fee/usage defined in the lease contract as the unit cost. In another example, a contract other than the lease contract may be concluded and the management information storage 322 may contain the fee/usage of the medical instrument according to the contract term. In short, the management information storage 322 may contain information required for the case expense estimation element 310 to estimate the case expense based on the unit costs of the medical instruments, which meet the given contract term and the unit costs of the medical instruments, which do not meet the given contract term.

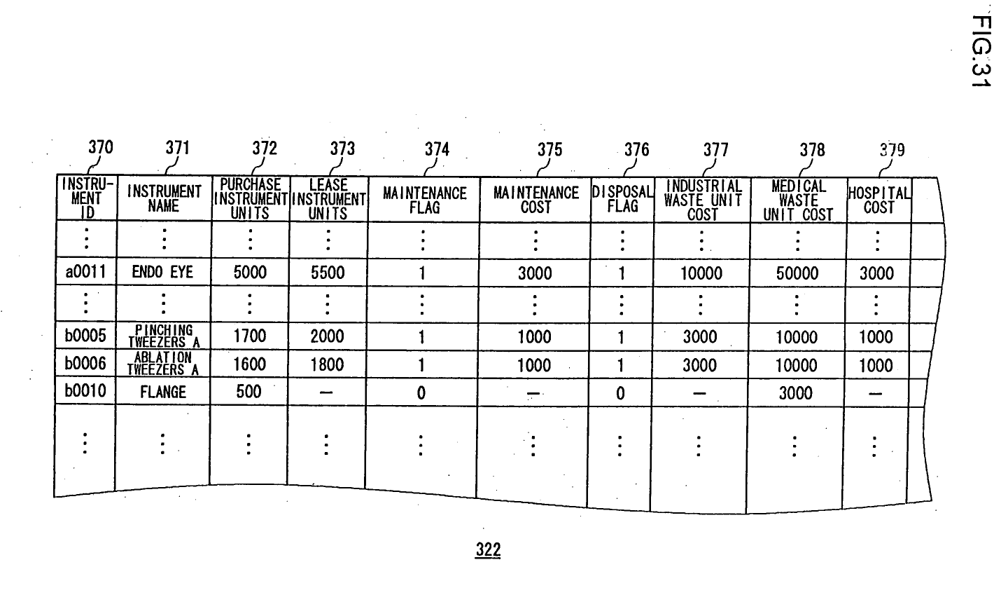

FIG. 31 is a view showing an example of the data structure of the management information storage 322 shown in FIG. 28. The instrument ID column 370 contains the medical instrument ID of the medical instrument. The instrument name column 371 contains the name of the medical instrument. The purchasing unit column 372 contains the unit cost of the purchased medical instrument. The lease unit cost column 373 contains the unit cost of the lease medical instrument. The estimation element 310 shown in FIG. 28 identifies the unit cost of by referring to the purchase unit cost column 372 and estimates the case expense by referring to the lease unit cost by referring to the lease unit cost column 373.

The maintenance flag column 374 contains information on the need for maintenance in using the medical instrument. In the figure, “1” indicates that the maintenance is needed while “0” indicates that it is not needed. If maintenance is needed, maintenance cost incurs. The maintenance cost column 375 contains a maintenance cost.

The estimation element 310 shown in FIG. 28 refers to the maintenance flag column 374. If the medical instrument, for which maintenance is needed, is found in a list of estimated medical instruments, the estimation element 310 requests the related expense estimation element 324 shown in FIG. 28 to estimate the cost required for maintenance of the medical instrument. The related expense estimation element 314 estimates the maintenance cost by referring to the maintenance cost column 375.

The disposal flag column 376 contains information on whether the medical instrument may be disposed as non-infectious waste or not. The waste can be classified into two groups, “infectious” and “non-infectious”. Hereinafter, the infectious wastes are simply referred to as “medical waste” and non-infectious waste as “industrial waste”. In the figure, “1” indicates that the medical instruments may be disposed as industrial waste and “0” indicates that they may not.

An industrial waste unit cost column 377 contains the cost required for disposing the medical instrument as industrial waste. A medical waste unit cost column 378 contains the cost required for disposing the medical instrument as medical waste. The medical wastes may be disposed as industrial waste, by, for example, applying treatments such as washing, disinfect, and sterilization. When these washing, disinfecting, and sterilizing treatments are applied to the medical instruments, special tasks are needed. A hospital cost column 379 contains the cost required for washing, disinfecting, and sterilizing the medical instruments. The cost is estimated based on, for example, labor time, the costs for detergents and electricity used in washing, disinfecting, and sterilizing the medical instruments.

Generally, the cost require for disposing medical waste id higher than that of industrial waste. Since by washing, disinfecting, and sterilizing the medical wastes, they may be disposed as industrial waste, in some cases it may reduce the disposal cost that the medical instruments are disposed as industrial waste by washing, disinfecting, and sterilizing them depending on their costs. The waste flag column 376, the industrial waste unit cost column 377, medical waste unit cost column 378, and hospital cost column 379 are included so that a indication may be given whether the medical instrument is to be disposed as medical waste or industrial waste.

The estimation element 310 shown in FIG. 28 requests the related expense estimation element 314 to estimate the cost required for disposal of the medical instruments. The related expense estimation element 314 refers to the waste flag column 376 and estimates the cost required for disposing the medical instruments to be disposed as industrial waste, and the cost for required for disposing them as medical waste, and the cost incurring in the hospital for washing, disinfecting, and sterilizing them as the related expense. The related expense estimation element 314 used data contained in the industrial waste unit cost column 377, the medical waste unit cost column 378, and the hospital cost column 379 to estimate the related expense.

In response to the instruction given by the estimation element 310, the related expense estimation element 314 estimates the related expense such as the maintenance cost and the disposal cost. For the lease medical instruments, namely the medical instruments, which meets the given contract term, the related expense estimation element 314 determines whether the hospital shall maintain or dispose the medical instruments by referring to the contract information database 320. To determine the need for maintenance or disposal, the related expense estimation element 314 uses the data contained in the maintenance flag column 365 shown in FIG. 30. The related expense estimation element 314 estimates the related expense, when the hospital needs to perform maintenance or disposal of the medical instruments.

The contract information for medical instruments, the medical instruments used foe each case, and estimated medical instruments are dependent on the hospital. The register 316 accepts the records to be contained in the case database 318, the contract information database 320, and management information storage 322 as management information and registers them in the case database 318, the contract information database 320, and the management information storage 322, respectively. The register 316 may accept for example, management information via any input device for example, a keyboard or mouse, or may accept management information from a server over a network. Any path, along which management information is acquired, may be used. The register 316 may update data contained in the case database 318, the contract information database 320, and the management information storage 322 and organize so that they may be customized for each hospital. This allows for cost estimation for medical practices at each hospital.

The medical instrument management equipment 300 not only estimates the case expense but also provides the user with the related expense incurring for the case. Accordingly, the user can clearly understand the cost for each medical practice, making the ambiguous problem in hospital accounting clear.

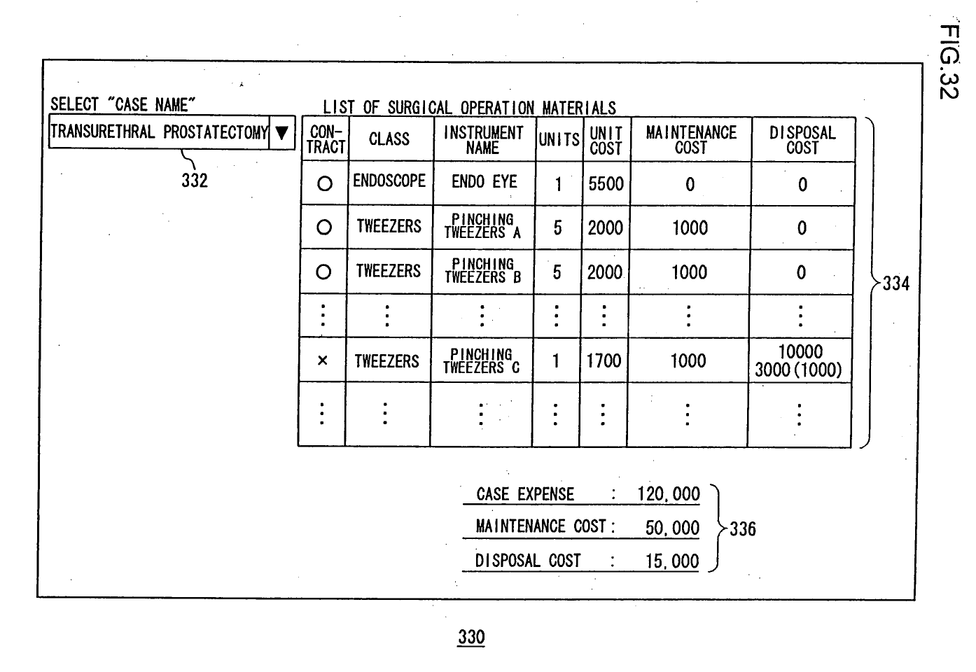

FIG. 32 is a view showing an example of a display in the indicator output by the output element 312 shown in FIG. 28. A case entry area 332 is an area for entering a case. In the figure, a combo box is created to select any case. In an instrument list area 334, a list of medical instruments corresponded to the cases enter in the case entry are 332 appears. In the contract list column, a mark or character indicates whether for the medical instrument, a lease contract has been concluded or not. In a maintenance cost column, the maintenance cost is displayed. In a disposal cost column, the disposal cost is displayed. The disposal cost incurs for purchase medical instruments. For example, in the figure, for an “endoscope”, a lease medical instrument, “0 yen” is displayed in the disposal cost column. Moreover, the “pinching tweezers” is a purchased medical instrument and “1000 yen” is displayed in the maintenance cost column. In the waste cost column, the disposal cost “10000 yen” in the case of disposing as medical waste is displayed in the upper line and “3000 yen” as industrial waste and the cost “1000 yen” for washing, disinfecting, and sterilizing the medical instruments are displayed in the lower line. In the cost display are 336, the case expense, maintenance cost, and disposal cost are displayed.

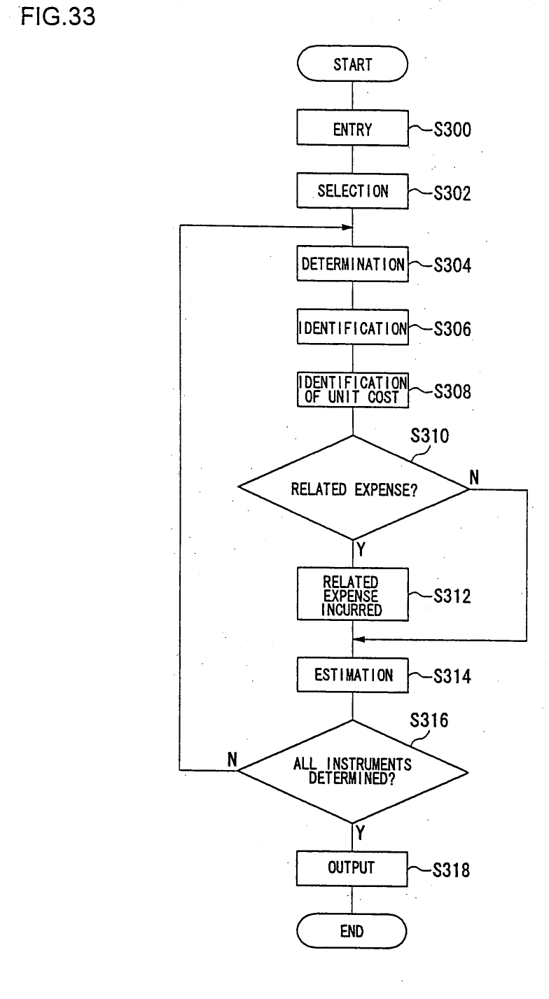

FIG. 33 is a flowchart showing a process in the medical instrument management equipment 300 shown in FIG. 28. Entry elements 302 shown in FIG. 28 can accept the entered cases (S300). The election element 304 shown in FIG. 28 selects the medical instrument previously corresponded to accepted case (S302). The determination element shown in FIG. 28 determines whether the medical instrument is estimated, or non-estimated (S304). The identification element 308 shown in FIG. 28 identifies the lease and purchased medical instruments included in estimated medical instruments (S306). The estimation element 310 shown in FIG. 28 identifies the unit costs for the lease and purchased medical instruments, respectively (S308).

Moreover, the estimation element 310 determines whether the related expense may incur or not (S310). If the related expense incurs (Y at S310), the related expense estimation element 314 shown in FIG. 28 estimates the related expense (S312). The estimation element 300 estimates the case expense and the related expense based on the unit cost of the medical instrument and the related expense (S314). If no related expense incurs (N at S310), the process goes to S314. The determination element 306 determines whether the entry element 302 has checked all the medical instruments corresponding to the accepted cases or not (S316). If all the medical instruments have not been checked (N at S316), the process returns back to 304. If all the medical instrument checked (Y at S316), the estimation element 310 outputs the case expense and the related expense (S318).

The system for estimating the cost for each medical practice has been described referring to the embodiment 5. The embodiment 5 only informative and the person skilled in the art may fully recognize that various variants can be developed by combining the components and steps and these variants may be included in the scope of the present invention.

These variants include:

First Variant in the Embodiment 5

The management information storage 322 may contain fields for registering unit costs for various kinds of things, person, and services in conducting medical practices such as the unit costs for a surgeon and nurse. The register 316 may accept and register the information from the user. The more the information contained in these fields, the accurate the estimation of case expense may be achieved.

Second Variation in the Embodiment 5

The medical instrument management equipment 300 shown in FIG. 28 may be configured as a server so that the hospital can accesses the medical instrument management equipment on a network using, for example, the user's browser. In this case, the entry element 302, the output element 312, and register 316 shown in FIG. 28 may be communicatably configured in conformance with any communications protocol, for example, HTTP (Hyper Text Transfer Protocol). Moreover, the entry element 302, the register 316, and output element 312 are able to provide the web browser with the screen information in conformance with, for example, HTML (Hyper Text Markup Language) through a network.

Furthermore, the medical instrument management equipment 300 may be shared a plurality of hospitals and in this case, the entry element 302 and the register 316 have preferably a certification function. Any known art may be employed for the certification function. Besides, to estimate the cost for each hospital individually, the case database 318, the contract database 320, and the management information storage 322 may contain the various type of information in correspondence with hospital IDs. For example, the contract information database 320 described using FIG. 30 contains records in connection with hospital IDs. This allows a plurality of hospitals to share the medical instrument management equipment installed on the network.

Third Variant in the Embodiment 5

The functions implemented in the medical instrument management equipment 300 may be distributed at the nodes over the network. For example, the case database 318 may be deployed in the network and the remaining functions may be implemented at the terminals on the hospital side. At least one of the case database 318, the contract information database 320, and the management information storage 322 may be deployed on the intra-hospital network. In short, focusing on the administrative policies such as maintainability and security of various kinds of information contained in the case database 318, the contract information database 320, and management information storage, they may be configured.

Fourth Variant in the Embodiment 5

The medical instrument management equipment 300 may further have an order element for making order to the order-receiving device, which accepts orders of medical instruments, configured on the network. For example, the output element 312 further brings up the “Order” button for giving an instruction to the display screen described using FIG. 32. When the “Order” button is pressed, the order element makes an order of the medical instrument, for which cost has been estimated, to the order-receiving device. The order element refers to the contract information database 320 and sends the instrument ID and the contract ID in connection with one another to the order-receiving device. When receiving data, the order-receiving device can arrange the ordered medical instruments, identify the unit cost of the medical instrument in accordance with the contract for each hospital, and estimate the total cost.

The characteristics described in the embodiment 5 may be specified by the following items.

(Item 35)

Medical Instrument management equipment, comprising;
a entry element for accepting medical information on the given medical practice,
a selection element for selecting the medical instrument corresponded to the given medical practice base on the medical information,
a first storage for containing the conditions for using the given medical instruments under the given contract,
an identification element for determining whether the medical instruments selected at the selection element are related to those defined in the given contract, referring to the first storage, and
an estimation element for estimating the costs required for using the medical instruments-corresponded to the medical practice depending on they being contracted or not contracted ones using different pricing systems.
   (Item 36)

The medical instrument management equipment described in the item 35, further comprising;
a second storage for containing information required for identifying the medical instruments for each medical practice in connection with one another, wherein the selection element refers to the second storage to select the medical instruments corresponded to the medical information accepted.
   (Item 37)

The medical instrument management equipment described in the item 35 or 36, further comprising;
a register for accepting the conditions for using the given medical instruments under the given contract and registering them in the first storage.
   (Item 38)

The medical instrument management equipment described in any of the items 35 to 37, wherein, the first storage contains information identifying the lease medical instrument, and the identification element determines whether the medical instrument selected at the selection element is the lease medical instrument or the purchased medical instrument.

(Item 39)

A program implementing in a computer;
an entry element for accepting the medical information on the given medical practice,
a selection element for selecting the medical instrument corresponded to the medical practice based on the medical information,
a first storage for containing the conditions for using the given medical instructions under the given contract,
an identification element for determining whether the medical instrument is a medical instrument related to the given contract or not by referring to the first storage, and
an estimation element for estimating the cost for using the medical instrument corresponded to the medical practice depending on whether it is related to the given contract using different pricing system.
   (Item 40)

A medical instrument management method, comprising;
an entry step for accepting the entered medical information on the given medical practice,
a selection step for selecting the medical instrument corresponded to the given medical practice based on the medical information by referring to the storage containing the information identifying the medical instrument to be used for medical practice,
a step for determining whether the medical instrument selected at the step is related to the given contractor not by referring to the storage containing the conditions for using the given medical instrument under the given contract, and
a step for estimating the cost required for using the medical instrument corresponded to the medical practice using difference pricing systems depending on whether the medical instrument is related to the contract or not.
   (Item 41)

A medical instrument management equipment, comprising;
an entry element for accepting the entered medical information on the given medical practice,
a selection element for selecting the medical instrument corresponded to the given medical practice based on the medical information,
a storage for containing the cost required for using the medical instrument for each medical instrument,
an estimation element for identifying the costs for using individual medical instruments selected at the selection element by referring to the storage and estimating the total cost required for using a series of medical instruments corresponded to the given medical practice,
   (Item 42)

The medical instrument management equipment described in the item 41, further comprising;
a related expense estimation element for estimating the related expense related to the medical instrument.
   (Item 43)

The medical instrument management equipment described in the item 42, wherein the related expense estimation element estimates the maintenance cost for the medical instrument to be maintained as the related expense.

(Item 44)

The medical instrument described in item 42 or 43, wherein the related expense estimation element estimates the cost for disposing the medical instrument as the related expense.

(Item 45)

The medical instrument described in the item 44, wherein aforementioned related expense estimation element estimates the cost for disposing the medical instrument as the waste in the first class and the cost for disposing it as the waste in the second class, as the related expense, and estimates the labor required for the entity, who uses the system, to dispose the wastes in both classes.

(Item 46)

Medical instrument management equipment, comprising;
an entry for accepting the entered information on the medical instrument to be used in the given medical practice,
an identification element for identifying the lease medical instrument to be leased and the purchased medical instrument to be purchased among the medical instruments,
a lease cost data storage for storing the lease cost data on the lease medical instrument,
a purchasing cost data storage for storing the purchasing data on the purchased medical instrument, and
an estimation element for reading the lease cost data stored in the lease cost data storage or the purchasing cost data stored in the purchasing cost data storage and estimates the cost for the medical practice.
   (Item 47)

Medical instrument management equipment, comprising;
an entry for accepting the entered information on the medical instrument to be used in the given medical practice,
an identification element for identifying the lease medical instrument to be leased, the purchased medical instrument to be purchased, and the medical instrument to be maintained among the the medical instruments,
a lease cost data storing element for storing lease cost data on the lease medical instruments,
a purchasing cost storing element for storing purchasing cost data on the purchased medial instrument, and
an estimation element for reading the lease cost data stored in the lease cost data storing element or the purchasing cost data stored in the purchasing cost data based on the result of the identification at the identification element and estimating the cost for the given medical instrument, and
an output element for outputting at least the cost estimated in the estimation element, the information on the lease medical instrument, information on the purchased medical instrument, and the medical instrument to be maintained.
   (Item 48)

Medical instrument management equipment, comprising;
an entry element for accepting the entered information on the medical instrument to be used in the given medical practice, and an estimation element for identifying the medical instrument to be disposed after the medical practice and estimating the cost for disposing waste.
   (Item 49)

The medical instrument management equipment described in the item 48, wherein, the related expense estimation element estimates the costs for disposing the medical instrument to be disposed as medical waste after the medical practice and the medical instrument to be reused after the medical practice using different pricing systems.

According to the item 35, when medical information, for example, the case name is entered, the medical instrument to be used in the case is selected, eliminating the need for the user to enter the individual medical instruments to be used in the medical practice. For this reason, data may be easily entered and excessive time consumption and mental burden may be eliminated. Moreover, depending on the given contract for the medical instrument, the costs are estimated using the different pricing system. Accordingly, the cost for each medical practice may be estimated under the contract for each medical instrument.

According to the item 37, since the contract information may be registered at the user's discretion, the costs for the given medical practice may be estimated for each hospital using the different pricing systems.

According to the item 41, since if medical information, for example, the case name is entered, the medical instrument to be used in the medical practice is selected, the user needs not to enter the individual medical instruments to be used.

According to the item 42, the cost incurred by the medical practice may be estimated with time to space not only at the point when the medical practice is conducted but also at up to the point when the medical instrument is maintained or disposed, the costs incurring at the hospital may be made clear for each medical instrument.

According to the item 45, for example, “Class 1 waste” indicates infectious waste and “Class 2 waste” indicates non-infectious waste. “Labor incurring in entity” is the task, for example, washing and sterilization required for changing the infectious waste to the non-infectious waste.

<Medical Instrument Management System>

### Embodiment 6

To reduce the cost for the medical instruments, the medical instruments such as reusable instruments may be leased. However, when the medical instrument supplier leases their lease instruments to a plurality of hospitals, it is required to strictly manage lease status of medical instruments to the hospitals. These medical instruments need to be more strictly managed than other lease products because of they being for the medical practices.

The embodiment 6 has been developed in this context and its object is to provide a technique for effectively managing the medical instruments to be leased.

First of all, the medical instrument management system is outlined and then described in detail. The embodiment 6 of the present invention relates to a distribution system for medical instruments, where the medical instrument supplier ships their medical instruments to the medical institution and collects at lease some of shipped medical instruments (hereinafter, simply referred to as “collected medical instrument”. As described before, herein, the medical instruments include two types, purchased medical instruments and lease medical instruments and the collected medical instrument is usually a lease medical instrument. The lease medical instrument may include given disposable medical instruments, for example, the disposable medical instruments to be disposed at the medical institution in addition to the reusable medical instruments.

At least some of collected medical instruments are the lease medical instruments to be leased from the medical instrument supplier to the medical institution based on the lease contract concluded between both parties. According to the embodiment 6, the medical instrument management equipment installed at the medical instrument supplier manages lease status of the lease medical instruments and operates appropriately them by referring to the lease status when the medical institution makes an order of medical instruments. In the embodiment 6, the medical instrument supplier assigns an identification number to each of the subassemblies of the lease medical instrument to recognize the circulation status for each of subassemblies of the lease medical instrument within the distribution channel by referring to the identification numbers. Hereinafter, in some cases, “medical instrument” and “their subassemblies” are not discriminated. In the case where the medical instrument has a plurality of subassemblies, “medical instrument” includes not only “medical instruments” but also “their subassemblies”.

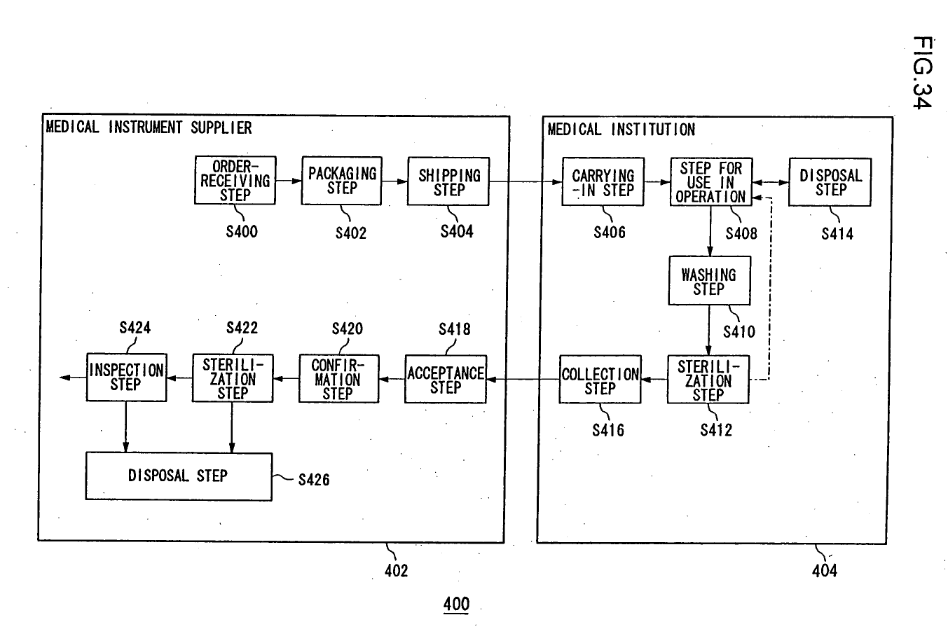

FIG. 34 is a schematic diagram explaining the distribution channel of the medical instruments in a medical instrument distribution system 400 according to the embodiment 6. The distribution system 400 includes the medical instrument supplier 402 and the medical institution 404. Herein, only the path, along which medical instruments are transported is described as the distribution channel between the medical instrument supplier 402 and the medical institution 404 but actually, it may include a network such as the Internet for ordering and order-receiving the medical instruments between the medical instrument supplier 402 and the medical institution 404. Moreover, in the figure, the distribution system has one medical instrument supplier 402 and one medical institution 404 only for easy recognition but a plurality of medical instrument suppliers 402 or a plurality of medical institutions 404 may be included.

The medical instrument supplier 402 is a entity which supplies medical instruments, for example, a medical instrument manufacturer. The medical institution 404 is a user of the medical instruments, for example, a hospital. The medical instrument supplier 402 accepts entered order data on the medical instrument to be used for a given medical practice through the network (not indicated) from the medical institution 404 (S400). When the medical instrument supplier 402 accepts the order data at the order-receiving step S400, confirms the stock of lease medical instruments, and arranges necessary medical instruments as described in detail later. The medical instrument supplier 402 packages the medical instruments according to the received order (S402) and ships the packaged medical instruments to the medical institution 404 (S404).

The medical instruments shipped from the medical instrument supplier 402 are carried in the medical institution 404 (S406). The medical institution 404 uses the carried medical instruments in surgical operation (S408). The medical devices, namely medical instruments are contaminated during surgical operation. The medical instruments, after being used, are disassembled into individual subassemblies. Those, which are included in a group of not-collected ones, out of the disassembled subassemblies are disposed (S414). Usually, the medical waste disposer collects these subassemblies to be disposed. The subassemblies included in a group of the collected ones are washed (S410) and sterilized (S412). The sterilized medical devices may be reused in surgical operation. After being disassembled, these washed/sterilized medical instruments in a group of collected ones are collected by the medical instrument supplier 402 (S416) and accepted by the medical institution 404 (S418). In the example shown in the figure, the medical instruments in a group of collected ones are washed and sterilized at the medical institution while in the other examples, they may be washed and sterilized at the medical instrument supplier 402.

The medical instrument supplier 402 confirms the lease medical instruments included in the collected medical instruments (S420). Namely, the medical instrument supplier 402 determines whether the lent lease medical instruments have been collected or not. The medical instrument supplier 402 re-sterilizes the collected medical instruments (S422). The disposable ones out of sterilized medical instruments in a group of collected ones are disposed (S426), while the reusable ones out of sterilized medical instruments in a group of collected ones are checked to determine whether they are to be disposed or reused depending on their usage status (S424). The reusable instruments determined to be disposed are disposed (S426). Usually, the medical waste disposer or the industrial waste disposer collects these medical instruments. The reusable instruments determined to be reusable are carried and kept in a warehouse of the medical instrument supplier 404 until they are lent to the medical institution 402.

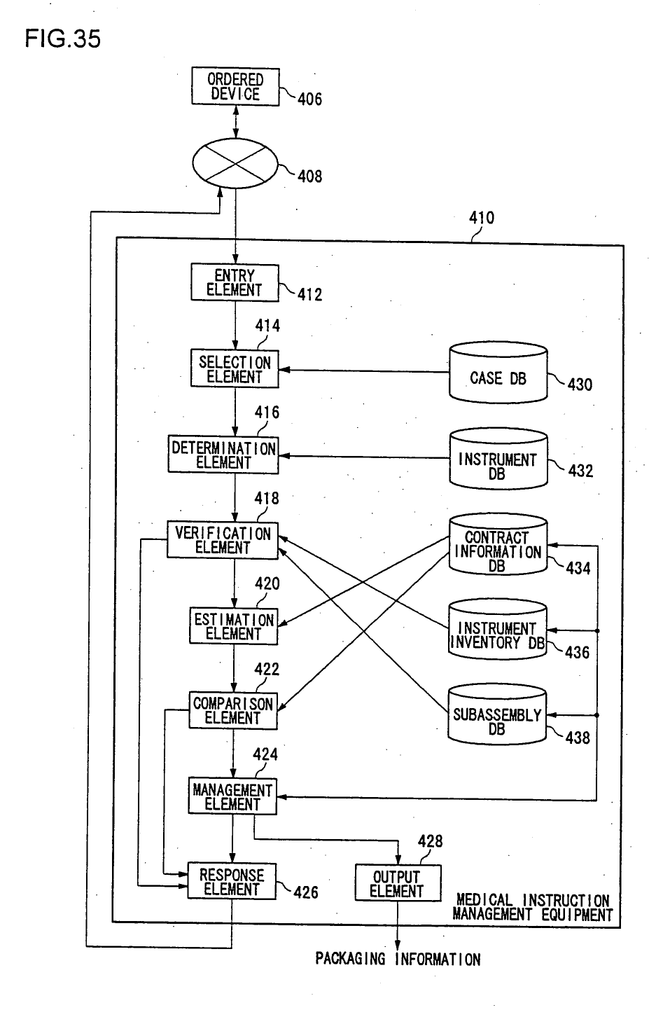

FIG. 35 is a view of the configuration of the medical instrument management equipment 410 according to the embodiment 6. The components of the medical instrument management equipment 410 are implemented by means of CPU, memory, a program loaded to memory, which implements the elements shown in the figure, memory unit, for example, hardware which stores the program, interface for connecting to a network giving as example of hardware components of any computer. The person skilled in the art can fully recognize that it may be implemented in other various manners. The figures described below indicate functional blocks but not hardware components. Note that the medical instrument management equipment 410 is the first device 20 in FIG. 1 and the order device 406 is the second device 30.

The entry element 412 accepts order data on the medical instruments to be used in the given medical practice from the medical institution 404 through the network 408. The entry element 412 may accept the names of the individual medical instrument or may accepts the case name, which indicates the given medical practice, for example, “laparoscopic cholecystectomy” and “laparoscopic gastrectomy”. At that time, the entry element 412 also accepts the desired date of delivery for the ordered medical instruments. When the case name is entered as the order data, the selection element 414 selects the medical instruments required for the medical practice by referring to the case database 430.

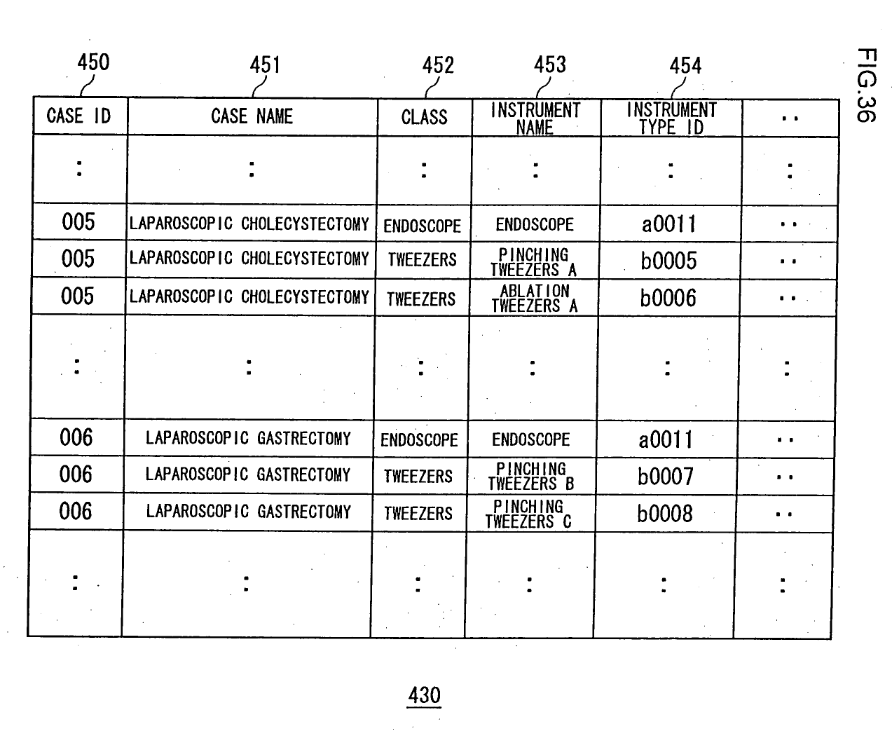

FIG. 36 is a view showing an example of the data structure of the case database 430 shown in FIG. 35. The case database 430 stores the medical instrument required for each case in connection with one another. The case ID column 450 contains information identifying the case. The case name column 451 contains the case name. The class column 452 contains information indicating the class of the medical instrument. The instrument name column 453 contains the name of the medical instrument. The instrument type ID 454 contains the instrument type ID identifying the type of the medical instrument. For example, “laparoscopic cholecystectomy” identified by the case ID “005” is corresponded to “endoscope” and “tweezers” such as “pinching tweezers A” and “Ablation tweezers A”. Thus, the case database 430 contains information identifying the medical instruments to be used for each case in connection one another. Note that in the figure, only the case corresponded to an endoscope is described but it is not intended to limit this example. The case database 430 may contains information on various type of cases.

Turning back to FIG. 35, the selection element 414 searches the case database 430 using the case name entered from the entry element 412 as a search key, selects the medical instrument corresponded to the given case, and outputs the instrument type ID of the selected medical instrument at the determination element 416. Thus, by corresponding the medical instruments to be possibly used to each case in advance, the case specified by the user, namely the medical instruments to be used in the medical practice may be extracted automatically, improving the user's convenience.

The case database 430 may be configured at each medical institution 404 or may be installed for each user, for example, a surgeon. If the surgeon, an orderer, desires the delivery of the medical instruments not included in a standard set of medical instruments stored in the case database 430, the entry element 412 may accept an additional order of the medical instruments.

The determination element 416 determines the lease medical instruments among the medical instruments selected at the selection element 414. The determination step may be implemented in various manners. For example, the determination element 416 may contains a list of lease medical instruments and determines those included in the list among the instrument type IDs supplied by the selection element 414, to be lease medical instruments. Alternatively, the determination element 416 may determines the lease medical instruments by referring to the medical database 432.

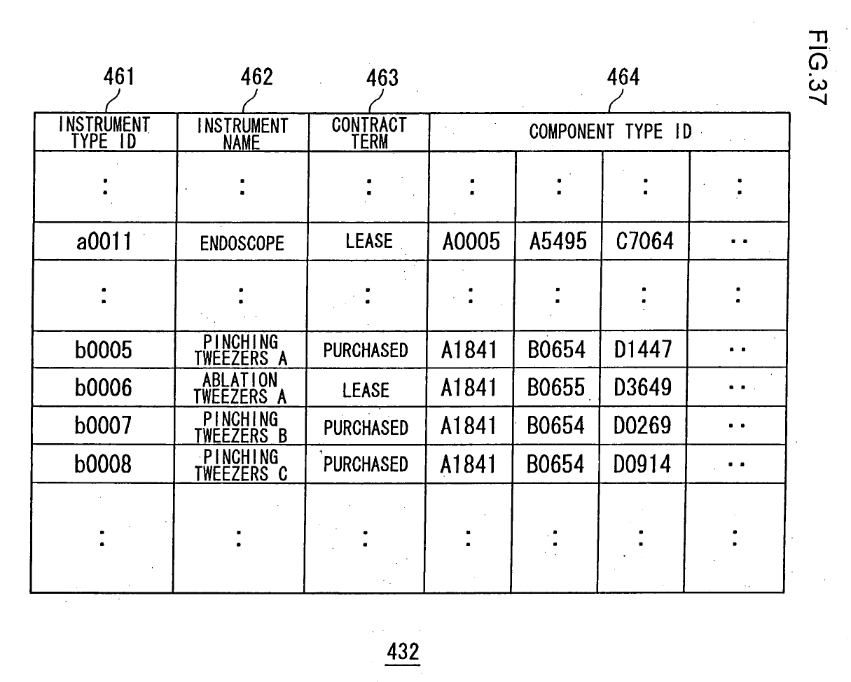

FIG. 37 is a view showing an example of the data structure the instrument database 432. The instrument database 432 stores information such as components and contract terms for each of medical instrument types. The instrument type ID column 461 contains the instrument type ID identifying the medical instrument type. The instrument name column 462 contains the name of the medical instrument. The contract term column 463 contains the contract term to be followed when the medical instruments are delivered to the medical institution 404. Specifically, it contains information on whether the medical instruments are supplied under the lease contract or under the purchasing contract. The component type ID column 464 contains the subassembly type ID identifying the type of the subassembly of the medical instrument.

Turn in back to FIG. 35, the determination element 416 searches the instrument database 432 using the instrument type ID of the medical instrument selected at the selection element 414 as a search key, identifies the lease medical instrument, and outputs it at the verification element 418. Moreover, the determination element 416 acquires the subassembly type IDs of the assemblies composing the identified lease medical instrument from the instrument database 432, and outputs them at the verification element 418.

The verification element 418 verifies the stock of the lease medical instruments identified by the determination element 416 by referring to the instrument inventory database 436 or the subassembly inventory database 438. The verification element 418 confirms the stock for each of the assemblies of the lease medical instrument and determines whether the lease medical instrument may lent to the medical institution 404 or not.

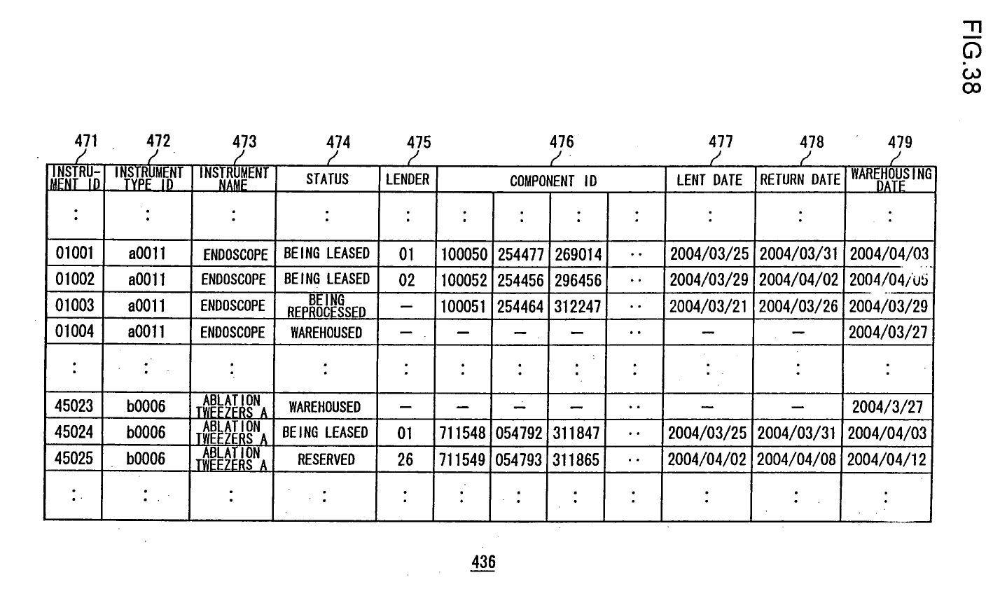

FIG. 38 is a view showing an example of the data structure of the instrument inventory database 436 shown in FIG. 35. The instrument ID column 471 contains the instrument ID identifying the lease medical instrument. The instrument type ID column 472 contains the instrument type ID identifying the type of the medical instrument. The instrument name column 473 contains the name of the medical instrument. The status column 474 contains information on the stock of the medical instruments. The stock information includes, for example, “being lent” indicating that the lease medical instrument is being lent to the medical institution 404, “being reprocessed” indicating that the medical instrument, after being returned”, is being sterilized or inspected, “warehoused” indicating that the medical instrument, after being inspected, kept in the warehouse, and “reservation for lending” indicating that the medical instrument is being reserved for future lending in response to the order by the medical institution 404. Since even tough being lent or reprocessed, the medical instrument may be reserved for lending on the date after being warehoused, a separate lend reservation column may be created. The lent party column 475 contains information on the medical institution 404, to which the medical instrument is lent. The component ID column 476 contains the subassembly IDs of the subassemblies composing the lent medical instrument. The lending date column 477 contains the date when the medical instrument has been lent to the medical institution 404 or the schedule date when it will be lent. The return date column 478 contains the date when the medical instrument was returned from the medical institution 404 or the schedule date when it will be returned. The warehoused date column 479 contains the date when the medical instrument was warehoused or the schedule date when it will be warehoused.

The medical instruments with status of “warehoused” may be lent to the medical institution 404. The medical instruments with status of “being reprocessed” may be lent when the reprocess step completes. The verification element 418 may determine that the medical instrument may be lent to the medical institution 404 provided that the warehousing date is earlier than the desired date of delivery. Similarly, the medical instruments with status of “being lent” may be lent when the reprocess step completes on schedule after they being returned on schedule, the verification element 418 may determine that they may be lent provided that the schedule warehousing is earlier than the desired data of delivery.

The instrument inventory database 436 shown in FIG. 38 is suited to grasp the stock of the subassemblies of the medical instrument. Using the component ID column 476 as a search key, the stock of the subassemblies of the medical instrument may be grasped.

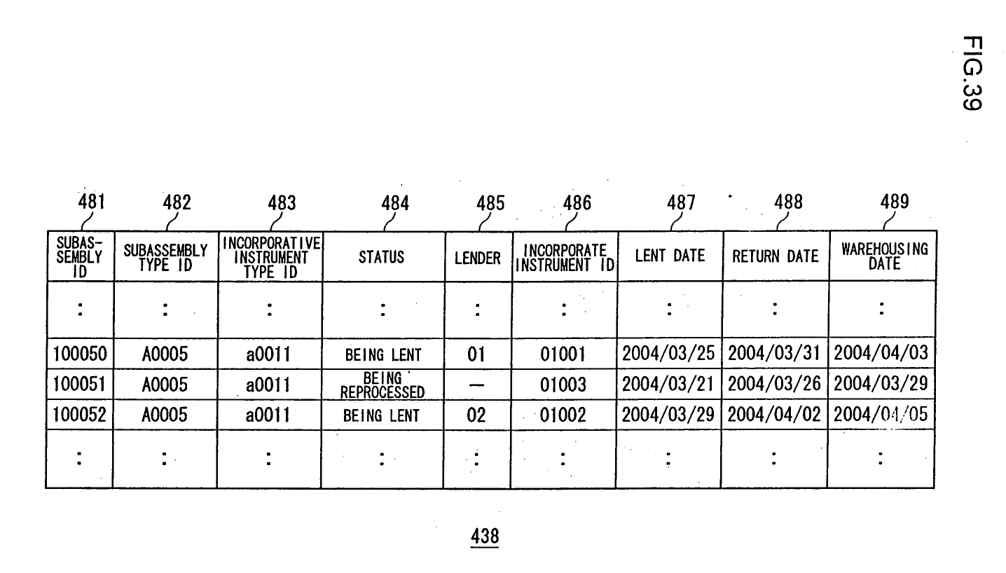

FIG. 39 is a view showing an example of the data structure of the subassembly inventory database 438 shown in FIG. 35. The subassembly ID column 481 contains the subassembly IDs identifying the subassemblies composing the medical instrument. The subassembly type ID column 482 contains the subassembly type IDs identifying the types of the subassemblies. The incorporative instrument ID column 483 contains the instrument type IDs identifying the types of the medical instruments, in which subassemblies may be incorporated. For example, if the same type of subassembly may be incorporated in a plurality of medical instruments, the incorporative instrument type ID column 483 contains a plurality of instrument type IDs. The status column 484 contains information on the stock of the medical instruments. Stock status includes “being lent”, “being reprocessed”, “warehoused”, and “reserved” as described above. The lent party column 485 contains information on the medical institution 404, to which the medical instrument, in which the subassemblies have been incorporated. The incorporated instrument ID column 486 contains the instrument ID identifying the medical instrument, in which the subassemblies have been incorporated. The lend date column 487 contains the date when the medical instrument has been lent to the medical institution 404 or the data when the schedule date when it will be lent. The return date column 488 contains the date when the medical instrument has been returned from the medical institution 404 or the schedule date when it will be returned. The warehousing date column 489 contains the date when the medical instrument has been warehoused or the schedule date when it will be warehoused.

Similar to the instrument stock database 436, the subassemblies with status of “warehoused” may be lent and those with status of “being reprocessed” may be lent provided that the desired data of delivery is earlier that the schedule warehousing date.

The subassembly inventory database 438 shown in FIG. 39 is suited to grasp the stock for each subassembly. However, by searching the subassembly inventory database 438 suing the incorporated instrument ID column 486 as a search key, the stock for each subassembly may be grasped. The medical instrument management equipment 410 may have the instrument inventory database 436 and/or the subassembly inventory database 438. If both of them are included, for example, the subassemblies, which are incorporative in a plurality of medical instruments, are managed for each subassembly using the subassembly inventory database 438. For the subassemblies incorporated only in a single type of medical instruments may be managed for each medical instrument using the instrument inventory database 436 rather than being disassembled for lending.

Turning back to FIG. 35, the verification element 418 determines whether all the subassemblies composing the medical instruments to be lent to the medical institution 404 may be lent or not by referring to the instrument inventory database 436 or the subassembly inventory database 438 and outputs the result of the verification at the response element. The response element 426 provides the user with the result of the verification at the verification element 426 if appropriate. For example, if the result of the verification indicates that there are some subassemblies, which are not acquired and lent until the desired date, the response element 426 informs the user of it. Modification of order data may be accepted.

The estimation element 420 estimates the number of lease medical instruments lent to the medical institution 404. The comparison element 422 compares the number of lent medical instruments estimated at the estimation element 420 with the upper limit set based on the lease contract. These configurations are incorporated when the lease contract, where the upper limit of lent medical instruments is agreed between the medical institution 404 and the medical instrument supplier 402, is concluded. The leas contract information is stored in the contract information database 434.

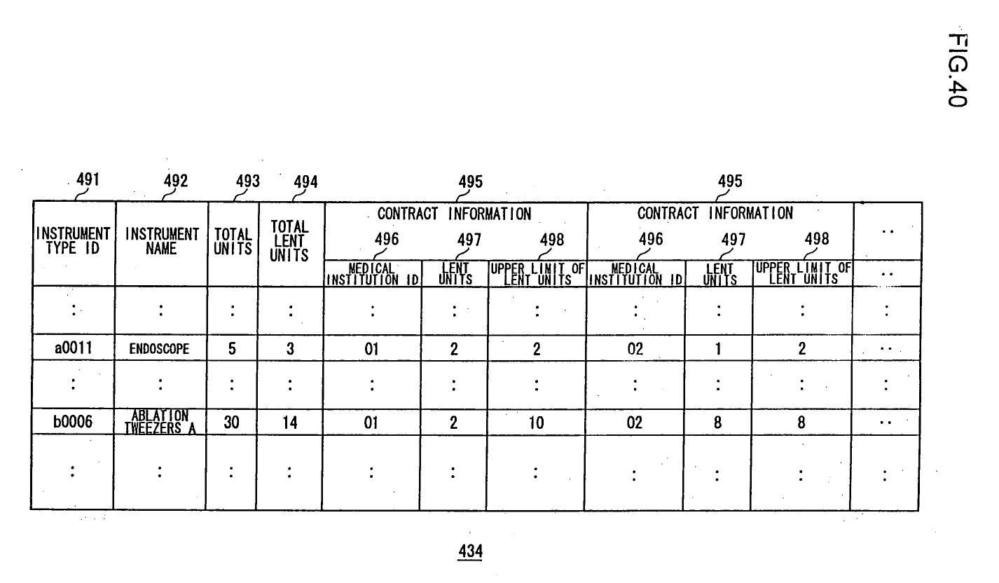

FIG. 40 is a view showing an example of the data structure of the contract information database 434 shown in FIG. 35. The instrument type ID column 491 contains the instrument type ID identifying the type of the lease medical instrument. The instrument name column 492 contains the name of the lease medical instrument. The total number column 493 contains the total number of lease-contracted medical instruments. This total number indicates the total number of lease medical instruments the medical instrument supplier 402 posses including those being lent, those being reprocessed, such as washing/sterilization, and those warehoused. The total lent instruments column 494 contains the number of medical instruments being lent. The contract information column 495 contains the contents of the contract for each medical institution 404. The contract information 495 has the medical institution ID column 496 containing the medical institution ID 404, the total of lent instruments column 497 containing the number of lent medical instruments being lent to the medical institution 404, and the upper limit of lent instruments column 498 containing the upper limit of lent instruments. In the figure, the upper limit of medical instruments lent to the medical institution 404 is set as the lease contract information. In addition, lent period, fee, additional fee applied when additional medical instrument is lent beyond the upper limit of lent instruments may be set under the lease contract and stored in the contract information database.

Turning back to FIG. 35, the estimation element 420 may acquired the number of lease medical instruments lent to the medical institution 404 by referring to the number of lent instruments column 497 in the contract information database 434. The comparison element 422 acquires the upper limit of lease medical instruments lent to the medical institution 404 by referring to the upper limit of lent instruments column 498 in the contract information database 434, compares it with the number of lent instruments estimated by the estimation element 420. The response element 426 makes a response to the order data based on the result of the comparison at the comparison 422. The response element 426 may suppress the lending if the number of lent medical instruments lent to the medical institution 404 exceeds the upper limit set for the medical institution 404. This prevents a excessive number of lease medical instruments from being lent to the medical institution 404, resulting in effective management of a limited number of lease medical instruments.

The medical instrument management equipment 410 may permit the lending of the medical instruments to the medical institution 404 even tough the number of lease medical instruments lent to the medical institution 404 exceeds the upper limit of the medical instruments lent to the medical institution 404, with additional fee. The medical instrument management equipment 410 may request, for example, an administrator to increase the upper limit if the upper limit is exceeded too many times. The medical instrument management equipment 410 may request, for example, an administrator to increase the total number of medical instruments if any type of medical instruments run out and are not capable of being lent. This facilitates smooth management of lending lease medical instruments.

The management element 424 updates the contract information database 434, the instrument inventory database 436, and the subassembly inventory database 438, reserves the subassemblies to be lent, and establishes the order if all the ordered medical instruments may be lent. Specifically, the management element 424 changes the status columns 474 of records corresponding to the medical instruments to be lent in the instrument inventory database 436 to “reserved”, records the medical institution ID of the medical institution 404, to which the medical instruments are lent, in the lender column 475, and records the subassembly IDs of the reserved subassemblies in the subassembly ID column 476. It records schedule date of lending, schedule date of return, and schedule date of warehousing in the lending date column 477, return date column 478, warehoused date column 479, respectively. The management element 424 changes the record status columns 484 of the records corresponding to the subassemblies in the subassembly inventory database 438 to be lento “reserved”, records the medical institution ID of the medical institution 404, to which the assemblies are to be lent, in the lending party column 485, and records the instrument ID of the medical instrument, in which the subassemblies have been incorporated, in the incorporated instrument ID column 486. Moreover, it records schedule date of lending, scheduled date of return, and schedule date of warehousing in the lending date column 487, the return date column 488, and the warehousing column 489. The management element 424 adds “1” to the total number columns 494 of the records corresponding to the medical instrument to be lent in the contract information database 434, and adds “1” in the number of lent instruments column 497 of the contract information column 495 of the medical institution, to which the instrument is lent. The output element 428 outputs, when the order is established, information on the medical instruments and their subassemblies to be lent to the medical institution 404. Specifically, the output element 428 outputs the instrument ID and subassembly IDs of the reserved lease medical instrument. These information are used at the packaging step S402 shown in FIG. 34.

The management element 424, when the packaged medical instrument is shipped to the medical instituted 404, changes the status columns 474 and 484 for the appropriate records in the instrument inventory 436 and the subassembly inventory 438, respectively to “being lent” and records actual lending date in the lending date columns 477 and 487.

The management element 424, when the medical instrument is returned from the medical institution 404, changes the status columns 474 and 484 of the appropriate records in the instrument inventory database 436 and the subassembly inventory database 438 to “being reprocessed” and erases the lent party columns 475 and 485. It records the actual return date in the return date columns 478 and 488. At that time, if the schedule date of warehousing is changed, the warehousing date columns 479 and 489 are updated.

The management element 424, when the medical instrument reprocessing step is complete, changes the status columns 474 and 484 of the appropriate records in the instrument inventory database 436 and the subassembly inventory database 438 to “warehoused” and erases the subassembly ID column 476 and the incorporates instrument column 486. The actual warehousing date is recorded in the warehousing date columns 479 and 489 and the lending date columns 477 and 487 and the return date columns 478 and 488 may be erased.

The configuration described above allows the status of the lease medical instruments to be effectively managed. Moreover, in response to the order from the medical institution 404, the medical instruments to be lent may be easily and correctly identified and arranged into a kit.

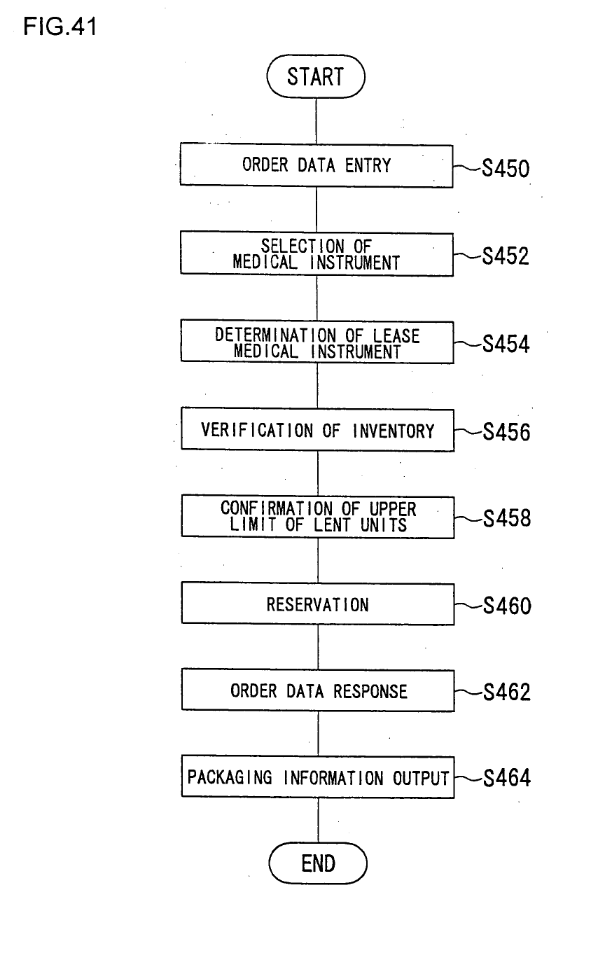

FIG. 41 is a flowchart showing the procedure for the medical instrument management method according to the embodiment 6. This procedure is reflected in the detail part of the order-receiving step (S400) in FIG. 34. The entry element 412 accepts the entered order data on the given medical practice from the order device 406 via the network 408 (S450). The selection element 414 selects the medical instruments required for the medical practice to be conducted in the medial institution 404 (S452). The determination element 416 identifies the lease medical instrument out of the selected medical instruments (S454). The verification element 418 verifies the current status of stock of the lease medical instruments (S456). The comparison element 422 compares the number of instruments lent to the medical institution 404 estimated by the estimation element 420 and the upper limit set for the medical institution 404 and determines whether the number of lent instruments does not exceed the upper limit (S458). If the upper limit of lent instruments is not exceeded and a sufficient amount of stock are found for all the necessary medical instruments, the management element 424 performs the reservation step (S460) and the response element 426 makes a response to the order (S462). The output element 428 outputs information on packaging (S464).

The characteristics described in the embodiment 6 of the present invention may be specified by the following items.

(Item 50)

Medical instrument management equipment, comprising;
a data entry element for entering order data on the given medical practice from the given medical institution,
a medical instrument selection element for selecting the medical instruments required for the given medical practice conducted in the given medical institution based on the order data entered from the order data entry element,
a lease medical instrument determination element for identifying the lease medical instruments out of the medical instruments selected at the medical instrument selection element,
a the inventory verification element for verifying the stock of the medical instruments identified at the lease medical instrument determination element, and
a response element for making a response to the order data based on the result of the verification at the inventory verification element.
   (Item 51)

The medical instrument management equipment described in the item 50, further comprising;
a stock status management element for managing the stock of the lease medical instruments, said the stock status management element managing for each of assemblies composing the medical instrument.
   (Item 52)

The medical instrument management equipment described in the item 51 or 52, further comprising;
a lending number information estimation element for estimating the number of instruments lent to the medical institution identified at the lease medical instrument determination element, a lending number comparison element for comparing the number of lent instruments estimated at the lending number estimation element and the upper limit defined based on the contract, said response element making a response to the order data based on the result of the comparison at the lending.
   (Item 53)

The medical instrument management equipment described in the item 52, wherein the response element suppresses the lending step of lease medical instruments to the medical institution if the upper limit of lent instruments is exceeded.

(Item 54)

Medical instrument management method, comprising;
a step for accepting the entered order data on the given medical institution,
a step for selecting the medical instruments required for the given medical practice conducted at the given medical institution based on the accepted order data,
a step for identifying lease medical instruments to be lent out of the selected aforementioned medical instruments,
a step for verifying the stock of the identified medical instruments, and
a step for making a response to the order data based on the result of the verification.

According to the item 50, “order data on medical practice” indicates, for example, the case name but may be any form of data, which reflects the medical practice. According to the equipment, out of the medical instruments required for the given medical practice, the stock of lease medical instruments may be appropriately managed and leased to the hospitals. The hospitals may recognize the stock of lease medical instruments out of the medical instruments required for the given medical practice, improving the convenience of order.

According to the item 51, lease medical instruments may be managed for each subassembly and the stock of them may be recognized, achieving effective and efficient management of lease medical instruments.

According to the item 52, a limited number of lease instruments may be efficiently managed.

<Distribution Management System for Medical Instruments>

### Embodiment 7

At hospitals, the used medical instruments are washed after they are used in surgical operation. At that time, if they are composed of a plurality of subassemblies, after disassembled, they are washed. When these medical instruments made of a plurality of subassemblies are washed, strict management of them is required because they are disassembled. It must be determined whether all the subassemblies have been collected after the instruments are collected for washing or sterilization.

The embodiment 7 has been developed in this context and its object is to provide medical instrument management method and equipment of the same.

First of all, the present invention is outlined and then described in detail. The embodiment 7 of the present invention relates to the distribution system of the medical instruments, where the medical instrument supplier ships the medical instruments to the medical institution and collects at lease some of the sipped medical instruments (hereinafter, the collected instruments simply referred to as “collected medical instrument”). As described above, herein, the medical instruments include lease medical instruments and purchased medical instruments and the collected medical instruments are generally lease medical instruments. This lease medical instruments include given disposable instruments, for example, those scheduled to be disposed the medical instrument supplier.

The medical instrument has been assembled from a plurality of subassemblies, when being shipped from the medical instrument supplier to the medical institution. On the other hand, when being colleted from the medical institution to the medical instrument supplier, it has been disassembled for washing (hereinafter, the terms “medical instrument” and its “subassembly” are used exchangeably, and even if the medical instrument is made of a plurality of subassemblies, in some cases, they are described in the same manner. This is true for disposable and reusable instruments.). According to the embodiment 7, the medical instrument supplier assigns ID to each of subassemblies of the collected medical instruments, records when collecting them at the medical institution, and compares the IDs to the IDs attached on the subassemblies of the collected medical instrument to check to see if all the medical instruments to be collected have been collected.

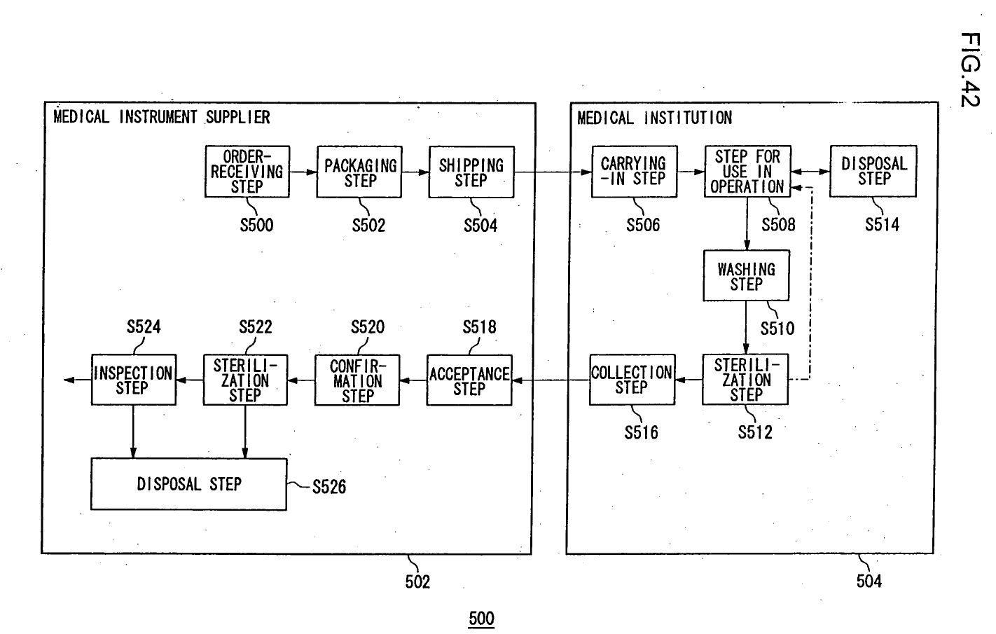

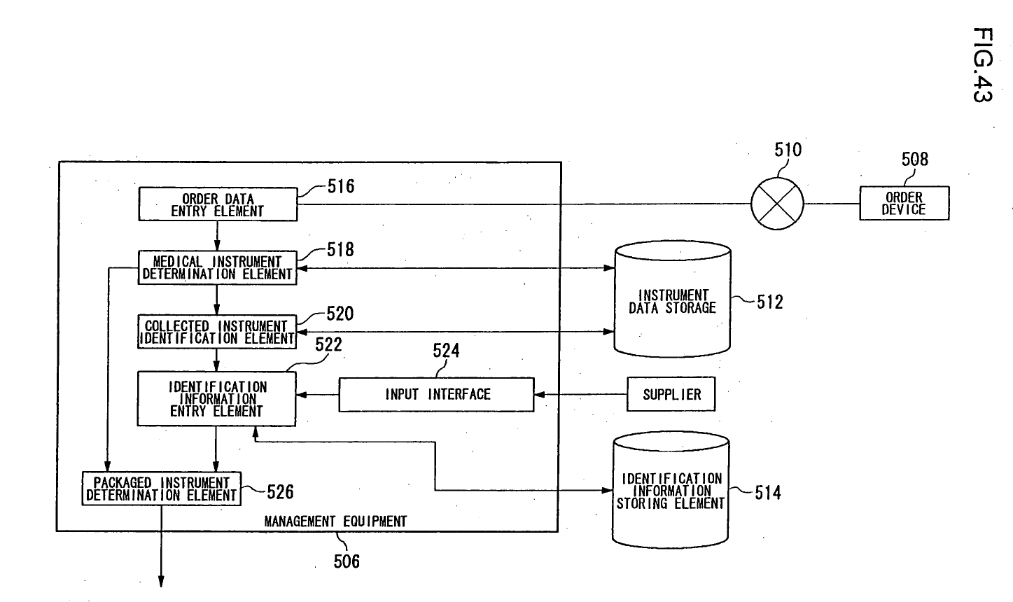

FIG. 42 is a schematic diagram explaining the distribution channel in the distribution system 500 of the medical instrument according to the embodiment 7 of the present invention. The distribution system 500 includes the medical instrument supplier 502 and the medical institution 504. Herein, only the path for transporting the medical instruments between the medical instrument supplier 502 and the medical institution 504 is assumed. Actually, there is another path such as a network, for example, the Internet for connecting between the medical instrument supplier 502 and the medical institution 504 for ordering or order-receiving. The latter is described referring to FIG. 43. In the figure, the distribution system 500 includes one medical instrument supplier 502 and one medical institution 504 only, but usually, a plurality of medical instrument suppliers 502 composes the whole distribution system 500.

The medical instrument supplier 502 is the entity which supplies medical instruments, for example, a medical instrument manufacturer. The medical institution 504 is the user, for example, a hospital.

The medical instrument supplier 502 accepts the order from the medical institution 504 via a network (not indicated) requesting the medical instrument supplier 502 to deliver the medical instruments to be ordered (S500). The medical instrument supplier 502 packages the medical instruments based on the accepted order (S502). The medical instrument supplier 502 ships the packaged instruments to the medical institution 504(S504).

The medical instrument shipped from the medical instruments supplier 502 are carried in the medical institution 504 (S506). The medical institution 504 use the carried medical instruments in surgical operation (S508). The medical instrument, namely the assemblies composing the medical instrument are contaminated during surgical operation. After being used, the medical instrument is disassembled into the subassemblies. Those contained in a medical instrument other than the medical instrument to be collected out of disassembled subassemblies are disposed (S514). Usually, the medical waste disposer collects these waste subassemblies. The subassemblies contained in the medical instrument to be collected are washed (S510) and sterilized (S512). The sterilized medical instrument may be reused in surgical operation but herein, the explanation is omitted for simplicity. These sterilized medical instrument to be collected are collected (S516) and accepted (S518) without being reassembled by the medical instrument supplier 502.

The medical instrument supplier 502 determines whether the collected medical instruments have been designated “collected” or not (S520). Namely, the medical instrument supplier 502 checks to see if any missing ones are detected or excessive ones are contained in the collected medical instruments. The medical instrument supplier 502 sterilizes the collected medical instruments (S522). The disposable ones out of the sterilized medical instruments are disposed (S526) while the reusable ones are checked to see if they may be used or not depending on their usage (S524). The reusable instruments determined to be disposed at inspection are disposed (S526). Usually, the medical waste disposer or the industrial waste disposer collects these wastes. The further explanation of reusable instruments determined to be usable is omitted.

FIG. 43 shows the configuration of management equipment 506 according to the embodiment 7 of the present invention. The management equipment 506 contains an order data entry element 516, a medical instrument determination element 518, a collection instrument determination element 520, an identification information entry element 522, an input interface 524, a packaging instrument determination element 526, the instrument data storing element 512, and the identification information storing element 514. FIG. 43 shows a distribution channel and a network between the medical instrument supplier 502 and the medical institution 504 in FIG. 42, is shown. Note that the management equipment 506 is the first device 20 in FIG. 1 and the order device 508 described later is the second device 30 in FIG. 1. The Management equipment 506 belongs to in the medical instrument supplier 502 and connected to the order device 508 in the medical institution 504 via the network 10. Herein, FIG. 43 shows the necessary portion of the order-receiving step (S500) shown in FIG. 42.

The order device 508 is a terminal, PC, at which is used by the medical institution 504 to make an order of medical instruments to the medical instrument supplier 502. The orderer of the medical institution 504 makes an order of the medical instruments by following the instructions displayed on the display screen (not indicated). Rather than using number of units, the medical instrument is ordered by means of, a case, for example, laparoscopic cholecystectomy or gastrectomy.

The order data entry element 516 enters the instructions described in the order entered at the order device 508 via the network.

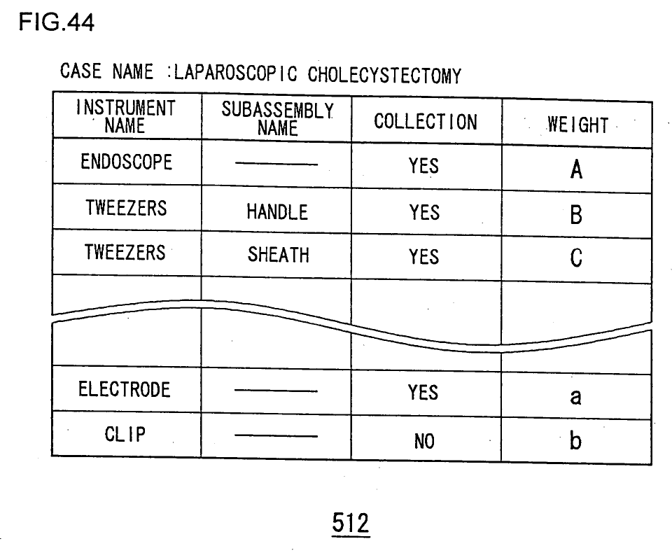

The instrument data storing element 512 stores data on the medical instruments corresponding to the ordered case. FIG. 44 shows the data structure of data stored in the instrument data storing element 512. Herein, data on the medical instrument corresponding to laparoscopic cholecystectomy is shown as an example. “instrument name” indicates the name of the medical instrument with no designation of reusable/disposable. “name of subassembly” indicates the mane of subassembly if the medical instrument described in “name of instrument” is composed of a plurality of subassemblies. “collection” indicates whether the medical instrument or its subassemblies are designated as “collected” or not. “weight” indicates the weight of the instrument or its subassembly.

Turning back to FIG. 43, the medical instrument determination element 518 selects the medical instruments corresponding to the ordered case from the instrument data storing element 512. The collected instrument determination element 520 identifies the medical instruments designated as “collected” out of the medical instruments selected at the medical instrument determination element 518. Namely, identifies the medical instrument or its assembly with “collection” parameter shown in FIG. 44 set to “YES”.

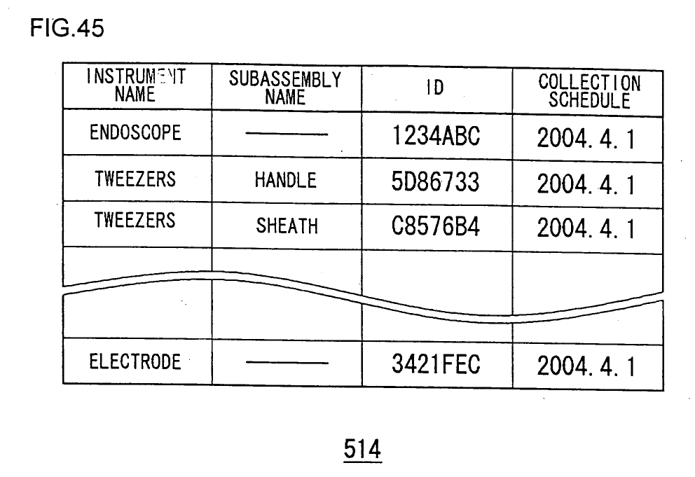

The identification information entry element 522 accepts the IDs assigned to the medical instruments designated as “collected” shipped to the medical institution 504, from the supplier of the medical instrument supplier 502 via the input interface. Moreover, the accepted IDs are corresponded to the name of the medical instrument or its subassembly designated as collected and stored in the identification information storing element 514. FIG. 45 shows the data structure of the identification information on the medical instrument stored in the identification information storing element 514. “name of instrument” and “name of subassembly” shown in FIG. 45 are the same those shown in FIG. 44. “ID” is assigned to the medical instrument corresponding to the ordered case or its subassembly and reflects the ID entered vie the input interface 524. “schedule date of collection” indicates the date when the medical instrument corresponding to the ordered case or its subassembly will be collected.

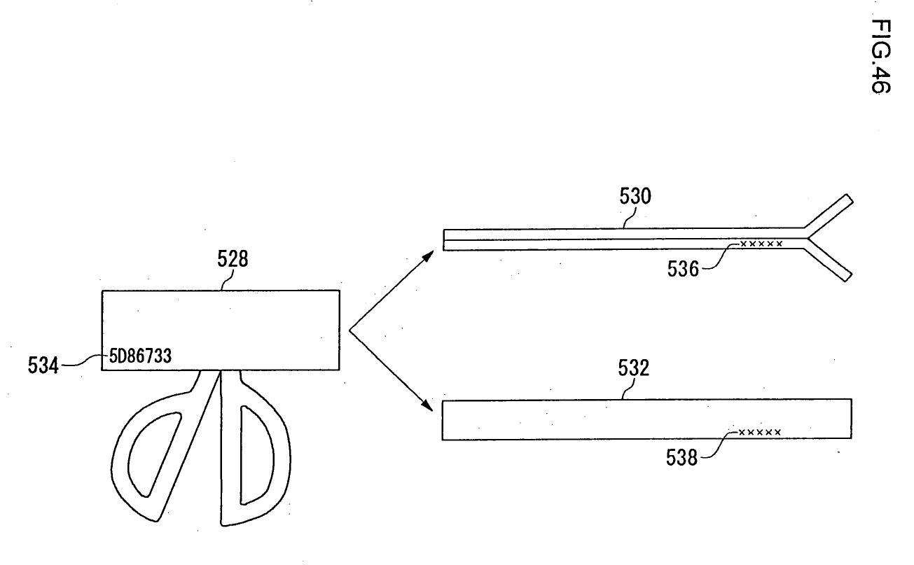

Herein, to illustrate the IDs assigned to the subassemblies of the medical instrument, in FIG. 46, the structure of a tweezers, which is distributed in the medical instrument distribution system 500. The tweezers contain a handle 528, a nipper unit 530, and a sheath 532. IDs 534, 536, and 538 have been assigned to the handle, the nipper unit, the sheath, respectively. Herein, IDs 534 for the handle, 536 for the nipper units, and 538 for the sheath are made of numeric characters or symbols. Alternatively, any non-contact tags may be attached called RFID (Radio Frequency Identification) rather than them. The supplier can enter these IDs at the identification information entry element 522 while watching ID 534 for the handle, ID 536 for the sniper unit, and ID 538 for the sheath, or viewing on the image on the screen taken by a camera.

Return back to FIG. 43, the packaging instrument determination element 526 determines the medical instrument to be packaged based on the information on the medical instrument selected at the medical instrument determination element 518 and the information on the medical instrument designated as collected entered at the identification information entry element [symbol] . The process goes to the packaging step (S502) shown in FIG. 42.

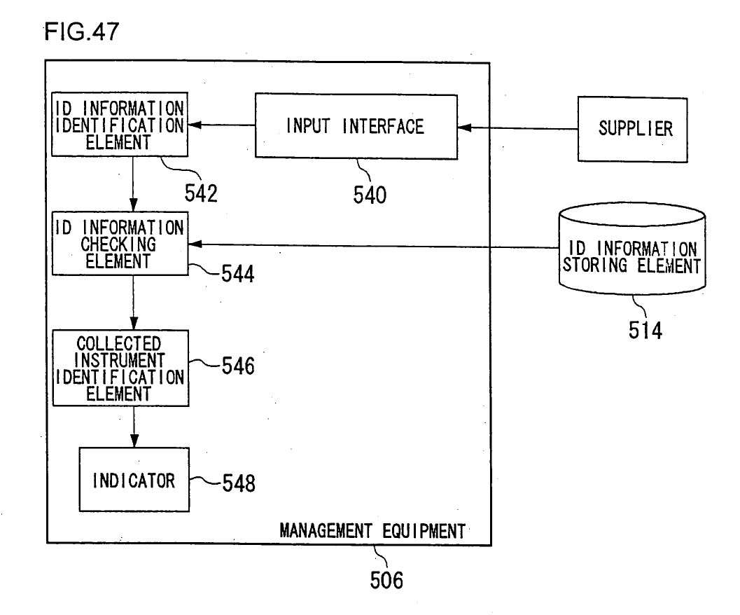

FIG. 47 shows the configuration of the management equipment 506 according to the embodiment 7 of the present invention. The management equipment 506 contains the input interface 540, the identification information determination element 542, the identification information checking element 544, the collected instrument determination element 546, the indicator 546, and the identification information determination element. The order data entry element 516 is configured in the medical instrument supplier 502 shown in FIG. 42. Herein, in FIG. 47, the necessary portion for the confirmation step (S520) is shown.

The identification information determination element 542 accepts IDs assigned by the supplier via the input interface to the collected medical instruments from the medical institution 504. As described above, since the medical instrument, which has been previously separated into subassemblies, are collected, the identification information determination element 542 identifies the IDs assigned to each of subassemblies of the medical instrument collected. As described above, herein, the supplier can enter these IDs at the identification information entry element while watching ID 534 for the handle, ID 536 for the sniper unit, and ID 538 for the sheath, shown on FIG. 46 or viewing the image on the screen taken by a camera.

The identification information storing element 514 is the same as the identification information storing element 514 shown in FIG. 43 and stores IDs of the shipped medical instrument designated as collected. The identification information checking element 544 checks IDs identified at the identification information determination element 542 and IDs stored in identification information storing element 514. The collection instrument determination element 546 identifies uncollected (“uncollected instrument”) ones and collected ones (“collected instrument”) among the medical instruments or its subassemblies designated as collected based on the result of the checking step at the identification information checking element 544. The indicator 548 displays the uncollected instrument identified at the collection instrument determination element 546 to the medical institution 504 in FIG. 42. Namely, it outputs the uncollected instrument to request the medical institution 504 to send them via the network 510 shown in FIG. 43.

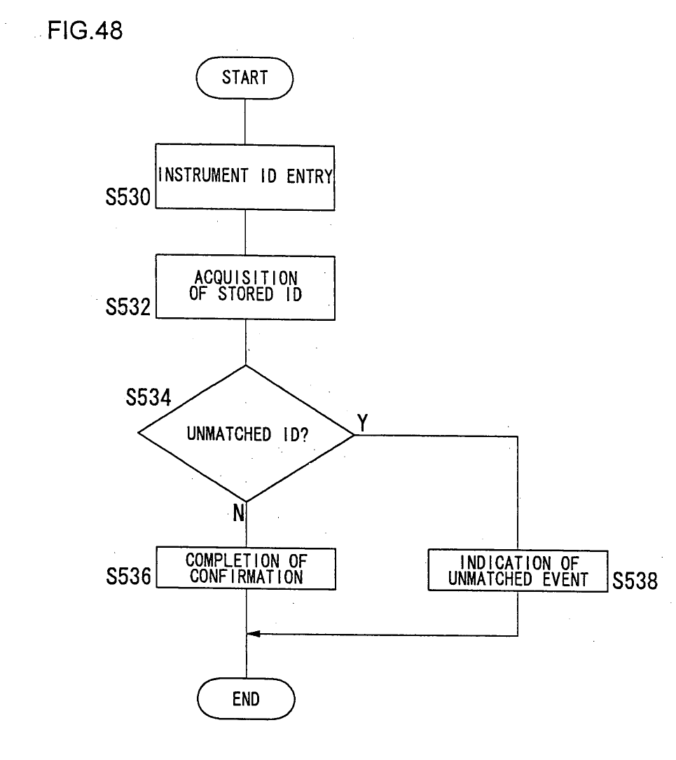

FIG. 48 is a flowchart showing the procedure for the confirmation step at the management equipment 506. When IDs of the collection medical instruments are entered for each of subassemblies via the input interface 540 (S530), the identification information determination element 542 identified the entered IDs. The identification information checking element 544 checks the collection medical instruments collected and acquires IDs stored in the identification information storing element 514 (S532). The identification information checking element 544 and the collection instrument checking element 546 checks IDs identified at the identification information determination element 542 and IDs acquired from the identification information storing element 514 to determine whether mismatch is found or not (S534). If no mismatch is found (Y at S534), the management equipment 506 exits the confirmation step (S536). The supplier goes to the step after the sterilization step shown in FIG. 42. On the other hand, if mismatch is found, (Nat 534), the indicator 548 informs the medical institution 504 shown in FIG. 42 of it (S538).

According to the embodiment 7 of the present invention, since the IDs are assigned to each of subassemblies composing the medical instrument designated as collected and the medical instrument supplier confirms IDs when collecting them, even though they have been already disassembled at the medical institution, the medical instrument supplier may determine whether they have been correctly collected or not. The medical instruments are collected together with disposable instruments and the medical instrument supplier washes and then disposes them. They may be disposed as industrial waste with disposal cost lower than that of medical waste. This allows the medical instrument supplier to provide the medical institution with convenient services at a low cost.

### Embodiment 8

Similar to the embodiment 7, the embodiment 8 of the present invention relates to the distribution system of medical instruments. Like the embodiment 7, according to the embodiment 8, the medical instrument supplier accepts the order of the medical instruments by means of “case” from the medical institution and based on the accepted order, packs and ships a plurality of medical instruments. While, the medical instrument supplier according to the embodiment 8 of the present invention assigns IDs to the packages. The medical instrument supplier, when collecting the packages containing the medical instruments designated as collected and compares IDs on the collection packages with IDs on the shipping packages to determine whether they have been collected in the form of package.

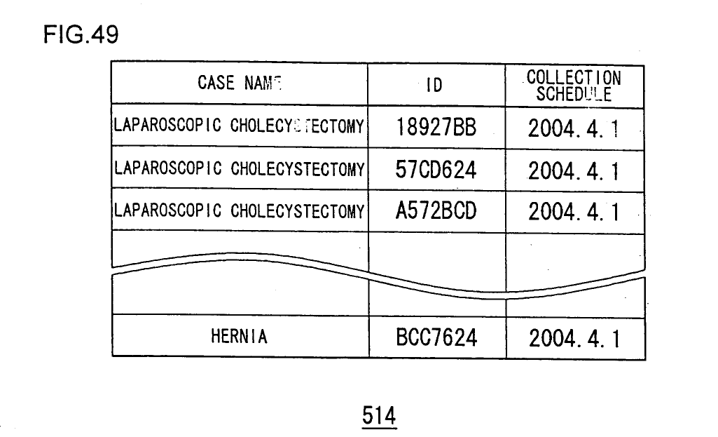

The embodiment 8 in the order step (S500) in FIG. 42 relates to the management equipment 506 of the same type as that of the management equipment in FIG. 43. However, IDs stored in the identification information storing element 514 are not those of subassemblies composing the medial instrument shown in FIG. 43 but those of cases described above. FIG. 49 shows the data structure of the identification information data on packages stored in the identification information storing element 514 according to the embodiment 8 of the present invention. “case name” indicates one package containing a plurality of medical instruments. “ID” is an identification number attached to the packages and entered via the input interface 524. The explanation of “schedule date of collection” is omitted here because it is the same as that shown in FIG. 5.

The embodiment 8 in the confirmation step (S520) in FIG. 42 relates to the management equipment 506 of the same type as that of the management equipment in FIG. 47. However, IDs identified in the identification information determination element 542 are IDs attached on the collected packages. IDs stored in the identification information storing element, as described above, are IDs assigned to the packages and the identification information checking element 544 and the collected medical instrument determination element 546 check IDs on the packages to determine whether shipped packages have been correctly collected.

According to the embodiment 8 of the present invention, IDs are assigned to each package containing a plurality of medical instruments designated as collected. The medical instrument supplier checks IDs on the packages, when collecting the medical instrument, facilitating the confirmation of the collected medical instruments designated as collected.

### Embodiment 9

The embodiment 9 of the present invention relates to the distribution system of medical instruments like the embodiments 7 and 8. Similar to the embodiments 7 and 8, the medical instrument accepts the order of the medical instruments by means of case from the medical institution, packages and ships a plurality of medical instruments based on the accepted case. Moreover, the medical instrument supplier according to the embodiment 9 stores the weights of the medical instruments designated as collected out of the packages prior to shipping. When collecting the packages containing the medical instruments from the medical institution, the medical instrument supplier compares IDs attached on the collected packages with IDs on shipped packages to determine whether the medical instruments have been collected in the form of package. Moreover, the weights of the collected packages are compared with those of the shipped packages to determine whether the medical instruments have been correctly collected or not.

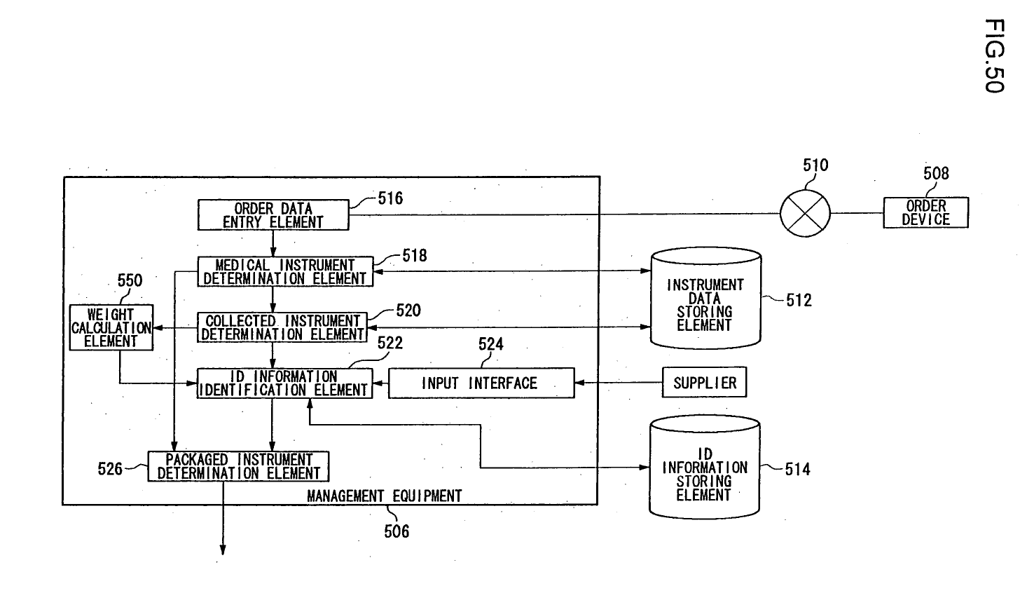

FIG. 50 shows the configuration of the management equipment 506 according to the embodiment 9 of the preen invention. The management equipment 506 has an additional a weight calculation element 550 unlike that shown in FIG. 43.

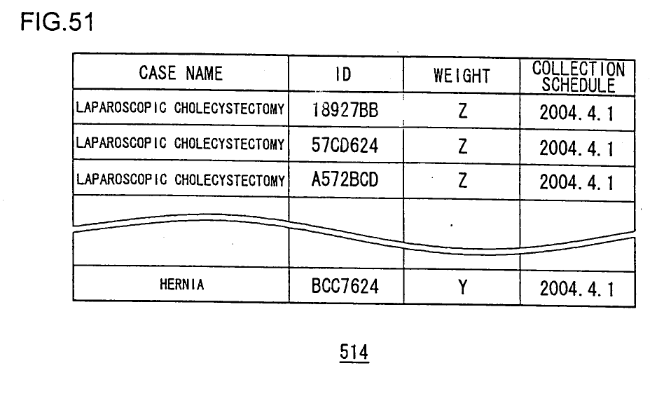

The weight calculation element 550, adds the weight identified at the collected instrument determination element 520, namely the weight included in the medical instrument data shown in FIG. 44 to calculate for one package. Herein, if the medical instruments designated as collected are reusable ones, the weight calculation element 550 sums the individual weighs of them up to a total. The weight calculated at the weight calculation element 550 is entered in the identification information, storing element 522, and stored in the identification in formation storing element 514. FIG. 51 shows the data structure of the package identification information stored in the identification information storing element 514. Like FIG. 38 according to the embodiment 8, “case name, “identification number”, and “schedule date of collection”, as well as “weight” calculated at the weight calculation element 550 are included.

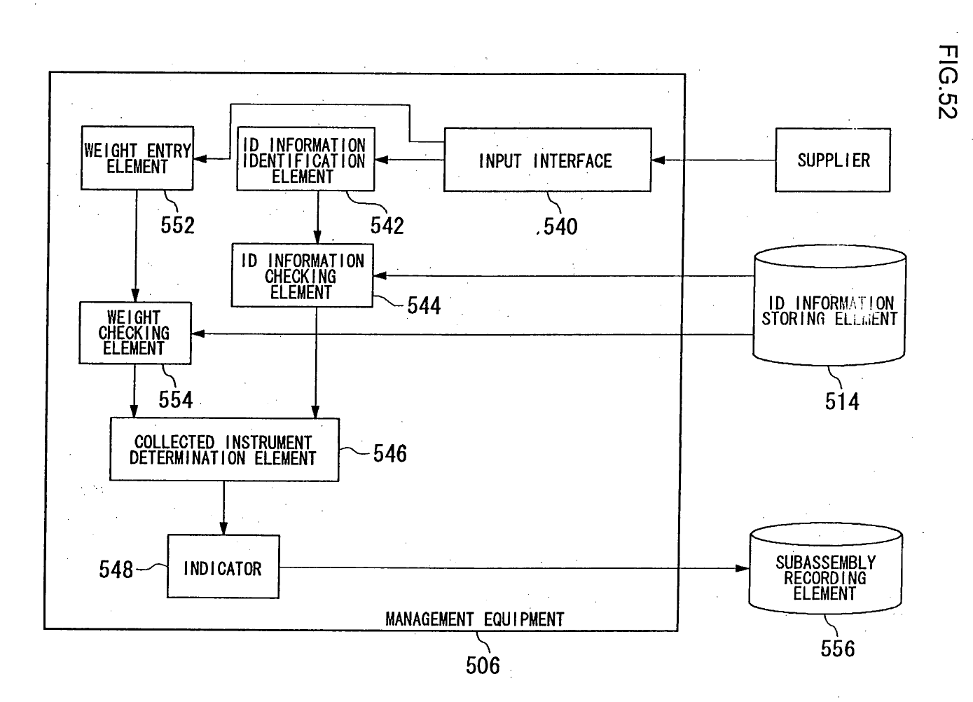

FIG. 52 shows the structure of the management equipment 506 according to the embodiment 9 of the present invention. The management equipment 506 has additional eight calculation element 552, weight checking element 554, and subassembly recording element 556, unlike that shown in FIG. 47.

Like the embodiment 8, the supplier enters IDs of the collected packages via the input interface 540 and the identification information determination element 542 identifies the IDs attached on the collected packages. The identification information storing element 514 and the identification information checking element 544 are the same as those of the embodiment 8. The supplier also enters the weights of the collected packages at the weight entry element 552 via the input interface 540.

The weight checking element 554 compares the weights on the packages entered and the weights of the packages stored in the input interface 524. Based on the result of checking IDs assigned at the identification information checking element 544, like the embodiment 8, the collected instrument determination element 546 determines whether the shipped packages have been collected. Moreover, if the shipped packages have been collected, based on the result of checking package weights at the weight checking element 554, determines whether the correct numbers of medical instruments are contained in the packages. At that time, since water adheres generally to the collected packages, the weights of the collected packages are heavier than those of the shipping packages excluding collected medical instruments. Herein, a given range of error is set for the weights of the sipping packages. If the weight of the collected package falls within the given range of error, it may be assumed that the same number of medical instruments are contained as that of the shipping package.

The indicator 548 indicates the uncollected medical instruments confirmed at the collected instrument determination element 546 at 504 shown in FIG. 42. The uncollected medical instruments are recorded in the subassembly recording element 556.

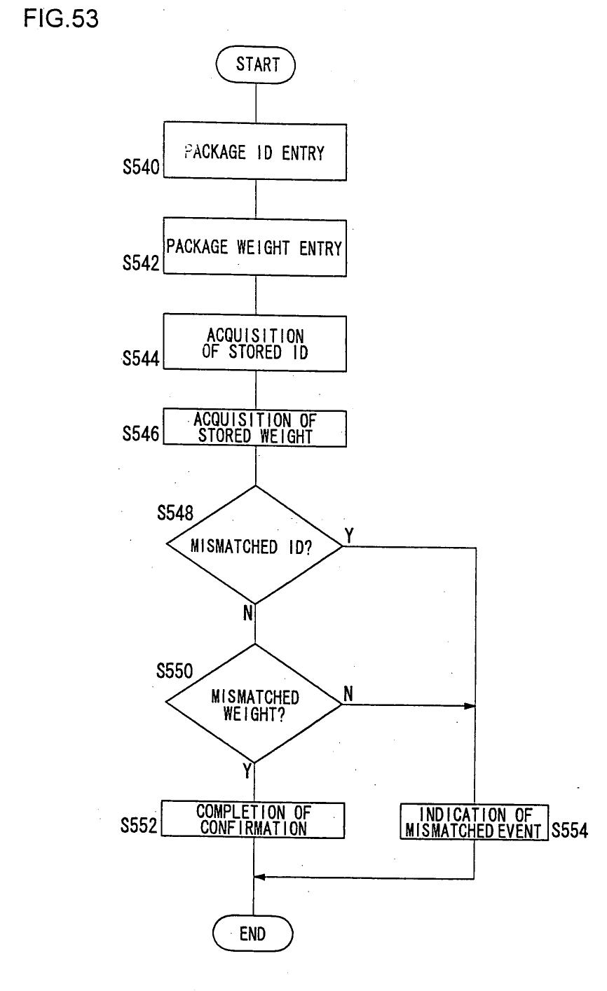

FIG. 53 is a flowchart showing the procedure of the confirmation step by the management equipment 506. The supplier enters ID for each of collected medical instrument packages via the input interface 540 (S540) and the identification information determination element 542 identifies the entered IDs. Moreover, the supplier enters the weights of the collected packages in the identification information entry element 522 via the in the interface 540 (S542). The identification information checking element 544 checks the collected packages and acquires the IDs (S544) stored in the identification information storing element 514 and the weights (S546). The identification information checking element 544 and the collected instrument determination element 546 check the IDs identified at the identification information determination element 542 and the IDs acquired from the identification information storing element 514, and confirm whether any mismatched Ids exist or not (S548).

If no mismatched Ids are found (N at S548), the weight checking element 554 and the collected instrument determination element 546 check the weights entered in the weight entry element 552 and the weights acquired from the identification information storing element 514 (S550). If the weights are matched within the given error (Y at S550), the management equipment 506 quits the confirmation step (S552). The supplier goes to the steps after the sterilization step (S522) shown in FIG. 42. On the other hand, if any mismatched IDs are found (Y at S548) or in weight (N at S550), the indicator 548 indicates the medical institution shown in FIG. 504 of the event (S554) and stores it in the instrument recording.

According to the embodiment 9 of the present invention, an ID is assigned to each package containing a plurality of medical instruments designated as collected and the medical instrument supplier checks the IDs on the individual packages, when collected, and also checked the weights on shipping packages against the weights on the collected packaged, resulting in easy detection of any missing instrument in the collected packages. By incorporating both steps, assigning an ID to and indicating weigh information on each package, any missing instrument in the collected packaged may be easily and correctly.

(Item 55)

Medical instrument management equipment, comprising,
an order data entry element for entering order data on the medical instruments ordered by means of the type of medical practice from the given medical institution,
a medical instrument extraction element for extracting the medical instruments required for the medical practice based on the order data entered in the order data entry element,
a collected medical instrument determination element for identifying the medical instruments designated as collected after the use of the medical institution out of the extracted medical instruments,
an identification information entry element for entering identification information on the medical instruments identified at the collected medical instrument determination element, and
an identification information storing element for storing the identification information entered.
   (Item 56)

Medical instrument management-equipment, comprising;
an identification information recording element for recording information on each of subassemblies composing the medical instrument shipped to the medical institution,
an identification information entry element for entering identification information assigned to each of a plurality of subassemblies composing the medical instrument shipped to the medical institution and then collected after being used and disassembled by the medical institution,
an identification information checking element for checking the entered identification information on each of assemblies against the identification information recorded on each of subassemblies, and
an indicator for providing the user with information on an uncollected subassembly, if any, base on the result of the checking step.
   (Item 57)

Medical instrument management equipment, comprising;
an identification information recording element for recording identification information on the packages containing the medical instruments of interest when shipped to the medical institution,
an identification information entering element for centering the identification information on the packages containing the medical instruments shipped to the medical institution and then collected after being used and disassembled by the medical institution, and
an identification information checking element for checking the entered identification information on the packages against the package identification information recorded, and
an indicator for providing the user with information on any uncollected package based on the result of the checking step.
   (Item 58)

Medical instrument management equipment, comprising;
a weight recording element for recording the identification information and weight of each of the packages containing the medical instruments of interest when shipped to the medical institution,
an identification information entry element for entering the identification information assigned to each of packages containing the medical instruments shipped to the medical institution and then collected after being used and disassembled by the medical institution,
an identification information checking element for checking the entered identification information on the packages against the identification information recorded on the packaged, and
a subassembly recording element for recording any uncollected subassembly detected when the weights of the shipping and collected packages, which are determined to be corresponded by comparing their weights, are checked against one another.
   (Item 59)

The medical instrument management equipment described in the item 58, wherein the subassembly recording element records the total weight of reusable ones out of medical instruments contained in the package of interest.

(Item 60)

A medical instrument management method, comprising;
a step for recording identification information on each of subassemblies composing the medical instruments of interest when shipped to the medical institution,
a step for entering the identification information assigned to each of the subassemblies composing the medical instrument shipped to the medical institution and then collected after being used and disassembled by the medical institution,
a step for checking the entered identification information on each of subassemblies against the identification information recorded on each of subassemblies and
a step for providing the user with information on any uncollected subassembly detected when these identification information rare checked against one another.

Regarding to the item 55, “order data on medical practice” indicates, for example, the case name, but not limited to it and any kind of data may be entered provided that based on it, the intended medical practice may be determined.

According to the item 55, since the medical instruments appropriate for the medical practice, when specified, are identified, the need for identification of individual medical instruments is eliminated, improving operability involved with the ordering process.

According to the item 56, since the identification information on each of subassemblies composing the collected medical instrument is checked against that of the shipped one even tough the collected medical instrument has been disassembled into its subassemblies, any uncollected subassembly may be detected.

Regarding the item 57, “package” indicates a kit of given medical instruments. The kit may be composed of any units and for example, the medical instrument may be combined together into a kit for either one case or a plurality of cases.

According to the item 57, since the identification information on the package containing the medical instruments collected are checked against the identification information on the shipping package containing the medical instruments, ant uncollected package may be immediately detected.

According to the item 58, since the identification information on the package containing medical instruments collected is checked against the identification information on the package containing the medical instruments shipped to the medical institution, any uncollected package may be immediately detected and the weights of the shipped medical instruments are checked against the weights of the collected medical instruments, any uncollected medical instrument may be detected in the package.

The example implementation of the present invention has been explained above in detail referring to the embodiments of the present invention. The person skilled in the art may fully recognize that various variants of the present invention may be used by combining appropriately the components and procedure steps described herein and these variants also fall within the scope of the present invention.

What is claimed is:

1. Medical instrument management equipment, comprising;
an order data entry element for entering the order data on medical instruments ordered by means of the specification of a medical practice type from a medical institution,
a medical instrument extraction element for extracting the medical instruments required for the medical practice identified, based on the order data entered at the order data entry element,
a medical instruments “designated as collected” determination element for identifying the medical instruments to be collected after being used by the medical institution out of the extracted medical instruments,
a pre-shipping identification information entry element for entering the identification information on the medical instruments identified t the medical instrument as designated “collected” determination element, and
an identification information storing element for storing the identification information entered.

2. The medical instrument management equipment defined in claim 1, further comprising;
a post-collection identification information entry element for entering the identification information assigned to each of subassemblies composing the medical instrument shipped to the medical institution and then collected after being used and disassembled by the medical institution,
an identification information checking element for checking the entered identification information of each of subassemblies against the identification information on each of subassemblies composing the medical institution recorded at the identification information storing element when being shipped, and
an indicator for providing the user with information on any uncollected subassembly detected based on the result of the checking step.

3. The medical instrument management equipment defined in claim 1, further comprising;
a post-collection identification information entry element for entering the identification information assigned to each of packages containing the medical instruments collected after being used and disassembled by the medical institution,
an identification information checking element for checking the entered identification information on the package against the identification information on the package containing the medical instruments when being shipped to the medical institution,
an indicator for providing the user with information on any uncollected package detected based on the result of the checking step.

4. The medical instrument management equipment defined in claim 1, further comprising;
a weight recording element for recording the identification information on the package containing the medical instruments shipped to the medical institution and the weight of the package containing the medical instruments of interest, respectively,
a post-collection identification information entry element for entering the identification information assigned to the package containing the medical instruments shipped to the medical to the medical institution and collected after being used and disassembled by the medical institution,
an identification information checking element for checking the entered identification information on the package against the identification information on the package recorded, and
a subassembly recording element for recording any uncollected subassembly detected based on the result of the step of checking the weights of the packages determined to be corresponded one another.

5. The medical instrument management equipment defined in claim 4, wherein the subassembly recording element records the total weight of reusable instruments to be reused out of the medical instruments contained the package of interest.

6. Medical instruments, wherein each of them is assembled from plural kinds of subassemblies corresponding to given medical functions and after being assembled from its subassemblies, supports the given medical practice in cooperation among the subassemblies, said subassemblies have their own subassembly ID assigned to manage their status in an external database.

7. The medical instruments defined in claim 6, wherein to make a given reader to read the subassembly ID out from the subassembly, geometric information is assigned to the subassembly as the subassembly ID.

8. Medical instrument management equipment, comprising;
an assembly table storing element for storing an assembly table, which corresponds the medical instrument IDs assigned to the medical instruments, to the subassembly IDs assigned to each of their plural kinds of subassemblies, each of said subassemblies being associated with a given medical function as a basic unit of the medical instrument,
a medical instrument ID entry element for accepting the entered medical instrument IDs,
a subassembly ID entry element for accepting the entered subassembly IDs, and
an assembly table recording element for recording the entered medical instrument IDs on the medical instruments to be managed and the entered subassembly IDs on the subassemblies composing the medical instrument in connection with one another to manage the usage statues of the medical instruments and their subassemblies included.

9. The medical instrument management equipment defined in claim 8, further comprising;
an instrument usage data storing element for storing an instrument usage data table, which corresponds the medical instrument IDs on the medical instruments to information on their usage, and
an intended purpose entry element for accepting the information on the intended usage of the medical instruments entered from the user, and
an instrument usage data recording element for recording the medical instruments IDs accepted by the medical instrument ID entry element and the information on their intended usage accepted by the intended usage entry element in the instrument usage data table in connection with one another.

10. The medical instrument management equipment defined in claim 9, further composing;
a subassembly usage data storing element for storing the subassembly usage data table, corresponds the subassembly IDs on the subassemblies to the information on the usage of these subassemblies in connection with one another,
a subassembly ID determination element for detecting the subassembly IDs on the subassemblies composing the medical instrument to be managed based on the medical instrument IDs by referring to the assembly table, and
a subassembly usage data recording element for recording the subassembly IDs detected and the information on the usage of the medical instrument to be managed in the subassembly usage data table in connection with one another.

11. The medical instrument management equipment defined in claim 8, further comprising;
a supplied instrument table storing element for storing a supplied instrument table, which corresponds the medical instrument IDs on the medical instruments supplied to the clinical field to the subassembly IDs on the subassemblies composing the medical instrument in connection with one another, and
a collection status detection element for detecting the collected and/or uncollected subassemblies our of the subassemblies composing the medical instrument supplied based on the subassembly IDs on the subassemblies collected from the clinical field by referring to the supplied instrument table.

12. The medical instrument management equipment defined in claim 8, further comprising;
a malfunction table storing element for storing the malfunction table, which corresponds the information on any malfunction occurring when the medical instrument being used to the subassembly IDs on the subassemblies composing the medical instrument in connection with one another,
a malfunction entry element for accepting the information on the malfunction entered by the user,
a malfunction table recording element for recording the subassembly IDs on the subassemblies composing the medical instrument, for which malfunction information has been accepted, identified at the subassembly ID determination element and the information on the malfunction in the malfunction data table in connection with one another, and
a malfunction detection element for determining whether the subassembly determined to be previously defective was detected among the inspected subassemblies by referring to the malfunction data table.

13. The medical instrument management equipment defined in claim 12, wherein the malfunction table recording element records a combination of the subassemblies composing the medical instrument, for which the malfunction information has been accepted, and the information on the malfunction occurring the medical instrument in the malfunction data table in connection with one another, said malfunction detection element determining whether plural combinations of subassemblies to be inspected were contained in the malfunctioned medical instrument as its part or not by referring to the data table.

14. The medical instrument management equipment defined in claim 8, further composing;
a subassembly information storage for storing the identification information of the assemblies composing medical instrument to be purchased or leased and their usage attribute values usage status in connection with one another,
a usage attribute detection element for detecting the usage attribute values of the assemblies to be detected based on the identification information, and
an indicator for displaying the result of the detection step on a screen.

15. The medical instrument management equipment defined in claim 8, further comprising;
a subassembly information storage for storing the identification information on the subassemblies composing the medical instrument to be purchased or leased and the type information of the medical instrument composed of the assemblies in connection with one another,
a medical instrument information acquisition element for detecting the type information on the medical instrument assembled from the subassemblies to be detected based on the identification information acquired from the subassembly information storage, and
an indicator for displaying the result of the detection step on the screen.

16. The medical instrument management equipment defined in claim 8, further comprising;
an identification information acquisition element for acquiring subassembly identification information assigned to the subassemblies composing the medical instrument, which is assembled from one or more assemblies,
a usage attribute value acquisition element for reading the usage attribute values indicating the current usage of the subassemblies out from a recording medium storing the usage attribute values
a usage limit value acquisition element for reading the usage limit values indicating the limit values for the usage attribute values out from a recording medium storing the usage limit values,
a usage attribute value storing element for storing the assembly identification information and the usage attribute values in connection with one another,
a usage limit value storing element for storing the assembly identification information and the usage limit values in connection with one another, and
a reusability determination element for determining whether the assemblies composing the medical instrument, for which reusability is to be determined, may be reused or not based on the assembly identification information read out by checking the usage attribute values and the usage limit values.
